(19) United States
(12) Patent Application Publication
(10) Pub. No.: US 2026/0135925 A1
(43) Pub. Date: May 14, 2026

(54) POSITION MESSAGE SYSTEM

(71) Applicant: SAKURAI LTD., Tokyo (JP)

(72) Inventor: Hidetoshi SAKURAI, Tokyo (JP)

(21) Appl. No.: 19/119,344

(22) PCT Filed: Oct. 13, 2022
(86) PCT No.: PCT/JP2022/038175

§ 371 Date: Apr. 8, 2025

(51) Int. Cl. H04L 67/52; G06F 16/9537; G06F 21/10; H04L 67/306; H04L 67/54

(52) U.S. Cl. CPC H04L 67/52; G06F 16/9537; G06F 21/1014; H04L 67/306; H04L 67/54

(57) ABSTRACT

A position message system is provided having a position message server device, which has: a user identification information retaining unit for retaining user identification information; a post information acquisition unit for acquiring post information; a post information retaining unit for retaining the acquired post information; a content record notification request acquisition unit acquiring a content record notification request which is a request for notifying other users of a record of the content included in the post information; and a notification processing unit for performing processing for notifying, among the users, only the users identified by the notification recipient user identification information included in the content record notification request.

### CROSS REFERENCE TO RELATED APPLICATIONS

This application is a 371 U.S. National Phase of International Application No. PCT/JP 2022/038175, filed on Oct. 13, 2022. The entire disclosure of the above application is incorporated herein by reference.

### BACKGROUND

### Technical Field

The present invention relates to a position message system which makes it possible to view or read a massage associated with geographical information from a terminal satisfying a predetermined geographical condition.

### Background Art

Conventionally, there has been a position message system as a system that allows users to access messages left by other users or to leave messages by themselves using location information of a spot where the users has actually been.

The messages retained in such a position message system include: personal messages from users; messages related to local history; local weather messages (on-demand); emergency and notification message (traffic); commercial messages such as advertisements and promotions; and the like. When a user having a mobile information terminal such as a smartphone actually goes to a site within a predetermined area or region relative to location information where the message is recorded, the user can access and view or read the message left in the location information.

When the position message system as described above is used to promote communication between users or for regional development or the like, a problem is anticipated in that the volume of messages increases as the number of system users increases, decreasing convenience for users. Prior art that focuses on this problem is Japanese Patent No. 6979421, filed by the applicant of the present application.

In Japanese Patent No. 6979421, a position message server device has a user information retaining unit, a position message acquisition unit, a position message retaining unit, a position message identification information request acquisition unit, a search population identification information acquisition rule retaining unit, a search population identification information acquisition unit, a relevant position message identification information search unit, and a relevant position message identification information output unit, making it easy to acquire a desired message from among a huge number of messages.

For the position message system according to Japanese Patent No. 6979421, no disclosure has been made about a configuration for letting a user to know that a new post has been made by the user's favorite posters or members of the same group as the user. As a result, because the user is not aware that a new post has been made, there is no motivation for the user to actually go to the site indicated by the location information associated with the new post to check the post.

Also, for the position message system according to Japanese Patent No. 6979421, messages are broadcast, and no disclosure has been made about two-way or shared communication for replying or sharing responses, evaluations, and the like associated with the relevant message is not disclosed. In addition, no disclosure has been made from the perspective of preventing slander and the leakage of personal information, which have become problems in recent years with SNS (Social Networking Services), when assuming the aforementioned two-way communication.

Furthermore, monetization to obtain funds to maintain and manage the system is an important element in order to continue providing the system as a service, but no disclosure has been made about a mechanism to achieve this.

The present invention has been made in consideration of the aforementioned problems and has an object to solve various problems that may arise when expanding the position message system as a service.

### SUMMARY

In order to solve the aforementioned problems, the present application provides, as a first invention, a position message system having a position message server device (A), the position message server device (A) having:
a user identification information retaining unit (AA) for retaining user identification information for identifying a user;
a post information acquisition unit (AB) for acquiring post information, which is information that associates:
   the user identification information of a user who has recorded a content included in the post information,
   geographical information including location information, which is information indicating a location used as a requirement for allowing a user other than the user identified by the user identification information to view this content, and
   the content;
a post information retaining unit (AC) for retaining the acquired post information;
a content record notification request acquisition unit (AD) for acquiring a content record notification request, which is a request for outputting a content record notification for notifying a user other than the user who recorded the content that the content included in the post information has been recorded, the request including notification recipient user identification information, which is user identification information of a user who is a notification recipient; and
a notification processing unit (AE) for performing a process of outputting the content record notification only to the user identified by the notification recipient user identification information included in the content record notification request among the users.

Based on the first invention, the position message system having the position message server device (A) is provided as a second invention, the position message server device (A) further having:
a viewing request information acquisition unit (AF) for acquiring viewing request information, which is information associating a request for viewing the retained post information and the geographical information including a location information which is information indicating at least a site of a user terminal device (B) being about to issue the request;
a geographical relationship determination rule retaining unit (AG) for retaining a geographical relationship determination rule, which is a rule for determining whether the geographical information included in the viewing request information acquisition unit (AF) and the geographical information associated with the retained content have a predetermined relationship;
a geographical relationship determination unit (AH) for determining, based on the geographical information included in the viewing request information, the geographical information associated with the retained content, and the retained geographical relationship determination rule, whether the two pieces of geographical information have the predetermined relationship;
a permission enabling information output unit (AJ) for outputting permission enabling information, which is information enabling permission to view the content which is requested to be viewed in the viewing request information, when the geographical relationship determination unit (AH) determines that they have the predetermined relationship; and
a content output unit (AK) for outputting the requested content to the user terminal device (B) that has output the viewing request information when a predetermined process is completed based on the output permission enabling information.

Based on the first or second invention, the position message system further having the user terminal device (B) is provided as a third invention, the user terminal device (B) having:
a user identification information retaining unit (BA) for retaining user identification information for identifying a user who uses the system;
a notification recipient candidate user identification information retaining unit (BB) for retaining notification recipient candidate user identification information, which is information of a user other than the user identified by the user identification information and who may be a candidate for the notification recipient described below;
a geographical information acquisition unit (BC) for acquiring geographical information including location information of the user terminal device (B);
a content input acceptance unit (BD) for accepting input of the content;
a content retaining unit (BE) for retaining the content of which input has been accepted in association with content identification information, which is information that identifies the content;
a notification recipient identification information selection unit (BF) for selecting as notification recipient identification information for identifying the notification recipient from the retained notification recipient candidate user identification information;
a content identification information selection unit (BG) for selecting a piece of the content identification information that identifies the retained content;
a post information output unit (BH) for outputting post information, which is information that associates:
   the content identified by the selected piece of the content identification information,
   geographical information acquired when the input of the content was accepted, and
   the user identification information of the user who uses the system;
a content record notification request acquisition unit (BJ) for acquiring a content record notification request, which is a request to notify the user identified by the selected piece of the notification recipient user identification information that the selected content is to be recorded or has been recorded; and
a content record notification request output unit (BK) for outputting the acquired content record notification request.

Based on the third invention, the position message system is provided as a fourth invention, in which the post information output unit (BH) of the user terminal device (B) has a current-location-limiting post information output means (BL) for outputting the post information associated with the geographical information acquired when the input of the content was accepted as the geographical information included in the post information.

Based on the third invention, the position message system is provided as a fifth invention, in which the user terminal device (B) further has a content record notification acquisition unit (BM) for acquiring the content record notification.

Based on the third invention, the position message system is provided as a sixth invention, in which the user terminal device (B) further has:
a reply content acquisition unit (BN) for acquiring, in accordance with the acquired post information, a reply content for a user identified by user identification information included in the post information; and
a post reply information output unit (BO) for outputting post reply information, which is information including the acquired reply content.

Based on the third invention, the position message system is provided as a seventh invention, in which
the user terminal device (B) has:
an evaluation/rating information acquisition unit (BP) for acquiring evaluation/rating information, which is information of evaluation/rating of the post information output by the post information output unit (BH); and
an evaluation/rating information output unit (BQ) for outputting the acquired evaluation/rating information, and
the position message server device (A) further has:
an evaluation/rating information acquisition unit (AM) for acquiring the evaluation/rating information; and
an evaluation/rating information retaining unit (AM) for retaining the acquired evaluation/rating information in association with the post information that was the subject of the evaluation.

Based on the third invention, the position message system is provided as an eighth invention, in which
the user terminal device (B) has:
a use/revenue/disposition information acquisition unit (BR) for acquiring, in association with the acquired content, use/revenue/disposition information, which is information regarding one or more of the use, revenue, and disposition of the content; and
a use/revenue/disposition information output unit (BS) for outputting the acquired use/revenue/disposition information, and
the position message server device (A) further has:
a use/revenue/disposition information acquisition unit (AN) for acquiring the use/revenue/disposition information;
a use/revenue/disposition information retaining unit (AO) for retaining the acquired use/revenue/disposition information in association with the content; and
a use/revenue/disposition processing unit (AP) for performing, in accordance with the acquired use/revenue/disposition information, a process related to one or more of the use, revenue, and disposition of the content.

Based on the third invention, the position message system is provided as a ninth invention, in which
the user terminal device (B) has:
a search query acquisition unit (BT) for acquiring a query for searching the post information retained in the position message server device (A); and
a query output unit (BU) for outputting the acquired search query to the position message server device (A), and
the position message server device (A) has:
a query acquisition unit (AQ) for acquiring the query; and
a post information search unit (AR) for searching the retained post information based on the acquired query.

Based on the third invention, the position message system is provided as a tenth invention, in which
the position message server device (A) further has:
an NFT-ization processing request acquisition unit (AS) for acquiring an NFT-ization request, which is a request for NFT-izing the content associated with the post information retained in the post information retaining unit (AC); and
an NFT-ization processing unit (AT) for performing a process of NFT-izing the content based on the acquired NFT-ization request.

Based on the third invention, the position message system according to any one of the second to ninth inventions is provided as an eleventh invention, in which the position message server device (A) further has:
an access authority information retaining unit (AU) for retaining access authority information, which is information indicating a right to access the content associated with the post information retained in the post information retaining unit (AC) from the user terminal device (B); and
an access authority NFT-ization processing unit (AV) for performing a process of NFT-izing the retained access authority information.

A method of operation of a computer-based position message system is provided as a twelfth invention, which includes a method of operation of a computer-based position message server device (A) including:
a user identification information retaining step (aa) for retaining user identification information for identifying a user;
a post information acquisition step (ab) for acquiring post information that associates:
   the user identification information of a user who has recorded a content included in the post information,
   geographical information including location information, which is information indicating a location used as a requirement for allowing a user other than the user identified by the user identification information to view this content, and
   the content;
a post information retaining step (ac) for retaining the acquired post information;
a content record notification request acquisition step (ad) for acquiring a content record notification request which is a request for outputting a content record notification for notifying a user other than the user who recorded the content that the content included in the post information has been recorded, the request including notification recipient user identification information, which is user identification information of a user who is a notification recipient; and
a notification processing step (ae) for performing a process of outputting the content record notification only to the user identified by the notification recipient user identification information included in the content record notification request among the users.

Based on the twelfth invention, the method of operation of the computer-based position message system is provided as a thirteenth invention, which includes the method of operation of the computer-based position message server device (A) further including:
a viewing request information acquisition step (af) for acquiring viewing request information, which is information for requesting to view the post information retained in association with the geographical information;
a geographical relationship determination rule retaining step (ag) for retaining a geographical relationship determination rule, which is a rule for determining whether the geographical information included in the viewing request information acquisition step (af) and the geographical information associated with the retained content have a predetermined relationship;
a geographical relationship determination step (ah) for determining, based on the geographical information included in the viewing request information, the geographical information associated with the retained content, and the retained geographical relationship determination rule, whether the two pieces of geographical information have the predetermined relationship;
a permission enabling information output step (aj) for outputting permission enabling information, which is information enabling permission to view the content which is requested to be viewed in the viewing request information, when the geographical relationship determination step (ah) determines that they have the predetermined relationship; and
a content output step (ak) for outputting the requested content to the user terminal device (B) that has output the viewing request information when a predetermined process is completed based on the output permission enabling information.

Based on the thirteenth invention, the method of operation of the computer-based position message system is provided as a fourteenth invention, which further includes the method of operation of the computer-based user terminal device (B) including:
a user identification information retaining step (ba) for retaining user identification information for identifying a user who uses the system;
a notification recipient candidate user identification information retaining step (bb) for retaining notification recipient candidate user identification information, which is information of a user other than the user identified by the user identification information and who may be a candidate for the notification recipient described below;
a geographical information acquisition step (bc) for acquiring geographical information including location information of the user terminal device (B);
a content input acceptance step (bd) for accepting input of the content;
a content retaining step (be) for retaining the content of which input has been accepted in association with the content identification information;
a notification recipient identification information selection step (be) for selecting the retained notification recipient candidate user identification information as notification recipient identification information for identifying the notification recipient described below;
a content identification information selection step (bg) for selecting a piece of the content identification information that identifies the retained content;
a post information output step (bh) for outputting as post information, which is information that associates:
   the selected content,
   geographical information acquired when the input of the content was accepted, and
   the user identification information of the user who uses the system;
a content record notification request acquisition step (bj) for acquiring a content record notification request, which is a request to notify the user identified by the selected piece of the notification recipient user identification information that the selected content is to be recorded or has been recorded; and
a content record notification request output step (bk) for outputting the acquired content record notification request.

A program readable and executable by a computer-based position message system is provided as a fifteenth invention, which includes programs readable and executable by a computer-based position message server device (A) including:
a user identification information retaining program (aa) for retaining user identification information for identifying a user;
a post information acquisition program (ab) for acquiring post information that associates:
   the user identification information of a user who has recorded a content included in the post information,
   geographical information including location information, which is information indicating a location used as a requirement for allowing a user other than the user identified by the user identification information to view this content, and
   the content;
a post information retaining program (ac) for retaining the acquired post information;
a content record notification request acquisition program (ad) for acquiring a content record notification request which is a request for outputting a content record notification for notifying a user other than the user who recorded the content that the content included in the post information has been recorded, the request including notification recipient user identification information, which is user identification information of a user who is a notification recipient; and
a notification processing program (ae) for performing a process of outputting the content record notification only to the user identified by the notification recipient user identification information included in the content record notification request among the users.

Based on the fifteenth invention, the program readable and executable by the computer-based position message system is provided as a sixteenth invention, which includes the programs readable and executable by the computer-based position message server device (A) further including:
a viewing request information acquisition step (af) for acquiring viewing request information, which is information for requesting to view the post information retained in association with the geographical information;
a geographical relationship determination rule retaining step (ag) for retaining a geographical relationship determination rule, which is a rule for determining whether the geographical information included in the viewing request information acquisition step (af) and the geographical information associated with the retained content have a predetermined relationship;
a geographical relationship determination step (ah) for determining, based on the geographical information included in the viewing request information, the geographical information associated with the retained content, and the retained geographical relationship determination rule, whether the two pieces of geographical information have the predetermined relationship;
a permission enabling information output step (aj) for outputting permission enabling information, which is information enabling permission to view the content which is requested to be viewed in the viewing request information, when the geographical relationship determination step (ah) determines that they have the predetermined relationship; and
a content output step (ak) for outputting the requested content to the user terminal device (B) that has output the viewing request information when a predetermined process is completed based on the output permission enabling information.

Based on the fifteenth or sixteenth invention, the program readable and executable by the computer-based position message system is provided as a seventeenth invention, which further includes the programs readable and executable by the computer-based user terminal device (B) including:
a user identification information retaining program (ba) for retaining user identification information for identifying a user who uses the system;
a notification recipient candidate user identification information retaining program (bb) for retaining notification recipient candidate user identification information, which is information of a user other than the user identified by the user identification information and who may be a candidate for the notification recipient described below;
a geographical information acquisition program (bc) for acquiring geographical information including location information of the user terminal device (B);
a content input acceptance program (bd) for accepting input of the content;
a content retaining program (be) for retaining the content of which input has been accepted in association with the content identification information;
a notification recipient identification information selection program (bf) for selecting the retained notification recipient candidate user identification information as notification recipient identification information for identifying the notification recipient described below;
a content identification information selection program (bg) for selecting a piece of the content identification information that identifies the retained content;
a post information output program (bh) for outputting as post information, which is information that associates:
   the selected content,
   geographical information acquired when the input of the content was accepted, and
   the user identification information of the user who uses the system;
a content record notification request acquisition program (bj) for acquiring a content record notification request, which is a request to notify the user identified by the selected piece of the notification recipient user identification information that the selected content is to be recorded or has been recorded; and
a content record notification request output program (bk) for outputting the acquired content record notification request.

In addition, the operation programs according to the fifteenth to seventeenth inventions may be recorded on a recording medium.

### Advantageous Effects of Invention

The position message system of the present invention can achieve the excellent effects of promoting active communication and enabling the system to be expanded to a variety of services.

### BRIEF DESCRIPTION OF THE DRAWINGS

FIG. 1 is a diagram showing an outline of a network configuration of a position message system.

FIG. 2 is a diagram showing an example of a screen of a position message service.

FIG. 3 is a block diagram showing a configuration of functions of a position message server device (A) according to Embodiment 1.

FIG. 4 is a diagram showing an example of user identification information.

FIG. 5 is a diagram showing an example of geographical information.

FIG. 6 is a diagram showing an example of post information.

FIG. 7 is a diagram showing a hardware configuration of the position message server device (A) according to Embodiment 1.

FIG. 8 is a flowchart showing a processing flow of the position message server device (A) according to Embodiment 1.

FIG. 9 is a block diagram showing a configuration of functions of a position message server device (A) according to Embodiment 2.

FIG. 10 is a diagram showing a hardware configuration of the position message server device (A) according to Embodiment 2.

FIG. 11 is a flowchart showing a processing flow of the position message server device (A) according to Embodiment 2.

FIG. 12 is a block diagram showing a configuration of functions of a user terminal device (B) according to Embodiment 3.

FIG. 13 is a diagram showing an example of an initial screen of a PMS application on the user terminal device (B) according to Embodiment 3.

FIG. 14 is a diagram showing an example of a notification recipient user registration screen on the user terminal device (B) according to Embodiment 3.

FIG. 15 is a diagram showing an example of a case where post information is input using the user terminal device (B) according to Embodiment 3.

FIG. 16 is a diagram showing an example of a post confirmation screen when posting on the user terminal device (B) according to Embodiment 3.

FIG. 17 is a diagram showing an example of a screen for specifying a posting location on the user terminal device (B) according to Embodiment 3.

FIG. 18 is a diagram showing a hardware configuration of the user terminal device (B) according to Embodiment 3.

FIG. 19 is a flowchart showing a processing flow of the user terminal device (B) according to Embodiment 3.

FIG. 20 is a diagram showing an example of posting from a user terminal device (B) according to Embodiment 4.

FIG. 21 is a block diagram showing a configuration of functions of the user terminal device (B) according to Embodiment 4.

FIG. 22 is a diagram showing a hardware configuration of the user terminal device (B) according to Embodiment 4.

FIG. 23 is a flowchart showing a processing flow of the user terminal device (B) according to Embodiment 4.

FIG. 24 is a diagram showing an example of a case where a notification is received by a user terminal device (B) according to Embodiment 5.

FIG. 25 is a block diagram showing a configuration of functions of the user terminal device (B) according to Embodiment 5.

FIG. 26 is a diagram showing an example of a location of post information notified to the user terminal device (B) according to Embodiment 5.

FIG. 27 is a diagram showing a hardware configuration of the user terminal device (B) according to Embodiment 5.

FIG. 28 is a flowchart showing a processing flow of the user terminal device (B) according to Embodiment 5.

FIG. 29 is a block diagram showing a configuration of functions of the user terminal device (B) according to Embodiment 6.

FIG. 30 is a diagram showing a hardware configuration of the user terminal device (B) according to Embodiment 6.

FIG. 31 is a flowchart showing a processing flow of the user terminal device (B) according to Embodiment 6.

FIG. 32 is a diagram showing an example of a screen for inputting a reply to post information on a user terminal device (B) according to Embodiment 7.

FIG. 33 is a diagram showing an example of a screen on the user terminal device (B) according to Embodiment 7 which displays the post information together with the reply thereto.

FIG. 34 is a block diagram showing a configuration of functions of the user terminal device (B) according to Embodiment 7.

FIG. 35 is a block diagram showing a configuration of functions of a position message server device (A) according to Embodiment 7.

FIG. 36 is a diagram showing a hardware configuration of the user terminal device (B) according to Embodiment 7.

FIG. 37 is a diagram showing a hardware configuration of the position message server device (A) according to Embodiment 7.

FIG. 38 is a flowchart showing a processing flow of the user terminal device (B) and the position message server device (A) according to Embodiment 7.

FIG. 39 is an example of displaying a location of post information and evaluation/rating information on the user terminal device (B) according to Embodiment 7.

FIG. 40 is a block diagram showing a configuration of functions of a user terminal device (B) according to Embodiment 8.

FIG. 41 is a block diagram showing a configuration of functions of a position message server device (A) according to Embodiment 8.

FIG. 42 is a diagram showing a hardware configuration of the user terminal device (B) according to Embodiment 8.

FIG. 43 is a diagram showing a hardware configuration of the position message server device (A) according to Embodiment 8.

FIG. 44 is a flowchart showing a processing flow of the user terminal device (B) and the position message server device (A) according to Embodiment 8.

FIG. 45 is a block diagram showing a configuration of functions of a user terminal device (B) according to Embodiment 9.

FIG. 46 is a block diagram showing a configuration of functions of a position message server device (A) according to Embodiment 9.

FIG. 47 is a diagram showing a hardware configuration of the user terminal device (B) according to Embodiment 9.

FIG. 48 is a diagram showing a hardware configuration of the position message server device (A) according to Embodiment 9.

FIG. 49 is a flowchart showing a processing flow of the user terminal device (B) and the position message server device (A) according to Embodiment 9.

FIG. 50 is a block diagram showing a configuration of functions of a position message server device (A) according to Embodiment 10.

FIG. 51 is a diagram showing a hardware configuration of the position message server device (A) according to Embodiment 10.

FIG. 52 is a flowchart showing a processing flow of the position message server device (A) according to Embodiment 10.

FIG. 53 is a block diagram showing a configuration of functions of a position message server device (A) according to Embodiment 11.

FIG. 54 is a diagram showing a hardware configuration of the position message server device (A) according to Embodiment 11.

FIG. 55 is a flowchart showing a processing flow of the position message server device (A) according to Embodiment 11.

FIG. 56 is a diagram showing an example of a case where search criteria of post information is input on the user terminal device (B) according to Embodiment 9.

### DETAILED DESCRIPTION

### Hardware That May Constitute The Present Invention

The present invention is in principle an invention that utilizes an electronic computer, but it is realized by software, by hardware, or by the cooperation of software and hardware. The hardware that realizes all or part of each of the constituent elements of the present invention includes: the basic configuration of computers such as CPUs (central processing units), main memories, system buses, or secondary storage devices (hard disk drives, non-volatile memories, motherboards, storage media such as CDs and DVDs as well as drives for reading these media, USB memories, IC card memories, flash memory cards, etc.), input devices used for inputting information, clocks, and display devices (liquid crystal display devices, EL display devices, LED display devices, etc.); hardware components such as other external peripheral devices, including tablets, smartphones, VR head-mounted displays, glasses-type displays (monocular type, see-through type, etc.), glasses-type displays with cameras (cameras are built-in type, clip-on type, etc.), and wearable cameras (attached to/embedded in clothing, clip-on type, built-in to caps, etc.), interfaces for these external peripheral devices, communication interfaces, location information interfaces, receivers of signals from positioning satellites, calculation devices that process signals from positioning satellites and calculate locations, beacon signal receivers, devices for analyzing location information from beacon signals, image analysis devices, microphones, vibration generators, projectors, blood pressure measurement sensors, pulse measurement sensors, sweat rate measurement sensors, fatigue measurement devices, pedometers, calorie consumption sensors, calorie consumption measurement devices, brainwave measurement sensors, barometers, temperature sensors, humidity sensors, wind direction sensors, wind speed senders, human presence sensors, infrared sensors, clocks, body temperature sensors, illuminance sensors, batteries, battery remaining gauges, power meters, power consumption meters, ammeters, various communication interfaces, various storage interfaces, navigation devices, remote controllers for drones, drones with cameras, Bluetooth (registered trademark) interfaces, gaze input interfaces, height input interfaces, touch input interfaces, and software keyboard interfaces; driver programs and other application programs for controlling such hardware; user interface applications; and the like. Also, the present system does not necessarily have to be composed of a single housing, but may be composed of multiple housings connected via communication. Furthermore, communication may be conducted via telephone lines, LAN, WAN, Wi-Fi (registered trademark), Bluetooth (registered trademark), infrared communication, or ultrasonic communication, and some of the communication may be conducted between housings located across national borders. In addition, each of the multiple housings may be operated by a different entity or by a single entity. The entity operating the system of the present invention may be single or multiple. The invention may also be configured as a system that includes, in addition to the present system, a terminal used by a third party, and a terminal used by yet another third party. These terminals may be arranged across borders. Furthermore, in addition to the present system and the aforementioned terminals, devices used to register information regarding to third parties and related persons, devices used for a database for recording details of the registration, and the like may be prepared. These devices may be provided in the present system, or may be provided outside the present system so that the present system can be configured to utilize such information (FIG. 1).

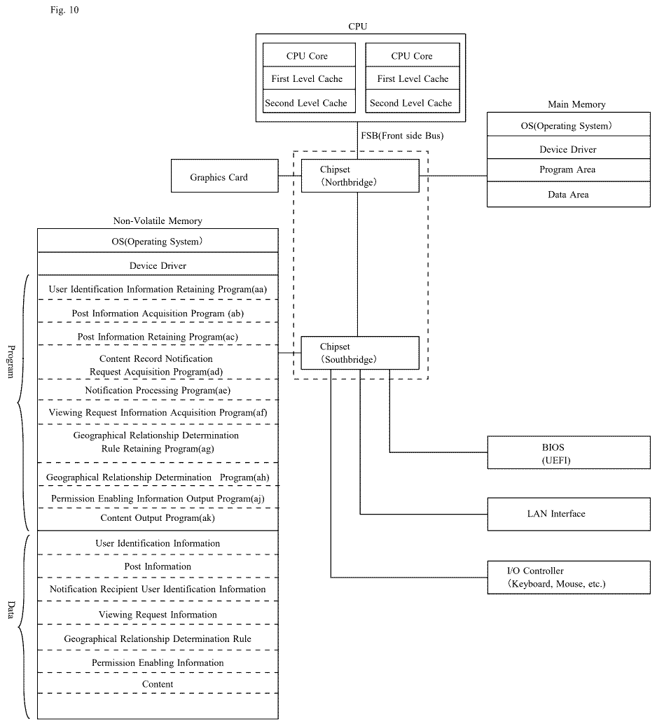

As shown in FIG. 7, a computer consists of a chipset, a CPU, a non-volatile memory, a main memory, various buses, BIOS, various interfaces including USB, HDMI (registered trademark), LAN, and the like, as well as a real-time clock, etc., which are configured on a motherboard. They operate in cooperation with an operating system, device drivers (for integrating various interfaces such as USB and HDMI (registered trademark) and various devices such as cameras, microphones, speakers, headphones, or displays), various programs, and the like. The various programs and the various data constituting the present invention are configured to efficiently utilize these hardware resources to execute various processes.

### >>Chipset>>

A “chipset” is a set of large scale integrated circuits (LSIs) mounted on a motherboard of a computer, on which a communication function, i.e., a bridge function, between external buses of a CPU and standard buses for connecting memories and peripheral devices is integrated. There are cases where a two-chip set configuration is used, and cases where a one-chip set configuration is used. A northbridge is provided on the side closer to the CPU and the main memory, and a southbridge is provided on the opposite side with the relatively slow interfaces to external I/O.

### (Northbridge)

The northbridge includes a CPU interface, a memory controller, and a graphics interface. Most of the functions of the conventional northbridge may be handled by a CPU. The northbridge is connected to a memory slot of the main memory via a memory bus, and to a graphics card slot of a graphics card via a high-speed graphics bus (AGP, PCI Express).

### (Southbridge)

The southbridge is connected to a PCI interface (PCI slot) via a PCI bus and is responsible for I/O functions with an ATA (SATA) interface, a USB interface, an Ethernet interface, or the like, and sound functions. Incorporating circuits that support PS/2 ports, floppy disk drives, serial ports, parallel ports, and ISA buses, which do not require or are not capable of high-speed operation, would hinder speeding up a chipset itself, so that such circuits may be separated from the chip of the southbridge and assigned to another LSI called a super I/O chip. Buses are used to connect the CPU (MPU) and peripheral devices and various control units. The buses are coupled to each other by a chipset. For the memory bus used for connection with the main memory, a channel structure may be adopted instead of the above-described configuration in order to increase speed. A serial bus or a parallel bus can be adopted as the bus. While the serial bus transfers data one bit at a time, the parallel bus transmits the original data itself or multiple bits extracted from the original data as a single block and over multiple communication paths simultaneously. A dedicated line for a clock signal is provided in parallel with the data lines for synchronizing data demodulation on the receiving side. The parallel bus is also used as a bus to connect the CPU (chipset) to external devices, and examples thereof include GPIB, IDE/(parallel) ATA, SCSI, PCI, and the like. Since there is a limit to speeding up, the data line may be a serial bus in PCI Express, an improved version of PCI, and Serial ATA, an improved version of parallel ATA.

### >>CPU>>

The CPU sequentially reads a sequence of instructions called a program on the main memory, interprets and executes it, and outputs information consisting of signals to the main memory as well. The CPU functions as the center of calculations within a computer. Note that the CPU is composed of a CPU core portion which is the center of calculations and its peripheral portions, and it internally includes a register, a cache memory, an internal bus connecting the cache memory and the CPU core, a DMA controller, a timer, an interface with a connection bus to the northbridge, and the like. Note that multiple CPU cores may be provided in a single CPU (chip). In addition, processing may also be performed by a graphics interface (GPU) or FPU in addition to the CPU. Although the embodiments will be described as a two-core type, this is not limiting. The program can also be embedded in the CPU.

### <<Non-Volatile Memory>>

### (HDD)

The basic structure of a hard disk drive is composed of a magnetic disk, a magnetic head, and an arm carrying the magnetic head. As an external interface, SATA (formerly ATA) may be adopted. A high-performance controller such as SCSI is used to support communication between the hard disk drives. For example, when copying a file to another hard disk drive, the controller can read sectors and transfer and write them into the other hard disk drive. During this process, the memory in the host CPU is not accessed. Therefore, there is no increase in the CPU load.

### (SSD: Solid State Drive)

Currently, two types of flash memories are commonly used: NAND flash memories and NOR flash memories. Although there are pros and cons regarding read/write speed, the NAND type is more advantageous for high integration and is used for data storage purposes. Compared to a hard disk drive, the flash memory is smaller and does not generate vibration or noise in operation because it has no movable parts. However, its cost per unit capacity has not yet fallen to a level where it can replace hard disk drives. If the amount of data to be stored is not large, the device can be made smaller and more resistant to shock, which is an advantage.

### <<Main Memory>>

The CPU directly accesses the main memory and executes various programs on it. The main memory is a volatile memory and a DRAM is used. The programs on the main memory are deployed from the non-volatile memory to the main memory in response to a program start command. The CPU then executes the programs according to various execution commands and execution procedures within the programs.

### >>Operating System (OS)>>

The operating system is used to manage the resources on the computer so that applications can use them, to manage various device drivers, and to manage the computer itself which is hardware. In small computers, firmware may be used as the operating system.

### <>BIOS>>

BIOS allows the CPU to execute procedures to start up the computer hardware and run the operating system, and is most typically the first hardware that the CPU reads when it receives the computer start-up command. This contains the address of the operating system stored in the disk (non-volatile memory), and the BIOS deployed in the CPU sequentially deploys the operating system into the main memory and makes it operational. Note that the BIOS also has a check function for checking the presence or absence of various devices connected to the bus. The results of the check are stored in the main memory and made available to the operating system as appropriate. Note that the BIOS may also be configured to check external devices and the like. Note that a computer may be configured to start up using UEFI (Unified Extensible Firmware Interface), a successor to BIOS with similar functions, instead of BIOS. The above applies to all embodiments.

As shown in FIG. 7, the present invention can basically be configured with a general-purpose computer program and various devices. The operation of the computer basically takes a form in which a program recorded in the non-volatile memory is loaded into the main memory, and processing is performed by the main memory, the CPU, and the various devices. Communication with the devices is performed via an interface connected to a bus line. Possible interfaces include a display interface, a keyboard, a communication buffer, and the like. Hereinafter, embodiments of the present invention will be described together with illustrated examples.

Hereinafter, embodiments of the present invention will be described with reference to the drawings. Note that the present invention is not limited to these embodiments and can be embodied in various forms without departing from the spirit of the present invention.

### Distributed Arrangement of Various Server Devices and Various Terminal Devices of the Present Invention

Regarding the various server devices and various terminal devices constituting the present invention, the server devices may each be housed in a single housing to constitute the invention, but the server devices may be housed in multiple housings and consequently cooperate to constitute a server device. In other words, the server devices may be distributed. Each of the aforementioned hardware may constitute a server device. The terminal devices may also housed in a single housing to constitute the invention, but they may be housed in multiple housing to constitute a terminal device. Each of the aforementioned hardware may constitute a terminal device.

### Terminology Used in the Present Invention

“Identification information” refers to symbols, characters, codes, and the like that are used to identify something. In some cases, the identification information itself may be the information to be identified. For example, position message identification information itself may be a position message. Therefore, “the position message identification information” may refer to merely a symbol, character, code, or the like, or simultaneously to the position message itself identified by the symbol, character, code, or the like.

“Association” is used in this specification to refer to not only cases where two or more pieces of information are directly associated, but also cases where two or more pieces of information are indirectly associated via one or more other pieces of information. The indirect association is not necessarily limited to an association within one device (a device with a single housing), but also includes cases where a plurality of devices are associated.

In the following description, the position message system of the present invention may be referred to as the present system.

### Embodiment 1: (Corresponding to Inventions 1, 12, and 15)

### <Embodiment 1: Overview>

The position message server device (A) according to Embodiment 1 is characterized by having a function by which, when a user makes a new post, users who are following the user who made the post are notified that a new post has been made.

### <Embodiment 1: Outline of Network Configuration of the Present System>

FIG. 1 is a diagram of an outline of a network configuration showing connection between apparatuses constituting a position message system of the present invention. A user terminal device (B) (0140) such as a tablet or a smartphone used by a user is connected to a position message server device (A) (0110) via a network such as the Internet (0101). When the user posts a message from the user terminal device (B) (0140), the message is associated with geographical information and recorded in the position message server device (A) (0110). A user other than the user who posted the message accesses and views or plays back the message which has been recorded in the position message server device (A) (0110) and is accessible, based on geographical information in which the user terminal device (B) used by him or her is and which is acquired.

### <Embodiment 1: Functional Configuration>

FIG. 3 is a block diagram showing a configuration of functions of the position message server device (A) according to Embodiment 1. The position message server device (A) (0310) of the position message system according to Embodiment 1 has a user identification information retaining unit (AA) (0311), a post information acquisition unit (AB) (0312), a post information retaining unit (AC) (0313), a content record notification request acquisition unit (AD) (0314), and a notification processing unit (AE) (0315).

### <Embodiment 1: User Identification Information Retaining Unit (AA) (0311)>

The “user identification information retaining unit (AA)” (0311) is configured to retain user identification information for identifying a user.

### <Embodiment 1: User Identification Information Retaining Unit (AA): User Identification Information>

The “user identification information” is information for uniquely identifying a user of the position message system, such as a membership number. The user identification information may be, for example, an ID code such as a membership number, which is a combination of alphanumeric characters issued by the present system, or an ID code or an email address designated by the user. The user identification information (e.g., an ID code or an email address) may be used as a user ID for logging in to the present system. The user may first access the position message server device (A) and input an ID code or an email address to use the present system, or the system may assign an ID code as appropriate. If user terminal identification information (such as a MAC address or a serial number), which is information for identifying a user terminal device (B) (described later) used by a user, can be uniquely associated with the user (e.g., biometric authentication of a smartphone), the user terminal identification information may be used as the user identification information. The user identification information such as the aforementioned ID code used for user registration is retained in the user identification information retaining unit (AA).

### <Embodiment 1: User Identification Information Retaining Unit (AA): User Attribute Information>

The user identification information retaining unit (AA) (0311) can be configured to retain information such as the user's name, phone number, address, email address, age, gender, nickname, password, and group affiliation as user attribute information, which is information indicating the attributes of the user, in a non-volatile memory in association with the user identification information such as the ID code. The user terminal identification information (such as a MAC address and a serial number), which is information for identifying a user terminal device (B) used by a user, may also be retained as the attribute information. It can be achieved by a configuration in which the position message server device (A) has the user attribute information retaining unit for retaining the user attribute information, which is information indicating the attributes of the user in association with the user identification information.

### <Embodiment 1: User Identification Information Retaining Unit (AA): Example of User Identification Information Registration in the Present System>

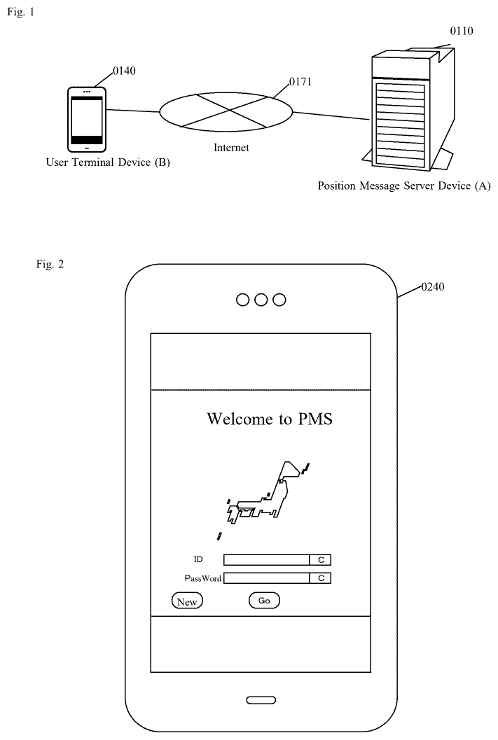

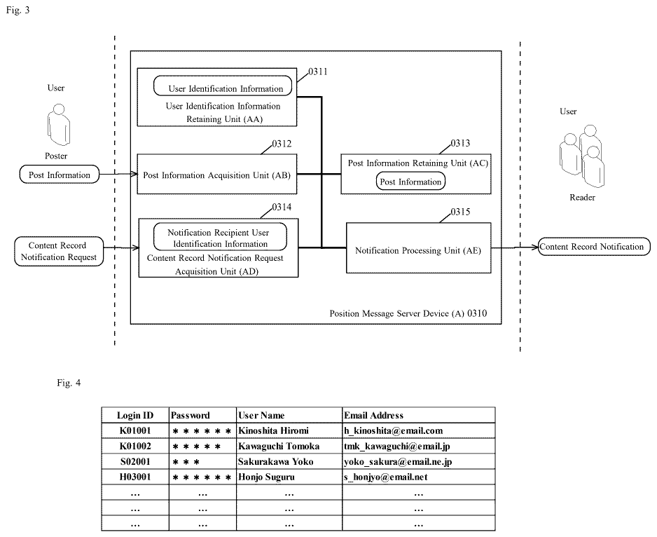

FIG. 2 is a schematic diagram showing an example of a login screen for the position message server according to Embodiment 1. The user terminal device (B) (0240) is a terminal, such as a smartphone, that is equipped with a function for utilizing signals from positioning satellites and can connect to the Internet via a mobile communication network. On a screen of the user terminal device (B) (0240) in FIG. 2, a login screen for a PMS (Position Message Service) application, which is the present system according to the present invention, is shown. The PMS may be configured so that it can be used by activating the application, or it can be logged in by accessing a predetermined address using a browser running on the user terminal device (B). An ID code, which is the user identification information, is input in an input field indicated as “ID” on the PMS application screen in FIG. 2, and a password previously set by the user is input in a PassWord input field. When a “Go” button below the password input field is pressed, the ID code and the password are checked, and if they match the information retained in association with the user identification information, the user can log in.

When using the PMS application for the first time, user registration is required. A “New” button on the lower side of the screen of the user terminal device (B) (0240) shown in FIG. 2 is pressed, and the user inputs the user's desired ID code (email address is also acceptable), password, or other attribute information (which may be optional) is input. It may be configured such that a one-time password or a link is sent as a confirmation email to an email address used by the user when registering for the first time (preferably an email address that can receive emails on the user terminal device (B)), and authentication is accomplished by inputting the one-time password or accessing a website dedicated to initial login confirmation.

Logging in to the PMS may be configured such that: after the initial login process is performed from one terminal, the logged-in state is always maintained unless the PMS application is terminated; when the PMS application is terminated or the user terminal device (B) is terminated, information for maintaining the logged-in state to the application is recorded and retained in the non-volatile memory in the user terminal device (B), and logging in is performed automatically when the PMS application is restarted so that the user is not aware of the login; or logging in is performed each time the application is restarted after termination. If an inside (screen-side) camera, a fingerprint authentication function, or a microphone is provided on the user terminal device (B), it may be configured such that biometric authentication such as face authentication, fingerprint authentication, or voice authentication is set and used as the user's identity authentication process for unlocking the application that remains in the logged-in state or for logging in after restarting the terminated application. It is possible to save the trouble of inputting the ID code or the password when logging in to the PMS application.

### <Embodiment 1: User Identification Information Retaining Unit (AA): Example of Registration of User Identification Information and Attribute Information>

FIG. 4 is a diagram showing an example of a configuration in which the attribute information is associated with the user identification information retained in the user identification information retaining unit (AA). The password, name, and the email address are retained in association with the user's login ID, which is the user identification information.

### <Embodiment 1: Post Information Acquisition Unit (AB) (0312)>

The “post information acquisition unit (AB)” (0312) is configured to acquire post information, which is information that associates: the user identification information of a user who has recorded a content included in the post information; geographical information including location information, which is information indicating a location used as a requirement for allowing a user other than the user identified by the user identification information to view this content; and the content. The post information sent from the terminal of the user who made a post via a network such as the Internet.

### <Embodiment 1: Post Information Acquisition Unit (AB): Post Information>

In the position message system according to the present invention, the “post information” does not simply refer to the content to be posted, but refers to the content with which at least the geographical information is associated and to which the user identification information is added so that the poster can be identified. In addition to the above, it can be configured to include, for example: time information, which is information indicating the time the content was recorded or posted; environmental information at the time of posting at a site represented by the geographical information associated with the content (weather such as temperature, humidity, scenery, wind speed, and sunshine, events such as festivals and concerts, traffic information, crowd status, incidents, etc.); reading authority information indicating the scope of publication of the post to other users; publication period information indicating publication start and end; and the like.

The content handled by the present invention is a message, which may be a message written in text, or may be a message input as voice data, or a message in which a video, a still image, a symbol, a code, vibrations and accelerations applied to a terminal which posts the post information, and the like are recorded. Image data, video data, and voice data may also be included as additional information of the message in association with the message. Alternatively, the message may be composed of a text format and designation data for synthetic voice for reading and reproducing (synthetic voice data itself, or setting information for voice synthesis software, etc.). It may be made by converting acquired voice data into a text message using a known voice recognition technique. The post information is created by associating the above-described message with at least the user identification information of the user who input the message and the geographical information indicating the point where the message was input.

### <Embodiment 1: Post Information Acquisition Unit (AB): Geographical Information>

The “geographical information” is information whose location can be identified, and is preferably latitude and longitude which can be acquired using a function to use signals from positioning satellites, but may also be address-based information. In addition, if there is a famous landmark at the point indicated by the latitude and longitude, information about it may also be associated and recorded. An address may also be obtained from a telephone number or a postal code. The geographical information may not only be information indicating a specific location, but also be information on movement. The information on movement may be, for example, something like route information from a car navigation system, or information indicating one or more passing points. It may also be information such as route information including the order of passing through one or more passing points, or information indicating one or more passing points in random order. The geographical information may also be location information inside a building. For example, it may be information indicating a specific restaurant in a building, or information indicating a position of a specific seat in a specific restaurant. Of course, it is not limited to information about restaurants, and may also be information indicating other types of buildings or stores in a building. Such information may be information from GPS or positioning satellite functions, or may be information from beacons arranged inside and outside of the building for emitting location information, location information using mobile phone base stations, or Wi-Fi (registered trademark) location information. Furthermore, it may also be image data input from cameras into the terminal which posts the post information, or location information analyzed from the image data. It may also be voice information including: voice announcements such as “Yurakucho Station,” and “Yamanote Line inner loop, next stop is Tokyo”; a melody used to signal departure at a train station; a melody indicating that a train is arriving; announcements in route buses or tourist buses; store guide announcements; voice indicating the poster's own location; or the like.

<embodiment 1: Post Information Acquisition Unit (AB): Example of Geographical Information>

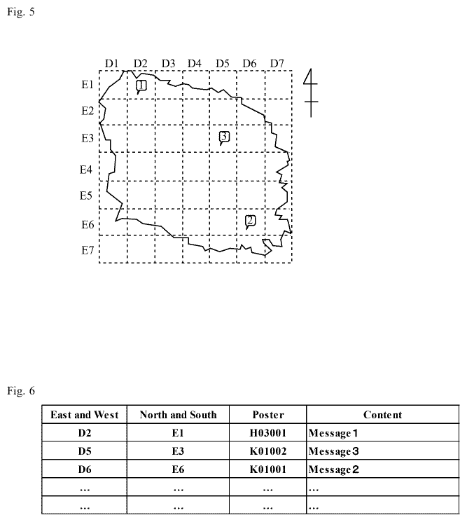

The geographical information may be managed as a point ID by assigning a unique identification number to each location separated by a grid. FIG. 5 is an example for easy understanding in which an island is divided and assigned point IDs as the geographical information. As shown in the figure, the island is managed by dividing it into 49 regions indicated by D1 to D7 and E1 to E7. Each point is assigned as a location ID such as D1E1. A message icon is displayed at a point where a message has been posted, and in the example in the figure, messages have been posted at the points indicated by D2E1, D5E3, and D6E6. A point ID is assigned to each grid-like region, and when a post is made at the location, the point ID and the content are associated and retained. It can be considered to manage the grid-like regions within a visible range of about 5 m to 10 m, but if there are a few distinctive features such as mountains or forests, it is acceptable to manage the regions in a wide range. When the geographical information is managed by latitude/longitude using a function for receiving signals from positioning satellites, it may be set to be readable and reproducible within a 5 m radius of the point where the post was made.

<embodiment 1: Post Information Acquisition Unit (AB): Geographical Information: Shape of Area>

The geographical information is not limited to geometric regions separated by a grid according to latitude/longitude as described above, or a circular region centered on the point where the post was made. For example, for a facility having a plot that is not of a specific geometric shape such as a circle or a rectangle, including shrines, temples, castle ruins, or parks, it is desirable to associate the geographical information so that reading of the posted content is limited to the area within the plot, thereby not allowing users who are not within the plot of the facility to read the posted content. In an extreme example, the post can be read inside a wall surrounding a shrine or temple, but cannot be read by tourist on the sidewalk just outside. Alternatively, it may be a specific location inside or outside a building, such as a specific store in a large shopping mall or a specific seat in a restaurant (such as a seat favored by a celebrity).

### <Embodiment 1: Post Information Acquisition Unit (AB): Geographical Information: Height Direction>

Note that the geographical information can include not only location information along the ground surface such as latitude/longitude, an address, and a plot, but also location information in the height direction, such as the number of floors of a building, how many floors underground it is, altitude, or depth underground or depth below sea level. By including the location information in the height direction, it is possible to distinguish between a post recorded at the Tembo Deck at a height of 350 m and a post recorded at the Tembo Galleria at a height of 450 m on Tokyo Skytree (registered trademark). Alternatively, it is possible to distinguish between a post by a diver visiting the undersea shrine (a branch of Sunosaki Shrine) located 12 meters deep and about 600 meters offshore in the Hasama Undersea Park and a post by a user on the sea surface. The range in the height direction can be as appropriate; for example, if the posting site is in a building, it can be set to a range that includes the height of one floor, allows an error of one floor above and below, etc.

### <Embodiment 1: Post Information Acquisition Unit (AB): Geographical Information: Temporal Condition>

Temporal conditions that a poster sets as conditions for a post may also be included as the geographical information. The post may be made public a predetermined period after it was posted, or conversely, it may be made public only for a predetermined period after it is published and then be made available to limited audiences or made completely private (or deleted). The post may also be made public for a predetermined period after a predetermined period has elapsed since posting. For example, if a user posts a photo of cherry blossoms in full bloom at a castle ruins park, the post could be made public only during the period from March to the end of April the following years, i.e., during the period when cherry blossoms are likely to be in bloom. It can also be configured such that users who visit the castle ruin park during the publication period during which cherry blossoms are in bloom can view the post. In addition, it may also be configured to add further conditions such as allowing only users who have received a content record notification to view the post. Alternatively, it may also be configured to allow reading when a user other than the poster has stayed in the location information (location information not only as a point but also an area or a region) associated with the post information including the content for a predetermined period or longer. In contrast to a person who visits the posting site with an interest and stays there for the aforementioned predetermined period (e.g., 10 minutes) or longer, a user who is simply passing by or who stops for waiting for the traffic light to change to green, etc., can be denied reading.

### <Embodiment 1: Post Information Acquisition Unit (AB): Geographical Information: Posting Site: Visited Before>

It is desirable that the location information included in the geographical information associated with the content included in the post information is acquired when the poster visits the spot and posts the content. However, it may also be configured such that, if a user does not have enough time to calm down and post a content while he or she is visiting a spot, and posts after leaving the site (including after a long time has passed), a history of visiting the spot at another site (history of the location information) can be referenced and posted in association with the content. For example, when a user travels, he or she can make a post about a site he or she visited during the daytime when he or she has time to relax in a hotel at night, or when he or she has enough time after returning home from his or her trip.

### <Embodiment 1: Post Information Acquisition Unit (AB): Geographical Information: Posting Site: Never Visited Before>

As the location information of a site where a content is recorded, even if the poster has never been there, the location information acquired by, for example, selecting on a map, specifying by latitude/longitude, specifying by the name of a building, historical site, or facility, or specifying by an address may be used. With this configuration, for example, a patient who has been hospitalized for a long time and is nearing death can post his or her will as a content while still in the hospital, associating it with the geographical information about his or her own graveyard which he or she has never visited but has had prepared for him or her by a proxy, and set it up so that after his or her death, relatives will gather at his or her graveyard to have his or her will read.

### <Embodiment 1: Post Information Retaining Unit (AC) (0313)>

The “post information retaining unit (AC)” (0313) is configured to retain the acquired post information. The post information acquired by the post information acquisition unit (AB) (0312) is recorded and retained in a large-capacity non-volatile memory. When retaining the post information in the post information retaining unit (AC) (0313), it is desirable to manage it based on the geographical information or/and time information. Also, a list of the post information for each of the pieces of user identification information indicating the posters may be retained so as to search for the post information in association with the posters.

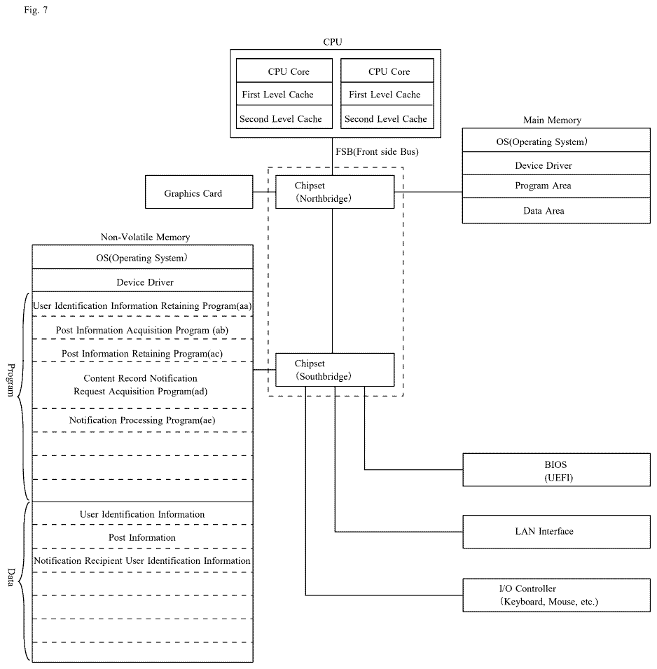

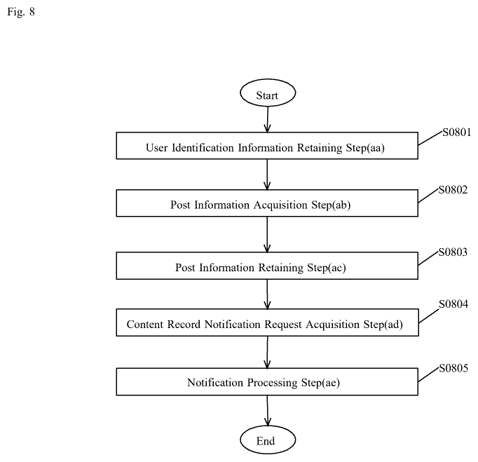

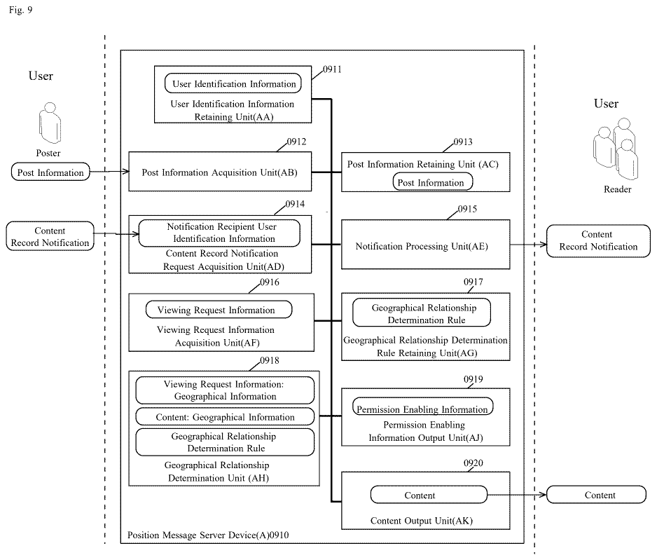

FIG. 6 shows an example of a case where the post information is retained using the point ID as a key. It is retained in a table using East-West D1 to D7 as a first key and North-South as a second key. Since the post information is retained in association with the point ID numbers in ascending order, it is stored in association with the first and second keys in the order of row E1, E2, and E3 in column D1.

When retaining the post information, at least the poster's user identification information is retained as information indicating the poster included in the post information, and for the content, at least a link to the content is retained, thereby making it possible to reduce the amount of data retained in the post information storage unit (AC) (0313). This is because the content is expected to be text, images, voice, video, etc., and the amount of data varies widely. Therefore, the contents may be stored in the order in which they were posted in a place in a non-volatile memory such as an HDD separate from a place where the post information itself is stored, and only the links to them may be retained.

By retaining the post information in the aforementioned manner, the messages posted in the vicinity can be efficiently extracted depending on the user's location when the user searches for and reads them, as in Embodiment 2 described below.

In addition, in parallel with the aforementioned retaining, a list for each poster may be created. This retains the geographical information and the links to the contents using a user identification number of the poster as a key. This makes it easy to extract and use only posts from a specific user.

In addition, in the post information retaining unit (AC), a post information geographical information statistical processing means for statistically processing the geographical information associated with the post information and a post information content statistical processing means for statistically processing details of the content included in the post information can be provided, and furthermore, a geographical information statistical processing information-content statistical processing information relationship analysis means for analyzing the relationship between the statistically processed geographical information and the statistically processed content geographical information can be provided. In addition, a geographical information statistical processing information-content statistical processing information temporal relationship analysis means for analyzing the relationship between the time information, which is information indicating the time when the post information was acquired, and the aforementioned two pieces of statistically processed information may be further provided. The post information geographical information statistical processing means can investigate how the geographical information associated with the post information is distributed. This makes it possible to know whether or not there are a lot of people at a particular station or site, or the like. This analysis may also be carried out from a time series perspective. It is also possible to analyze where there are more people in the morning and where there are more people in the daytime in association with the attribute information (age, gender, place of residence, preferences, etc.). The post information content statistical processing means can investigate people's interests, preferences, and inclinations by statistically processing the details of the content itself, the frequency of categories when content is classified into multiple categories, or the like. This analysis may also be carried out from a time series perspective as well. This makes it possible to know how people's interests change over time. In addition, by analyzing in conjunction with the attribute information (age, gender, place of residence, preferences, etc.), it is possible to know what interests people have according to their attributes. Note that the content may be a reply content which will be described in an embodiment below.

The geographical information statistical processing information-content statistical processing information relationship analysis means analyzes the relationship between the results of statistical processing of the geographical information and the results of statistical processing of the content. It can investigate what kind of content is posted in what sites, i.e., trends in sites and people's interests. An example is a case where in one park, there is a lot of content related to family interactions (playing with children, eating a box lunch, etc.). The geographical information statistical processing information-content statistical processing information temporal relationship analysis means analyzes the relationship between the results of statistical processing of the geographical information and the results of statistical processing of the content from a time perspective. In the aforementioned example, in one park, the content is mainly about flower viewing (with family and friends) instead of family interactions during the cherry blossom season, boating on the park pond and fireworks in summer, and autumn leaves in autumn. If the site is a train station, male and female commuters will post about the rush hour and train operation status in the morning, there will be more reviews of food at nearby restaurants and information about shop in the afternoon, and there will be more information about izakayas and restaurants that serve alcohol from early evening to night. By analyzing the various posting activities made by many users, it is possible to obtain information about the trends and inclinations of the users. It is desirable to explain to users at the time of registration to begin using the present system that the post information, reply content described in an embodiment below, evaluation/ratings, etc. will be used in the present system to understand users'movements and survey their inclinations as a part of the terms of use, and to ensure that those who wish to register agree to this before becoming users of the present system.

### <Embodiment 1: Content Record Notification Request Acquisition Unit (AD) (0314)>

The “content record notification request acquisition unit (AD)” (0314) is configured to acquire a content record notification request, which is a request for notifying a user who is identified by notification recipient user identification information, which is user identification information of a user other than the user who recorded the content, of records of the content included in the post information.

### <Embodiment 1: Content Record Notification Request Acquisition Unit (AD): Content Record Notification Request>

The “content record notification request” is a request issued to the position message server device (A) of the present system to notify a user of the present system other than a poster (a user identified by the notification recipient user identification information) of occurrence of an event of content record (i.e., an event that the poster has recorded a content). It can be configured such that the content record notification request includes the notification recipient user identification information, or a location of the notification recipient user identification information (such as a URL, an address in the non-volatile memory of the position message server device (A)).

### <Embodiment 1: Content Record Notification Request Acquisition Unit (AD): Acquisition of Content Record Notification Request>

There are two possible methods for acquiring the “content record notification request.”

The first method is in a case where the poster of the post information requests by him/herself the position message server device (A) to send the content record notification to a specified user. The poster associates the notification recipient user identification information which is a recipient of the content record notification with the post information and sends it to the position message server device (A) as the content record notification request.

The second method is in a case where a reader, i.e., a user who reads and reproduces the post information, requests to be notified when a specific user, i.e., a poster, makes a new post. The reader requests to be notified when a new post is made by sending his or her own user identification information along with the user identification information of the poster. When a post is made, the content record notification request acquisition unit (AD) (0314) checks whether or not there is a content record notification request for new posts from the poster of the aforementioned post. The content record notification request is created by using the user identification information of the user (reader) who has issued the content record notification request for new posts as the notification recipient user identification information which is a recipient of the content record notification. As notification recipient user identification information, a list of user identification information of users who have issued the content record notification request may also be used. If a content record notification request for a new post is issued by a user (reader) who wishes to be notified whether a specific user makes new post or not, the user who has issued the request may be unconditionally added to the recipient of the content record notification or may be added to the recipient based on the permission of the aforementioned specific user who is the target of the request.

### <Embodiment 1: Notification Processing Unit (AE) (0315)>

The “notification processing unit (AE)” (0315) is configured to perform a process of outputting the content record notification only to the user identified by the notification recipient user identification information included in the content record notification request among the users.

### <Embodiment 1: Notification Processing Unit (AE): Processing of Notification>

A process is performed for notifying a terminal used by a user indicated by the notification recipient user identification information acquired by the content record notification request acquisition unit (AD) (0314), that the content has been recorded. The process for outputting the notification refers to a process which includes, in addition to outputting the notification to the notification recipient, preparation for output, such as: issuing instructions to prepare the notification to be issued to the notification recipient; if the time for publishing the content is limited by the poster's wishes, outputting the prepared notification once the time for publishing has arrived; or outputting the notification with changing the range of notification recipient users according to the poster's wishes.

For example, if the terminal used by the user is a smartphone, one possible method is to send the notification as a push notification of the PMS application or as an SMS. It may also be configured such that the notification is sent by an email to an email address registered by the user. It can also be configured such that the user can specify the notification method.

### <Embodiment 1: Position Message Server Device (A) (0310)>

The “position message server device (A)” (0310) is configured to have the user identification information retaining unit (AA) (0311), the post information acquisition unit (AB) (0312), the post information retaining unit (AC) (0313), the content record notification request acquisition unit (AD) (0314), and the notification processing unit (AE) (0315) described above. The position message server device (A) (0310) is not limited to an aspect in which it is configured by only one device installed at one location. A plurality of position message server devices (A) (0310) with the aforementioned configuration may cooperate to function a single position message server device (A) (0310), or it may be configured such that the aforementioned unit are distributed and arranged as separate devices respectively so as to function in cooperation with each other. When the plurality of devices cooperates to operate as a single position message server device (A), the memory capacity for retaining messages can be increased, and a process of extracting messages according to requests from users and outputting them to the user terminal device (B) can be performed responsively. By arranging the position message server device (A) (0310) near a site where there are many users and where particularly many messages are left, the communication load and processing load can be reduced compared to a configuration in which only a single device is in charge of several sites. The load can be further reduced by arranging multiple position message server devices (A) (0310) near a site where particularly many messages are left, rather than limiting the number to one. This is at the discretion of the operator, as it is a trade-off between the load and the installation and operation costs.

### <Embodiment 1: Present System: Reading Condition Setting for Reader When Posting>

Although Embodiment 1 has a configuration in which the content record notification is output for notification of a new post from a poster, the configuration can also be such that a user (reader) who receives the content record notification can read the post without necessarily visiting the spot where the post was made. The poster may be allowed to set a condition for reading when posting. Possible conditions include: a condition that the content cannot be read unless the reader visits the spot after the post is made; a condition that if the reader has visited the spot at least once, the location information of the visited spots is retained, and the reader can read posts made after the visit; and a condition that whether or not the content can be read is determined based on the relationship between the reader and the poster, regardless of the geographical information of the reader. In the content record notification received by the reader, a link to the location (such as an IP address or an URL) of a storage device where the post information (or the content included in the post information) is recorded, or a link to a web page for reaching the aforementioned link, is included. In the former case, the post information can be read by following the link. In the latter case, the post information can be reached by inputting a password provided in advance by the poster, or by inputting information that identifies the reader as him/herself (biometric information, personal information, etc.). The latter is useful in cases where, if a poster leaves a specific message (e.g., a will) for family members or a specific friend at a specific site and would really like them to visit the spot and read the message, a condition is set so that the message can be read by those who are unlikely to be able to do so (such as an elderly or disabled person).

### <Embodiment 1: Present System: Example of Configuration for Reading Condition Setting for Reader When Posting>

In order for a poster to set a reading condition, which is based on the geographical information and other conditions, when posting, the following example of configuration is conceivable.

The position message server device (A) is configured such that it further has:
a viewing permission determination rule retaining unit for retaining a viewing permission determination rule for determining whether users other than the user who posted a content included in the retained post information should be allowed to view the content; and
a viewing permission determination unit for determining whether to allow the other users to view the content, wherein
the post information acquisition unit (AB) acquires post information including the viewing permission determination rule of the content associated with the content.

The viewing permission determination rule for determining whether to permit viewing based on the geographical information may be a geographical relationship determination rule described later in Embodiment 2.

### <Embodiment 1: Hardware Configuration>

The configuration of Embodiment 1 has been described above, but the case where this is realized as a program or an operation method also falls within the scope of the present invention.

FIG. 7 is a diagram for explaining hardware of the position message server device (A) of the computer-based position message system according to Embodiment 1, the hardware being composed of a mainboard and its peripheral devices.

The position message server device (A) of the computer-based position message system according to Embodiment 1 is composed of a “CPU”, a “chipset” consisting of a northbridge and a southbridge, a “non-volatile memory,” a “main memory,” an “I/O controller,” an “USB, IEEE1394, HDMI (registered trademark), LAN terminal, etc.,” “BIOS,” a “PCI slot,” a “real-time clock,” and the like.

In this configuration, the various programs and data (information) accumulated in the non-volatile memory are deployed on the main memory by starting the present system, and upon receiving an execution command, the CPU sequentially executes the programs to perform calculations using the data.

That is, as shown in FIG. 7, in the position message server device (A) of the computer-based position message system, the non-volatile memory has, in addition to the OS (operating system) and device drivers, a user identification information retaining program (aa), a post information acquisition program (ab), a post information retaining program (ac), a content record notification request acquisition program (ad), and a notification processing program (ae), and the user identification information, the post information, and the notification recipient user identification information are retained as data. They are deployed in the main memory when the present system is started up on a computer, and the CPU sequentially performs calculations using these programs and the data by accepting a start-up command.

### <Embodiment 1: Processing Flow>

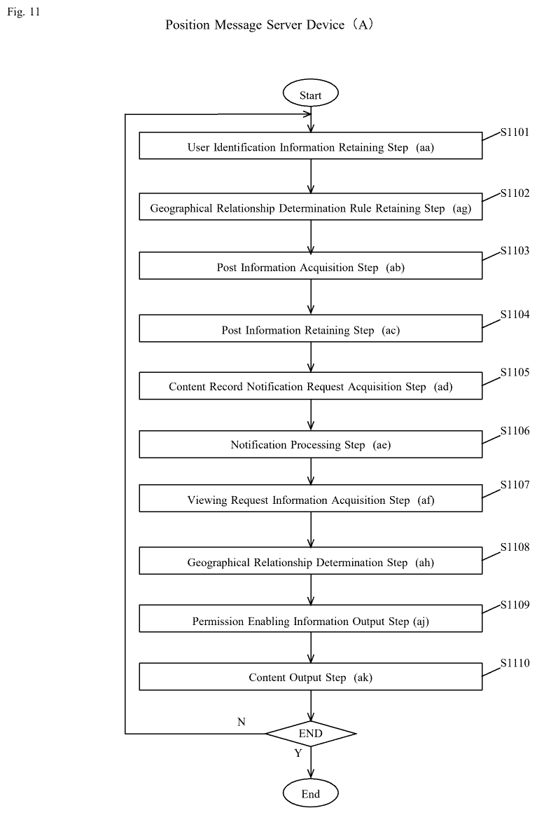

FIG. 8 is a flow chart showing a flow of control of the computer-based position message server device (A). The operation method of the position message server device (A) of the computer-based position message system according to Embodiment 1 includes a user identification information retaining step (aa) (S0801), a post information acquisition step (ab) (S0802), a post information retaining step (ac) (S0803), a content record notification request acquisition step (S0804), and a notification processing step (ae) (S0805).

The user identification information retaining step (aa) (S0801) performs a process of retaining user identification information for identifying a user;
the post information acquisition step (ab) (S0802) performs a process of acquiring post information, which is information that associates: the user identification information of a user who has recorded a content included in the post information; geographical information including location information, which is information indicating a location used as a requirement for allowing a user other than the user identified by the user identification information to view this content; and the content;
the post information retaining step (ac) (S0803) performs a process of retaining the acquired post information;
the content record notification request acquisition step (ad) (S0804) performs a process of acquiring a content record notification request, which is a request for outputting a content record notification for notifying a user other than the user who recorded the content that the content included in the post information has been recorded, the request including notification recipient user identification information, which is user identification information of a user who is a notification recipient; and
the notification processing step (ae) (S0805) performs a process of performing a process of outputting the content record notification only to the user identified by the notification recipient user identification information included in the content record notification request among the users.

The above-mentioned operation method is to have the position message server device (A) of the computer-based position message system execute such a series of processes.

<embodiment 1: Effect>

As described above, with the position message server device (A) of the position message system according to Embodiment 1, it is possible to inform related users that a content has been recorded at the same time as the content is posted.

### Embodiment 2: (Corresponding to Inventions 2, 13, and 16)

### <Embodiment 2: Overview>

The position message server device (A) according to Embodiment 2 is based on Embodiment 1 and is configured such that a reader attempting to read a post is permitted to do so only if the geographical information associated with the post and the geographical information of the reader attempting to view the post are in a predetermined relationship. The simplest example of the predetermined relationship is a relationship of being in the same site (in a predetermined range from the posting site: including a case where the reader is within a circle/sphere or rectangle centered on the posting site or within a plot of a facility or historical site that includes the posting site).

### <Embodiment 2: Functional Configuration>

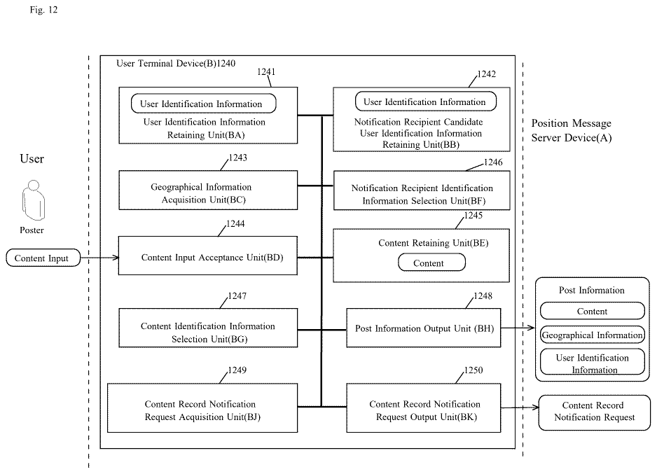

FIG. 9 is a functional block diagram of the position message server device (A) according to Embodiment 2 based on Embodiment 1. In addition to the configuration of Embodiment 1, it further has a viewing request information acquisition unit (AF) (0916), a geographical relationship determination rule retaining unit (AG) (0917), a geographical relationship determination unit (AH) (0918), a permission enabling information output unit (AJ) (0919), and a content output unit (AK) (0920).

### <Embodiment 2: Viewing Request Information Acquisition Unit (AF) (0916)>

The “viewing request information acquisition unit (AF)” (0916) is configured to acquire viewing request information, which is information associating a request for viewing the retained post information and the geographical information including a location information which is information indicating at least a site of a user terminal device (B) being about to issue the request.

### <Embodiment 2: Viewing Request Information Acquisition Unit (AF): Location Information>

The user terminal device (B) used by the user who wishes to read the retained post information obtains the location information of the site where it is present at the time based on longitude/latitude information obtained by a function build into the user terminal device (B) for receiving signals from positioning satellites, or location information obtained by a mobile phone network or Wi-Fi (registered trademark). For example, if the user terminal device (B) is connected to the Internet via the user's mobile phone by tethering or the like, location information of the user's mobile phone may be acquired and used as the location information of the device itself.

### <Embodiment 2: Viewing Request Information Acquisition Unit (AF): Viewing After Leaving Posting Site>

It may also be configured such that if the user who visits the posting site issues the viewing request information from the user terminal device (B) and acquires the requested content of the post information from the position message server device (A), the content acquired by the user can be viewed even after the user and/or the user terminal device (B) has left the posting site. Alternatively, it can also be configured such that if the user visits the posting site even once while carrying the user terminal device (B), the user can view the post information which he or she has not viewed at the the posting site even after leaving the posting site. Conversely, it may also be configured in a limited manner such that, as a geographical relationship determination rule described below, the post information or the content included in the post information may not be output if the user is not actually at the spot when issuing the viewing request information.

### <Embodiment 2: Viewing Request Information Acquisition Unit (AF): Example of Configuration for Viewing After Leaving Posting Site>

In order to view the content after leaving the posting site, the following example of configuration is conceivable.

It can be achieved by configuring the user terminal device (B) to have:
a user terminal device location information history retaining unit for retaining the location information acquired by the user terminal device (B);
a location information history acquisition unit for searching for and acquiring the location information to be associated with the viewing request information from among the location information retained in the user terminal device location information history retaining unit; and
a viewing request information output unit for outputting viewing request information, which is information associating a request for viewing the retained post information and geographical information including the acquired location information.

### <Embodiment 2: Geographical Relationship Determination Rule Retaining Unit (AG) (0917)>

The “geographical relationship determination rule retaining unit (AG)” (0917) is configured to retain a geographical relationship determination rule, which is a rule for determining whether the geographical information included in the viewing request information and the geographical information associated with the retained content have a predetermined relationship.

### <Embodiment 2: Geographical Relationship Determination Rule Retaining Unit (AG): Predetermined Relationship: Location Information>

The phrase “geographical information have a predetermined relationship” means that an area of the geographical information associated with the post information encompasses the geographical information of the user terminal device (B) which has issued the viewing request information. As described in Embodiment 1, the area of geographical information including the location information of the site where the post information has been acquired can be: a circular or rectangular region centered on the point where the post was made; a region that does not have a specific geometric shape such as plots of facilities like shrines and temples, historical sites, or parks; or the like. When determining the geographical relationship, the geographical information may also include altitude information. By including altitude information, regarding the example in Embodiment 1, it is possible to distinguish between post information posted at the Tembo Deck (at a height of 350 m) and post information posted at the Tembo Galleria (at a height of 450 m) of Tokyo Skytree (registered trademark) even if they have the same longitude/latitude information.

### <Embodiment 2: Geographical Relationship Determination Rule Retaining Unit (AG): Predetermined Relationship: Condition Other Than Location>

When determining whether a predetermined relationship is satisfied, whether the poster satisfies a temporal condition set in the post information may also be added to the determination rule in addition to the aforementioned location information and altitude information. Furthermore, whether the user has received the content record notification from the poster may also be added to the determination rule. The geographical relationship determination rule may also be set such that the predetermined relationship is that the location information or altitude information has a predetermined condition, and at the same time, the user satisfies the temporal condition set by the poster and has received the content record notification.

### <Embodiment 2: Geographical Relationship Determination Unit (AH) (0918)>

The “geographical relationship determination unit (AH)” (0918) is configured to determine, based on the geographical information included in the viewing request information, the geographical information associated with the retained content, and the retained geographical relationship determination rule, whether the two pieces of geographical information have a predetermined relationship.

It is determined whether they have a predetermined relationship based on the geographical relationship determination rule. As described above, the determination is made not only on whether the user terminal (B) which has issued the viewing request information is located within a region such as a circle or rectangle centered on the posting site, but also on whether it is located within a plot of a shrine, temple, historical site, or the like which does not have a specific geometric shape, and whether they have a predetermined relationship in the height direction. If the rules to which a temporary condition or other conditions are added are applied, it is determined whether they have a predetermined relationship based on these rules as well.

<Embodiment 2: Permission Enabling Information Output Unit (AJ) (0919)>

The “permission enabling information output unit (AJ)” (0919) is configured to output permission enabling information, which is information enabling permission to view the content which is requested to be viewed in the viewing request information, when the geographical relationship determination unit (AH) determines that they have the predetermined relationship.

### <Embodiment 2: Content Output Unit (AK) (0920)>

The “content output unit (AK)” (0920) is configured to output the requested content to the user terminal device (B) (0940) that has output the viewing request information when a predetermined process is completed based on the output permission enabling information.

### <Embodiment 2: Content Output Unit (AK): Predetermined Process>

It receives the permission enabling information and outputs the contents to the user terminal device (B) which has output the viewing request information. Prior to this output, a predetermined process is performed including, for example: a process of searching for and acquiring the post information including the requested content from the post information retaining unit (AC); a process of retaining a history of when and to which user terminal device (B) the content included in which post information was output (a content output history retaining means may be provided in the content output unit); and the like. If a fee is required to read the post information, processing is performed so that the user identified by the user identification information associated with the user terminal device (B) which has output the viewing request information deposits the required amount using an online payment means such as electronic money, and the deposit is confirmed.

### <Embodiment 2: Hardware Configuration>

The configuration of Embodiment 2 has been described above, but the case where this is realized as a program or an operation method also falls within the scope of the present invention.

FIG. 10 is a diagram for explaining hardware of the position message server device (A) of the computer-based position message system according to Embodiment 2, the hardware being composed of a mainboard and its peripheral devices.

The position message server device (A) of the computer-based position message system according to Embodiment 2 is composed of a “CPU”, a “chipset” consisting of a northbridge and a southbridge, a “non-volatile memory,” a “main memory,” an “I/O controller,” an “USB, IEEE1394, HDMI (registered trademark), LAN terminal, etc.,” “BIOS,” a “PCI slot,” a “real-time clock,” and the like.

In this configuration, the various programs and data (information) accumulated in the non-volatile memory are deployed on the main memory by starting the present system, and upon receiving an execution command, the CPU sequentially executes the programs to perform calculations using the data.

That is, as shown in FIG. 10, in the position message server device (A) of the computer-based position message system, the non-volatile memory has, in addition to the OS (operating system) and device drivers, a user identification information retaining program (aa), a post information acquisition program (ab), a post information retaining program (ac), a content record notification request acquisition program (ad), and a notification processing program (ae), as well as a viewing request information acquisition program (af), a geographical relationship determination rule retaining program (ag), a geographical relationship determination program (ah), a permission enabling information output program (aj), and a content output program (ak), and the user identification information, the post information, and the notification recipient user identification information, as well as the viewing request information, the geographical relationship determination rule, the permission enabling information, and the content are retained as data. They are deployed in the main memory when the present system is started up on a computer, and the CPU sequentially performs calculations using these programs and the data by accepting a start-up command.

### <Embodiment 2: Processing Flow>

FIG. 11 is a flow chart showing a flow of control of the computer-based position message server device (A). The operation method of the position message server device (A) of the computer-based position message system according to Embodiment 1 includes a user identification information retaining step (aa) (S1101), a geographical relationship determination rule retaining step (ag) (S1102), a post information acquisition step (ab) (S1103), a post information retaining step (ac) (S1104), a content record notification request acquisition step (S1105), a notification processing step (ae) (S1106), a viewing request information acquisition step (af) (S1107), a geographical relationship determination step (ah) (S1108), a permission enabling information output step (aj) (S1109), and a content output step (ak) (S1110).

The user identification information retaining step (aa) (S1101) performs a process of retaining user identification information for identifying a user;
the geographical relationship determination rule retaining step (ag) (S1102) performs a process of retaining a geographical relationship determination rule, which is a rule for determining whether the geographical information included in the viewing request information and the geographical information associated with the retained content have a predetermined relationship;
the post information acquisition step (ab) (S1103) performs a process of acquiring post information, which is information that associates: the user identification information of a user who has recorded a content included in the post information; geographical information including location information, which is information indicating a location used as a requirement for allowing a user other than the user identified by the user identification information to view this content; and the content;
the post information retaining step (ac) (S1104) performs a process of retaining the acquired post information;
the content record notification request acquisition step (ad) (S1105) performs a process of acquiring a content record notification request, which is a request for outputting a content record notification for notifying a user other than the user who recorded the content that the content included in the post information has been recorded, the request including notification recipient user identification information, which is user identification information of a user who is a notification recipient;
the notification processing step (ae) (S1106) performs a process of performing a process of outputting the content record notification only to the user identified by the notification recipient user identification information included in the content record notification request among the users;
the viewing request information acquisition step (af) (S1107) performs a process of acquiring viewing request information, which is information associating a request for viewing the retained post information and the geographical information including a location information which is information indicating at least a site of a user terminal device (B) being about to issue the request;
the geographical relationship determination step (ah) (S1108) performs a process of determining, based on the geographical information included in the viewing request information, the geographical information associated with the retained content, and the retained geographical relationship determination rule, whether the two pieces of geographical information have a predetermined relationship;
the permission enabling information output step (aj) (S1109) performs a process of outputting permission enabling information, which is information enabling permission to view the content which is requested to be viewed in the viewing request information, when the geographical relationship determination step (ah) (S1108) determines that they have the predetermined relationship; and
the content output step (ak) (S1110) performs a process of outputting the requested content to the user terminal device (B) that has output the viewing request information when a predetermined process is completed based on the output permission enabling information.

The above-mentioned operation method is to have the position message server device (A) of the computer-based position message system execute such a series of processes.

### <Embodiment 2: Effect>

As described above, the position message server device (A) of the position message system according to Embodiment 2 can prevent the content from being read unless the geographical relationship determination unit (AH) of the position message server device (A) determines that the geographical information including at least the location information of the site where the content included in the post information has been recorded and the geographical information of the user terminal (B) which has issued the viewing request information have a predetermined relationship. The simplest predetermined relationship is that the reader cannot read the content unless the reader goes to the site where the content has been recorded. When a user actually visits a site and views a content recorded at that site, the content resonates with the user more, making the site more memorable for the user who views the content, and the content the user views also more memorable.

### Embodiment 3: (Corresponding to Inventions 3, 14, and 17)

### <Embodiment 3: Overview>

The position message system according to Embodiment 3 has a user terminal device (B) and is configured to associate a content input by a user with geographical information including location information of the system and user identification information of the user who uses the system and to post the content as post information. It is also configured such that when posting, it retains user identification information of users who are notification recipient candidates as notification recipient candidate user identification information, and when a new post is made, it outputs a request to notify a user selected as a notification recipient from the retained notification recipient candidate user identification information that the post has been made.

### <Embodiment 3: Functional Configuration>

FIG. 12 is a block diagram showing a configuration of functions of the user terminal device (B) which the position message system according to Embodiment 3 based on Embodiment 1 has. In addition to the position message server device (A) according to Embodiment 1, the position message system according to Embodiment 3 further has the user terminal device (B) (1240). The user terminal device (B) (1240) has a user identification information retaining unit (BA) (1241), a notification recipient candidate user identification information retaining unit (BB) (1242), a geographical information acquisition unit (BC) (1243), a content input acceptance unit (BD) (1244), a content retaining unit (BE) (1245), a notification recipient identification information selection unit (BF) (1246), a content identification information selection unit (BG) (1247), a post information output unit (BH) (1248), a content record notification request acquisition unit (BJ) (1249), and a content record notification request output unit (BK) (1250). Hereinafter, each of the functional configurations will be described with reference to FIG. 12, and examples of each configuration will be described using separate figures as appropriate. Note that the same effect can be obtained even if Example 2 is used as a base.

### <Embodiment 3: User Identification Information Retaining Unit (BA) (1241)>

The “user identification information retaining unit (BA)” (1241) is configured to retain user identification information for identifying a user who uses the system.

### <Embodiment 3: User Identification Information Retaining Unit (BA): User Identification Information>

The “user identification information” is identification information for uniquely identifying a user of the position message system, such as a membership number as described in Embodiment 1 above. Regarding the user identification information, for example, the user may first access the position message server device (A) and input an ID code or an email address to use the present system, or the system may assign an ID code composed of alphanumeric characters as appropriate. The ID code or the email address may also be used as a user ID for logging in to the present system. If user terminal identification information (such as a MAC address or a serial number), which is information for identifying a user terminal device (B) (described later) used by a user, can be uniquely associated with the user (e.g., biometric authentication of a smartphone), the user terminal identification information may be used as the user identification information. The user identification information of the user who uses the user terminal device (B) by which user registration was made is retained in the user identification information retaining unit (AA) of the position message server device (A) via the user terminal device (B) and is also retained in a user identification information retaining unit (BA) (1241) of the user terminal device (B) used by the user.

### <Embodiment 3: User Identification Information Retaining Unit (BA): User Attribute Information>

The user identification information retaining unit (BA) (1241) is configured to retain, in a non-volatile memory, the user identification information such as the aforementioned ID code in association with user attribute information, which is information indicating the attributes of the user. Examples of the user attribute information include information such as the user's name, phone number, address, email address, age, gender, nickname, password, and group affiliation. Information for identifying a user terminal device (B) used by a user (such as a MAC address and a serial number) may also be retained as the user attribute information. By using the user identification information configured as information in which the user ID of the present system is associated with the name, email address, or password, the user terminal device (B) can be configured to automatically connect to the position message server device (A) or to add the user identification information to the post information.

### <Embodiment 3: User Identification Information Retaining Unit (BA): Example of Configuration for Retaining User Attribute Information>

The retention of the aforementioned attribute information can be achieved by a configuration in which the user terminal (B) has a user attribute information retaining unit for retaining the user attribute information, which is information indicating the attributes of the user.

### <Embodiment 3: Notification Recipient Candidate User Identification Information Retaining Unit (BB) (1242)>

A “notification recipient candidate user identification information retaining unit (BB)” (1242) shown in FIG. 12 is configured to retain notification recipient candidate user identification information, which is information of a user other than the user identified by the user identification information and who may be a candidate for the notification recipient described below.

A user who is to make a post selects a user who may be a candidate for a notification recipient when making a new post and retains him or her in the notification recipient candidate user identification information retaining unit (BB) (1242) of the user terminal device (B) (1240). To register the notification recipient candidate user, it is sufficient that at least the user identification information (e.g., user ID) is retained in the user terminal device (B). Alternatively, it may also be configured such that when the user who makes a post selects the user who will be the notification recipient candidate, the user terminal device (B) used by the user who makes a post accesses the position message server device (A), selects the user who is desired to be the notification recipient candidate from among the user identification information retained in the user identification information retaining unit (AA) of the position message server device (A), and acquires the user identification information.

### <Embodiment 3: Notification Recipient Candidate User Identification Information Retaining Unit (BB): Search for Notification Recipient Candidate User>

If it is configured such that the user attribute information is retained in the position message server device (A), the attribute information (e.g., notification recipient candidate user name, nickname, or affiliated group name) may be searched by using characters of a selection menu. If the group affiliation is selected, the user identification information of all users belonging to that group may be acquired. Regarding search for users, such a configuration is desirable that all users retained in the user identification information retaining unit (AA) of the position message server device (A) are not included in the search, and each user can only be searched for by other users for whom the user has given permission to be searched. For example, if the attribute information includes the name of the high school graduated, the graduation year, and the class name, it can also be configured such that the search is performed for users who graduated from the same high school or for schoolmates.

### <Embodiment 3: Notification Recipient Candidate User Identification Information Retaining Unit (BB): Notification Recipient Candidate User List>

A plurality of notification recipient candidate user lists including at least one piece of the notification recipient user identification information may also be retained. In other words, it can be configured such that, when it is desired to change the user to be notified depending on details of the post information, the notification recipient candidate user list is switched, and the notification recipient is selected from the notification recipient candidate user list after the switching, or all the users identified by the user identification information included in the notification recipient candidate user after the switching is selected. It may also be configured such that the notification recipient candidate user lists are shared among users who may make a post. For example, this applies to a case where those with similar interests such as travel or food create a group to notify each other when they make a post. Such a configuration is preferred that a notification recipient candidate user list is shared and retained as one of the notification recipient candidate user lists in the user terminal device (B) of each user, and when a user selects the notification recipient candidate user list of a group to which the user belongs as notification recipients, the notification is made excluding the user him/herself from the notification recipients.

### <Embodiment 3: Present System: Example of Notification Recipient Candidate User Registration>

A case of registering the notification recipient user identification information on the PMS will be described using FIG. 14. In FIG. 14, a PMS application is activated on a smartphone as the user terminal device (B) (1440), and a notification recipient user registration screen is displayed.

### <Embodiment 3: Present System: Up to Notification Recipient Candidate User Registration Screen>

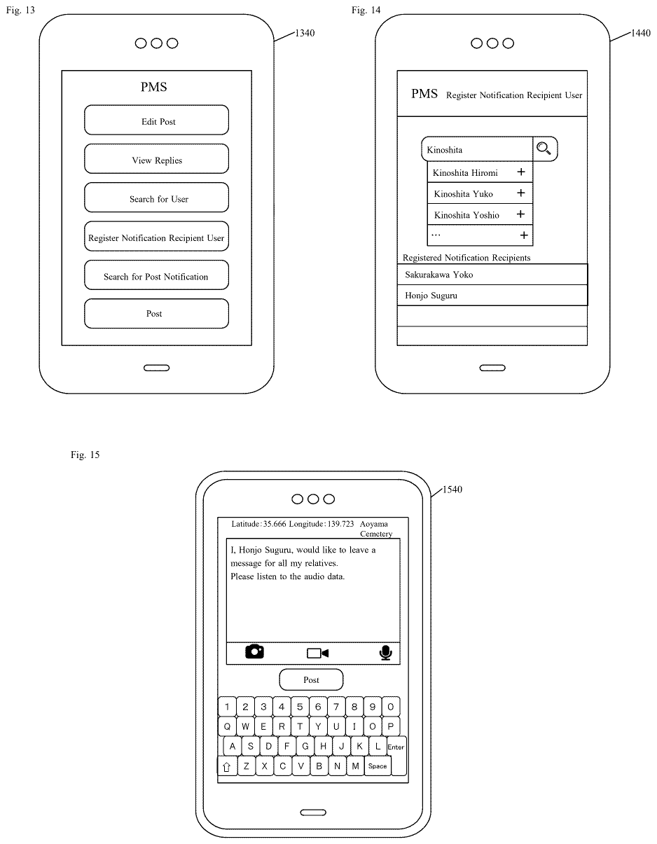

First, an outline of how the screen state of FIG. 14 is reached will be described. The PMS application shown in the example of FIG. 14 is configured such that when it is activated, it automatically logs in to the position message server device (A) based on the user identification information retained in the user identification information retaining unit (BA) and the attribute information associated with the user identification information. When the PMS application is activated and automatically logs in to the position message server device (A), an initial selection screen shown in FIG. 13 is displayed, in which each button is arranged so that the user can read and reproduce the user's own post information in the server device, post the post information, search for users, register notification recipient users when the user makes a post, etc. When pressing a “notification recipient user registration” button the screen transitions to the notification recipient user registration screen.

### <Embodiment 3: Present System: Notification Recipient Candidate User Registration Screen: Search>

In the notification recipient user registration screen shown in FIG. 14, a search word input field is arranged at the top. To perform a search, by inputting a name, a user's ID code, a nickname, or an email address as a keyword and pressing a search button, a search can be performed for a user to be registered as a notification recipient. As information other than the user's ID code, the user attribute information registered by the user when registering for use of the present system can be used. In the example of FIG. 14, “Kinoshita” has been input in the search word input field, so user names beginning with “Kinoshita” are displayed as a pull-down menu below the search word input field. It may be configured such that the pull-down menu of candidates opens by pressing a magnifying glass button to the right of the search word input field, or that candidates are displayed in the pull-down menu each time a character of a search word is input, and the candidates change each time a character of the search word is added. By pressing a “+” button at the right end of each field in the pull-down menu, the displayed users who are candidates can be added to the notification recipients. Users currently registered as the notification recipients are displayed at the bottom of the screen.

### <Embodiment 3: Present System: Notification Recipient Candidate User Registration Screen: Addition>

On the screen of FIG. 14, when pressing the “+” button at the right end of the field for “Kinoshita Hiromi” from among the users whose names begin with “Kinoshita” displayed as a result of the search by inputting “Kinoshita,” Kinoshita Hiromi is registered in the list of registered notification recipients at the bottom of the screen. It may be configured such that it is additionally inserted above Sakurakawa Yoko in FIG. 11, or it may be configured such that it is added below Honjo Suguru.

### <Embodiment 3: Geographical Information Acquisition Unit (BC) (1243)>

The “geographical information acquisition unit (BC)” (1243) of the user terminal (B) shown in FIG. 12 acquires geographical information including location information of the user terminal device (B). Examples of the geographical information include: location information specified by a user such as latitude/longitude, an address, or a point ID; and information that allows to specify a location or a limited area such as names or plots (regions) of landmarks, facilities, or historical sites. The location information is set as a rectangular area with predetermined length and width around a specified point, or an area of a predetermined radius centered on a specified point, and for the predetermined area, the default numerical values of the present system such as 10 m square or radius of 10 m may be used as they are, or the poster may arbitrarily specify the predetermined area.

### <Embodiment 3: Geographical Information Acquisition Unit (BC): Case Where Post is Made at the Spot>

When a post is made at the spot, it can be configured such that the location information that has been acquired by the user terminal device (B) is acquired as the geographical information. When the user terminal device (B) is a smartphone, it can acquire location information which can be grasped by communication with a mobile location station; latitude/longitude information obtained from a device receiving and processing signals from positioning satellites if such a device is provided; location information acquired by an internet search based on a landscape photo of a historical site to be posted taken with a camera; or altitude information if the user terminal device (B) is equipped with a barometer. It is preferable that the acquired location information is presented to a user who wishes to make a post, and if necessary, the user corrects it and output the post information from the user terminal device (B).

<Embodiment 3: Geographical Information Acquisition Unit (BC): Case Where Post is Made after Leaving the Spot>

A user who wishes to make a post related to a point may make such a post later. For example, when a user visited a historical site during a tour but could not make a post at the spot because it was approaching time to move the next site, the user makes the post after checking into a hotel in the evening. A user who wishes to make a post may input longitude/latitude, an address, a name of a landmark, etc. as text, or may specify a location or an area on a map etc. Alternatively, the specification by the text or map may be converted into another method of expressing a point such as latitude/longitude or a point ID. It may also be configured such that the user reads out a location on the map or a name of a building or historical site that could be a landmark to allow the system to recognize the user's voice for voice input.

<Embodiment 3: Present System: Case Where Post is Made with Specifying Posting Point on Map>

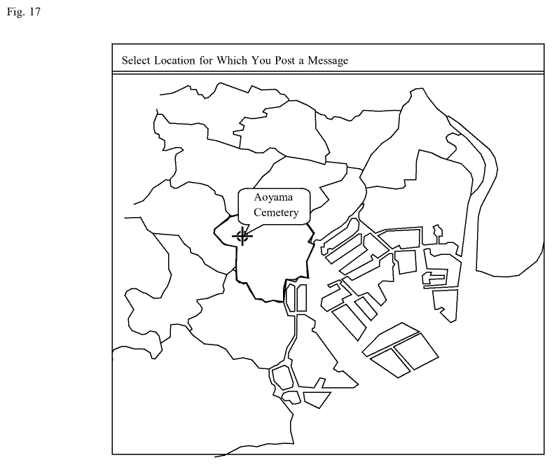

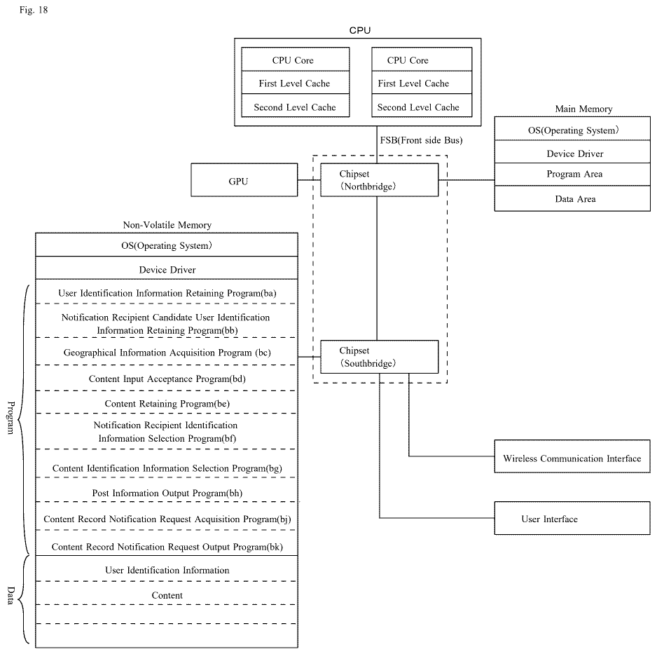

FIG. 17 is an example of a case where a spot is specified on a map. This is a case where a user uses a map for posting a message with specifying a location of, for example, the user's grave in Aoyama Cemetery. If the user whishing to make the post has difficulty inputting characters using a keyboard or by hand, such a configuration is preferred that the user moves a cursor on a map with a finger, etc., and the name of the place or building where the cursor is located is displayed in a speech bubble near the cursor. In FIG. 14, the site indicated by the circle and cross cursor is Aoyama Cemetery. Although not shown, it can also be configured to use a map of Aoyama Cemetery to specify a site closer to the destination on the map. If the location for which a post is to be made can be specified on a map or the like in this way, even those who are unable to move due to illness or the like can leave messages anywhere in the world.

### <Embodiment 3: Content Input Acceptance Unit (BD) (1244)>

The “content input acceptance unit (BD)” (1244) shown in FIG. 12 is configured to accept input of the content.

### <Embodiment 3: Content Input Acceptance Unit (BD): Content>

In the position message system, the “content” is a message that is post information, and is composed of a combination of one or more of text, image data, video data, voice data, etc. The content input acceptance unit (BD) (1244) has a configuration to which these data can be input or which can acquire these data.

### <Embodiment 3: Present System: Example of Entering Content>

FIG. 15 is an example of a case the content input acceptance unit (BD) receives the input of content. FIG. 15 shows a smartphone as an example of the user terminal device (B) (1240). The latitude/longitude and the name of the point are displayed as the geographical information at the top of the screen, and below that there is a text input field, and below the text input field, there are displayed a camera button, a video button, a microphone button, a post button, and a software keyboard in this order.

Text input is input by operating a keyboard when a message is input as text. The keyboard may be a kana input keyboard or a keyboard for kana flic input, etc.

When the camera button is pressed, a camera application of the user terminal device (B) is activated and take an image, and this image can be posted as a message body or as an attachment to a message in text format. When taking the image, the internal (screen side) camera and the external (back side of the screen) camera built into the smartphone can be switched as appropriate.

When the video button is pressed, a camera of the user terminal device (B) is activated and a video can be taken, and this video can be posted as a message body or as an attachment to a message in text format. When taking the video, the internal (screen side) camera and the external (back side of the screen) camera built into the smartphone can be switched as appropriate.

When the microphone button is pressed, a microphone of the user terminal device (B) is activated, allowing voice to be recorded and a voice message to be posted. It may also be configured such that the voice can be posted as data attached to the text, image, or video message. Voice input may also be used as an input interface for text messages. In addition, as data attached to the message, environmental information (temperature, humidity, weather, sunshine, precipitation, sunrise/sunset times, low/high tide times, or phenological observation information such as cherry blossom front) of the point indicated by the geographical information associated to the content may be attached.

It is possible to create the content by combining a variety of data in such a manner as overlaying text data on an image as a telop, inserting in the middle, and even overlaying a message in the poster's own voice, a song, or a performance, or music, sounds, etc. that are not the poster's own, and to render it the post information. When the “post” button slightly below the center of the screen in FIG. 15 is pressed, the content is output as the post information and acquired by the post information acquisition unit (AB) of the position message server device (A). In the manner described above, image data, video data, and voice data in addition to text messages can be acquired by the smartphone which is the user terminal device (B) as the content.

The example in FIG. 15 is a screen on which Honjo Suguru is creating a message to leave a will addressed to his relatives and close relatives at the location of his grave, with specifying Aoyama Cemetery as the geographical information. As the geographical information, the latitude and longitude of the point specified by the user who is making the post (Honjo Suguru in this example) on the user terminal device (B) is acquired from the geographical information acquisition unit (BC) and displayed. The user inputs a message in text, presses the microphone button to record a message that will be his will by voice, and enters the content of the message.

### <Embodiment 3: Content Retaining Unit (BE) (1245)>

The “content retaining unit (BE)” (1245) shown in FIG. 12 is configured to retain the content of which input has been accepted in association with content identification information, which is information that identifies the content.

### <Embodiment 3: Content Retaining Unit (BE): Content Storage Location>

The content input and accepted in the content input acceptance unit (BD) (1244) can be configured to be stored in a corresponding storage location according to the type of the content. For example, text messages are stored in the document storage location, image data is stored in the image data storage location, video data is stored in the video data storage location, and voice data is stored in the voice data storage location. As the content identification information, which is information identifying the content, for example, a content ID composed of alphanumeric characters may also be retained in association with the content storage location, input time, the geographical information of the location where the input was made, etc. Regarding the content made by combining the text message and the voice data, it can be configured such that text message address information indicating an address in the document storage location where the text message is stored and in voice data address information indicating an address in the storage location where the voice data is stored are retained in association with the content identification information (e.g., content ID). When searching for the content later, the content identification information can be used instead of a large file containing the text message and the voice data, video data, etc., so as to reduce communication volume, lighten data processing, and enable faster search.

### <Embodiment 3: Notification Recipient Identification Information Selection Unit (BF) (1246)>

The “notification recipient identification information selection unit (BF)” (1246) shown in FIG. 12 is configured to select as notification recipient identification information for identifying the notification recipient from the retained notification recipient candidate user identification information. To notify other users that a post has been made when posting the content retained in the content retaining unit (BE) (1245) as the post information, users to be notified are selected from the notification recipient user identification information.

### <Embodiment 3: Present System: Example of Selecting Notification Recipient Identification Information>

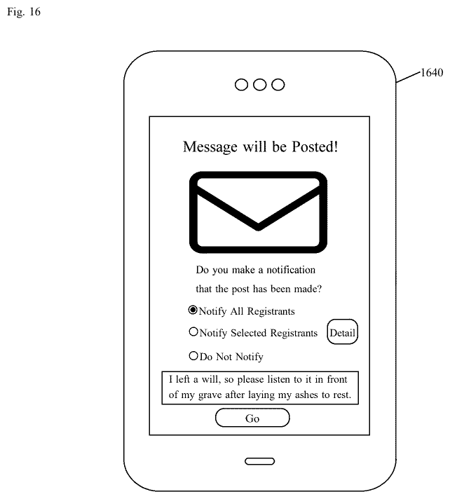

FIG. 16 is a diagram showing an example of selection of the notification recipient identification information, in which a smartphone is used as the user terminal device (B) (1640), and when making a new post, on the final confirmation screen for whether or not to make the post, the notification recipient setting for the post is selected. This is an example of the selection of the notification recipient identification information by the notification recipient identification information selection unit (BF), and in FIG. 16, one of the following is selected: to notify all the user registered in the user terminal device (B); to select some of the registered users and to notify them; of not to notify all registered users. When the notification recipients are selected from the registered users, a list of registered notification recipient candidate users is displayed by pressing a “details” button, allowing to select the users to be notified. When a “Go” button is pressed, the post information is output to the post information acquisition unit (AB) of the position message server device (A), and the selected notification recipient user identification information is also sent as a content record notification request. A comment input field below the notification recipient is an input field for inputting a comment to be added to the content record notification, and no comment may be input.

### <Embodiment 3: Content Identification Information Selection Unit (BG) (1247)>

The “content identification information selection unit (BG)” (1247) shown in FIG. 12 is configured to select a piece of the content identification information that identifies the retained content. When a user who is a poster makes a post, the user select the content to be posted from among the contents input in the content input acceptance unit (BD) (1244) and retained in the content retaining unit (BE) (1245).

Generally, in the position message system, a user inputs a content, which is a message, at a predetermined location with which the user wishes to associate a post, and posts the content while remaining at that location. In this case, the user simply selects and registers a content identification number of the content stored in the content retaining unit (BE) (1245) immediately before making the post.

### <Embodiment 3: Content Identification Information Selection Unit (BG): Case Where Post Is Made Later>

Unlike the above, it can also be configured such that a user inputs a content, which is a message, at a predetermined location with which the user wishes to associate a post, retains the content in the content retaining unit (BE) (1245), and acquires geographical information including the user's own location information from the geographical information acquisition unit (BC), but the post information, which is a post, is sent later after moving to another location. An example of such a case is when the location with which the user wishes to associate the post is outside the service area of the mobile communication contracted by the smartphone of the user who is to make the post, so that data communication is not possible there. In addition, another example is when the post information is sent from a site where high-capacity communication such as Wi-Fi (registered trademark) is available, because the content allows videos with large file size so that when posting the content including videos, the communication data volume becomes large, the communication time becomes long, and the communication fee becomes high. In this case, when the content is retained in the content retaining unit (BE), the geographical information needs to be retained in association with the content identification information.

### <Embodiment 3: Content Identification Information Selection Unit (BG): Case Where Poster Posts Different Point>

It can also be configured such that, when the user wishes to make a post related to a site where the user has not been or a site where the user has been but for whish the user did not acquire the location information, the user acquires the geographical information of the site which the user wishes to associate the post with from a map, latitude/longitude information, an address, a landmark name, etc. For example, a case where Honjo Suguru is to leave a will message with respect to the site of his grave in Aoyama Cemetery was described using FIGS. 15, 16, and 17. However, if Honjo Suguru is already hospitalized and bedridden when he decides to leave his will, he cannot go to the spot and acquire the geographical information. Thus, it may be configured such that the location information is acquired from a map, etc., as described above. Furthermore, if it is configured such that the location information of the actual location of the user terminal device (B) itself when the operation of acquiring the geographical information was performed is acquired as reference information in addition to the acquired geographical information, there are two pieces of location information (one of which is the reference information) so that the readers can understand that the poster was in a different site when the poster acquired the geographical information which the post was associated with.

### <Embodiment 3: Post Information Output Unit (BH) (1248)>

The “post information output unit (BH)” (1248) shown in FIG. 12 is configured to output as post information, which is information that associates: the content identified by the selected piece of the content identification information; the geographical information acquired when the input of the content was accepted, and the user identification information of the user who uses the system.

The post information output unit (BH) (1248) outputs the post information to the post information acquisition unit (AB) of the position message server device (A), for example via a network such as the Internet by using a communication method such as mobile communication of a smartphone or Wi-Fi (registered trademark), the post information being composed by associating one or more of the following contents: text messages, image data, video data, voice data, etc., which are contents associated with the content identification information selected in the content identification information selection unit (BG) (1247), with latitude and longitude information or information such as a point ID, which is the geographical information retained in association with the contents, and the user's own user identification information. Transmission of the post information is started by pressing the Go button described with reference to FIG. 13.

### <Embodiment 3: Content Record Notification Request Acquisition Unit (BJ) (1249)>

The “content record notification request acquisition unit (BJ)” (1249) shown in FIG. 12 is configured to acquire a content record notification request, which is a request to notify the user identified by the selected piece of the notification recipient user identification information that the selected content is to be recorded or has been recorded.

The content record notification request acquisition unit (BJ) (1249) acquires content record notification request which requests the position message server to notify the users identified by the user identification information selected in the notification recipient identification information selection unit (BF) (1246) that the content has been recorded. As described above, the notification recipient users may be selected as a list when selecting the notification recipient information, or the users on the list may be selected, or the users may be selected individually one by one, or the users on the list and the individually selected users may be selected together. A request is made to notify the users selected in this way.

### <Embodiment 3: Content Record Notification Request Output Unit (BK) (1250)>

The “content record notification request output unit (BK)” (1250) shown in FIG. 12 is configured to output the acquired content record notification request. The content record notification request output unit (BK) sends the content record notification request acquired by the content record notification request acquisition unit to the content record notification request acquisition unit (AD) of the position message server device (A), for example via a network such as the Internet by a communication method such as mobile communication of a smartphone or Wi-Fi (registered trademark).

### <Embodiment 3: Content Record Notification Request Output Unit (BK): Content Record Notification Comment Input Acceptance Means>

In order to add the summary of the post information to the content record notification and send it, the following example of configuration is conceivable.

The user terminal (B) is further configured such that:
the content record notification request output unit (BK) (1250) has a content record notification comment input acceptance means for accepting input of a comment indicating the summary of the post information in order to add the summary of the post information to the content record notification and send it; and
the content record notification request output unit (BK) includes the accepted input comment into the content record notification request and sends it to the position message server device (A).

### <Embodiment 3: Content Record Notification Request Output Unit (BK): Comment>

The comment input by the poster him/herself is intended to briefly inform the notification recipient user about which type of the message the post to which the comment is added is. This allows the user who has received the content record notification to know the outline of the message that was posted and to decide whether or not to go to the site for viewing or reading the message. An example of a specific configuration of the content record notification comment input acceptance means is the comment “This is a will” in the comment input field at the bottom of the post confirmation screen shown in FIG. 16. It is desirable not to limit the number of characters or the duration of voice or video for the messages constituting the contents of the post information. On the other hand, it is preferable to limit the number of characters for the comments for notifying the notification recipient users of the outline of the message. If the comment is displayed as a search result together with the poster's ID in searching for the message, it becomes easier for the user who wishes to read the message to understand the outline of the message and to make a selection. However, if the comment is too long, it is unclear whether the user will be able to obtain useful information when the search results are displayed, and if there is no limit on the number of characters, there is a possibility that a comment that is almost the same as the text of the message body will be posted.

### <Embodiment 3: Hardware Configuration>

The configuration of Embodiment 3 has been described above, but the case where this is realized as a program or an operation method (process flow) also falls within the scope of the present invention. FIG. 18 is a diagram showing a hardware configuration of a smartphone, which is an example of the user terminal device (B) according to Embodiment 3. In addition to the position message server device (A) according to Embodiment 1, the position message system according to Embodiment 3 further has the user terminal device (B), and the user terminal device (B) has a “CPU,” a “chipset” consisting of a northbridge and a southbridge, a “non-volatile memory,” a “main memory,” a “GPU” (Graphics Processing Unit), a “wireless communication interface,” and a “user interface.” Note that similar effects can be obtained using Embodiment 2 as a base.

The CPU reads and executes programs from the main memory to control each unit. The main memory is a memory which can be accessed at high speed by the CPU, and loads and temporarily records programs and data or is used as a working area for the CPU. The chipset 1404 relays access from the CPU to low-speed external devices and interfaces with various devices. The GPU is a processor dedicated to image processing and controls the display on the screen. The wireless communication interface communicates with external communication devices via mobile communication connected to a public line or wireless communication such as Wi-Fi (registered trademark) or Bluetooth (registered trademark). The user interface 1407 is a touch panel, a switch, etc. and accepts operational inputs from the user.

In this configuration, the various programs and data (information) accumulated in the non-volatile memory are deployed on the main memory by starting the present system, and upon receiving an execution command, the CPU sequentially executes the programs to perform calculations using the data.

That is, as shown in FIG. 18, in the user terminal device (B) of the computer-based position message system, the non-volatile memory has, in addition to the OS (operating system) and device drivers, a user identification information retaining program (ba), a notification recipient candidate user identification information retaining program (bb), a geographical information acquisition program (bc), a content input acceptance program (bd), a content retaining program (be), a notification recipient identification information selection program (bf), a content identification information selection program (bg), a post information output program (bh), a content record notification request acquisition program (bj), and a content record notification request output program (bk), and the user identification information and the contents are retained as data. They are deployed in the main memory when the present system is started up on a computer, and the CPU sequentially performs calculations using these programs and the data by accepting a start-up command.

### <Embodiment 3: Processing Flow>

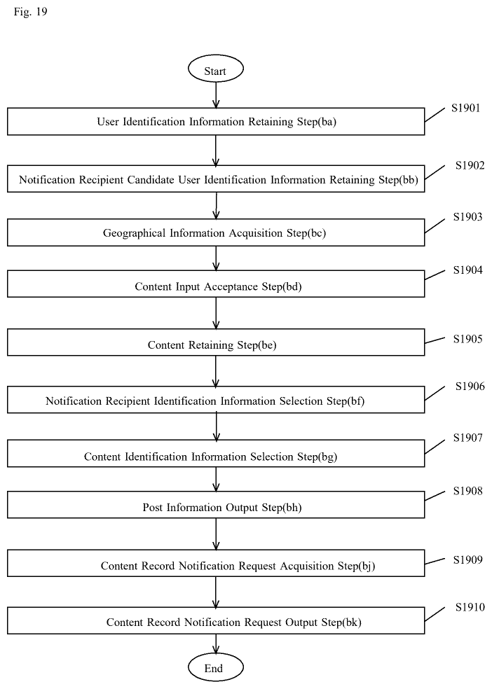

In addition to the operation method of the computer-based position message server device (A) according to Embodiment 1, the computer-based position message system according to Embodiment 3 has an operation method of the computer-based user terminal device (B). FIG. 19 is a flowchart showing a processing flow in the user terminal device (B) of the position message system according to Embodiment 3. The operation method of the computer-based user terminal device (B) further has a user identification information retaining step (ba) (S1901), a notification recipient candidate user identification information retaining step (bb) (S1902), a geographical information acquisition step (bc) (S1903), a content input acceptance step (bd) (S1904), a content retaining step (be) (S1905), a notification recipient identification information selection step (bf) (S1906), a content identification information selection step (bg) (S1907), a post information output step (bh) (S1908), a content record notification request acquisition step (bj) (S1909), and a content record notification request output step (bk) (S1910). Note that similar effects can be obtained using Embodiment 2 as a base.

The user identification information retaining step (ba) (S1901) performs a process of retaining user identification information for identifying a user who uses the system;
the notification recipient candidate user identification information retaining step (bb) (S1902) performs a process of retaining notification recipient candidate user identification information, which is information of a user other than the user identified by the user identification information and who may be a candidate for the notification recipient described below;
the geographical information acquisition step (bc) (S1903) performs a process of acquiring geographical information including location information of the user terminal device (B);
the content input acceptance step (bd) (S1904) performs a process of accepting input of the content;
the content retaining step (be) (S1905) performs a process of retaining the content of which input has been accepted in association with the content identification information, which is information identifying the content;
the notification recipient identification information selection step (bf) (S1906) performs a process of selecting notification recipient identification information for identifying the notification from the retained notification recipient candidate user identification information;
the content identification information selection step (bg) (S1907) performs a process of selecting a piece of the content identification information that identifies the retained content;
the post information output step (bh) (S1908) performs a process of outputting post information, which is information that associates the content identified by the selected content identification information, the geographical information acquired when the input of the content was accepted, and the user identification information of the user who uses the system, to the post information acquisition step (ab) of the position message server device (A);
the content record notification request acquisition step (bj) (S1909) performs a process of acquiring a content record notification request, which is a request to notify the user identified by the selected piece of the notification recipient user identification information that the selected content is to be recorded or has been recorded; and
the content record notification request output step (bk) (S1910) performs a process of outputting the acquired content record notification request to the content record notification request acquisition step (ad) of the position message server device (A).

The above-mentioned operation method is to have the user terminal device (B) of the computer-based position message system execute such a series of processes.

Through the above processes, the message post is uploaded to the position message server device (A), and the position message server device (A) notifies the user requested based on the content record notification request that the message has been posted.

### <Embodiment 3: Effect>

The position message system according to Embodiment 3 allows the user to specify a point where the user wishes to leave a message from the user terminal device (B) of the user, post the message, and notify other users that the message has been posted. This allows, for example, the user to post a message associated with a desired point even if there are circumstances that prevent the user from going to the site where the user wishes to leave the message. Therefore, this system can be applied to various games that use position messages, such as orienteering and treasure hunting, as hints or riddles can be posted in advance as messages at some points. In this way, the application of the position message system can lead to regional development and economic revitalization.

### Embodiment 4: Mainly Corresponding to Invention 4

### <Embodiment 4: Overview>

In Embodiment 4 based on Embodiment 3, the location of the user does not necessarily have to be the current location acquired when the input of the content was accepted, but instead the present system further has a viewing-location-limiting remote post information output means (BL) for limiting a viewing location of a user who wishes to view the content.

### <Embodiment 4: Functional Configuration>

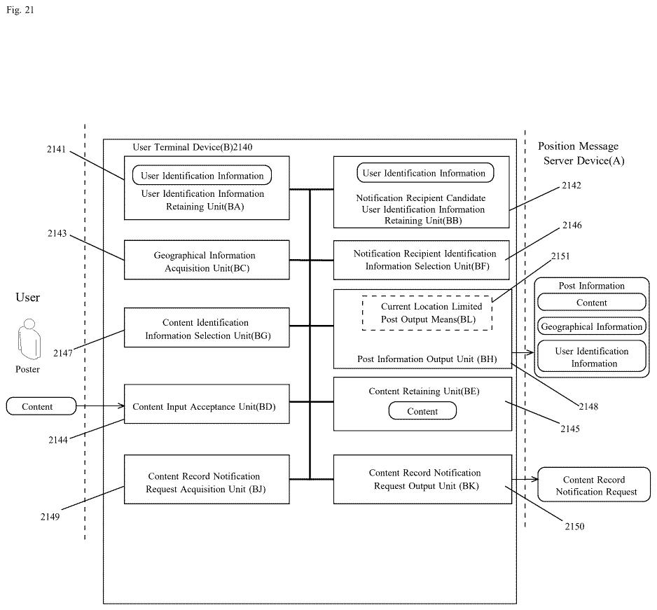

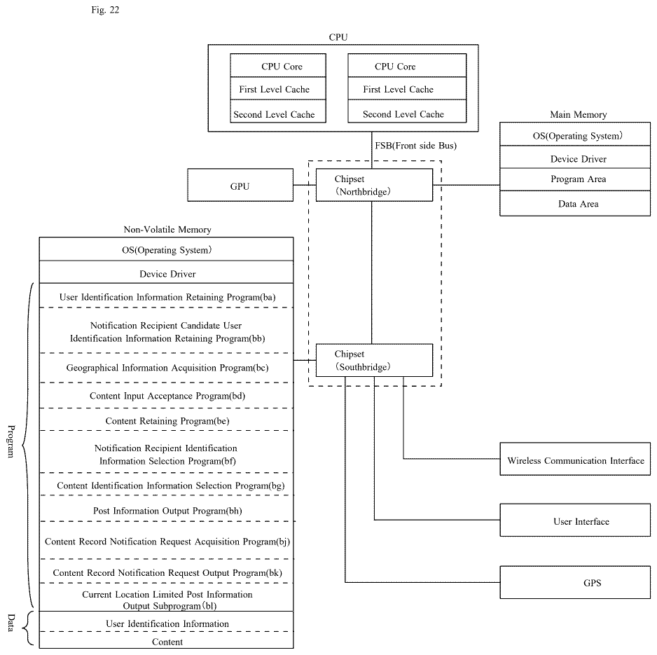

FIG. 21 is a block diagram showing the configuration of functions of the user terminal device (B) of the position message system according to Embodiment 4 based on Embodiment 3. In the user terminal device (B) of the position message system according to Embodiment 4 based on Embodiment 3, the post information output unit (BH) further has the viewing-location-limiting remote post information output means (BL) (2151) in addition to the configuration of Embodiment 3. In addition, the user terminal device (B) has a feature that the geographical information acquired by the geographical information acquisition unit (BC) (2143) is the location information of the site where it is located.

### <Embodiment 4: Geographical Information Acquisition Unit (BC) (2143)>

It is configured such that the geographical information acquired by the “geographical information acquisition unit (BC)” (2143) according to the Embodiment 4 is the location information of the site where the user terminal device (B) is located. Therefore, the geographical information acquisition unit (BC) (2143) acquires the latitude and longitude of the point by using, for example, a function that utilizes signals from positioning satellites. Alternatively, it may adopt a method of acquiring the location from a nearby Wi-Fi (registered trademark) access point or a mobile phone base station. In a case where management is performed using the point IDs as described in FIG. 5, it may also have such a configuration that the latitude and longitude information is converted into the point ID. A predetermined range around the point where the user terminal device (B) is located, determined by latitude/longitude, may be acquired as the geographical information. As described in Embodiment 1, the predetermined range may be a rectangular range with predetermined length and width or length and width specified by the poster, or a circular area defined by a predetermined radius or a radius specified by the poster centered on the point where the user terminal device (B) is located. Alternatively, when the poster is within the plot of a facility as a shrine, temple, or castle ruins, the area of the plot can also be acquired as the geographical information. Furthermore, not only location information along the ground surface, but also altitude information (in both + and − directions relative to the sea level) may also be included as the location information. That is, the location information can be configured as a set of information on latitude, longitude, and altitude.

### <Embodiment 4: Viewing-Location-Limiting Remote Post Information Output Means (BL) (2151)>

The “viewing-location-limiting remote post information output means (BL)” (2151) is configured in the post information output unit (BH) of the user terminal device (B) so as to output, as the geographical information included in the post information, the post information associated with the geographical information for limiting the viewing location which does not necessarily have to be the current location acquired when the input of the content was accepted.

<Embodiment 4: Viewing-Location-Limiting Remote Post Information Output Means (BL): Geographical Information Associated with Site Where Post is Made and with Content>

When inputting the content, the geographical information for the limitation that the content is read by users who wish to read it in a site different from the current site of the user who is making the post (poster) can be selected from a map, be specified by latitude/longitude, be specified by facility name, be specified by an address, or be specified by using the location information in metadata of photos or videos (for photos, Exif data is also available) when the content to be input is a photo or video, for example. This allows, for example, people who have been hospitalized for a long time to leave their will as the content in a cemetery they have never visited, as described above. If the geographical information when the input of the content was accepted is different from the geographical information included in the post information, it can also be configured such that the geographical information when the input of the content is retained as reference information in association with the post information.

By the geographical information associated with the content posted by the remote poster, the viewing location of the users who wish to view the post information (or the content included therein) can be limited by the geographical information associated with the content. The geographical information for this limitation is information including location information (circular or rectangular ranges, plots of facilities, or altitude information, etc.), and temporal information. Although an example has been described above in which the current location acquired when the content of the post information was input is different from the geographical information included in the post information, the two are not necessarily different. They may be the same.

### <Embodiment 4: Present System: Post>

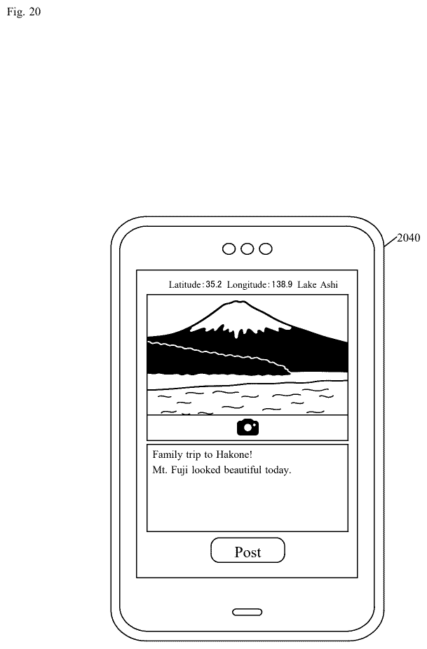

FIG. 20 shows an example of a case where an image of Mt. Fuji is posted from the shore of Lake Ashi by using the user terminal device (B) of the position message system according to Embodiment 4. It is conceivable to configure the screen such that a message is input on the screen as shown in FIG. 15 (although the example of FIG. 15 is not the example of posting an image of Mt. Fuji), and the message is displayed when a camera button or video button is pressed. At the top of the screen of the smartphone 2040, the latitude and longitude of the shore of Lake Ashi as the current location information, and Lake Ashi as a landmark are displayed. The upper half of the screen shows an image captured by the user when the user is about to take a photo. The image is taken by pressing a shutter button shaped like a camera. In the message field in the lower half of the screen, the message which was input before this screen is displayed. It is posted as a message with a photo attached by pressing a “post” button.

<Embodiment 4: Present system: Taking Photo and Posting It Later>

In the above-described example, if a photo is taken, for example, the location information of the site is associated with the contents which are the message and the photo as the geographical information. When the post button is pressed, the post information associated with the location information of the site where the photo was taken is sent to the position message server. In a case of the image data, the location information recorded as Exif information may also be used as the location information as it is. In addition to the “post” button, a “save” button may be configured to enable the message to be saved in the user terminal device (B). It may also be configured such that the message is stored also in the user terminal device (B) when the shutter button is pressed. In this case, it can also be configured such that the stored post information can be opened later and posted by pressing the post button. When posting later, the geographical information of the point where the image was taken is added to the massage. In the case of posting later, if the geographical information of the site where the poster is at the time of posting is associated with the message, which is the content, the viewing-location-limiting remote post information output means may also be configured to restrict posting by making the post switch unable to be pressed. It is preferable to provide a separate operation to remove the posting restriction.

### <Embodiment 4: Hardware Configuration>

The configuration of Embodiment 4 has been described above, but the case where this is realized as a program or an operation method also falls within the scope of the present invention. FIG. 22 is a block diagram showing a hardware configuration of the user terminal device (B) of the position message system according to Embodiment 4 based on Embodiment 3. In addition to the configuration of Embodiment 3, the user terminal device (B) according to Embodiment 4 further has a function of receiving and processing signals from positioning satellites, and it further has a viewing-location-limiting remote post information output subprogram in the non-volatile memory. The programs and subprogram are deployed in the main memory when the present system is started up on a computer, and the CPU sequentially performs calculations using these programs and the data by accepting a start-up command.

### <Embodiment 4: Processing Flow>

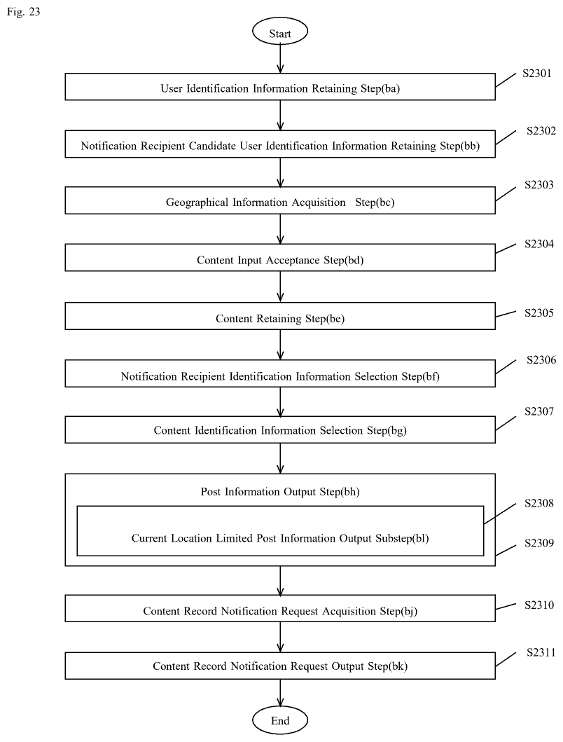

FIG. 23 is a flowchart showing a processing flow of the computer-based user terminal device (B) of the position message system according to Embodiment 4 based on Embodiment 3. The operation method of the user terminal device (B) of the computer-based position message system according to Embodiment 4 further has a user identification information retaining step (ba) (S2301), a notification recipient candidate user identification information retaining step (bb) (S2302), a geographical information acquisition step (bc) (S2303), a content input acceptance step (bd) (S2304), a content retaining step (be) (S2305), a notification recipient identification information selection step (bf) (S2306), a content identification information selection step (bg) (S2307), a post information output step (bh) (S2309), a viewing-location-limiting remote post information output substep (bl) (S2308) in the post information output step (bh) (S2309), a content record notification request acquisition step (bj) (S2310), and a content record notification request output step (bk) (S2311).

The user identification information retaining step (ba) (S2301) performs a process of retaining user identification information for identifying a user who uses the system;
the notification recipient candidate user identification information retaining step (bb) (S2302) performs a process of retaining notification recipient candidate user identification information, which is information of a user other than the user identified by the user identification information and who may be a candidate for the notification recipient described below;
the geographical information acquisition step (bc) (S2303) performs a process of acquiring geographical information including location information of the user terminal device (B);
the content input acceptance step (bd) (S2304) performs a process of accepting input of the content;
the content retaining step (be) (S2305) performs a process of retaining the content of which input has been accepted in association with the content identification information, which is information identifying the content;
the notification recipient identification information selection step (bf) (S2306) performs a process of selecting from the retained notification recipient candidate user identification information as notification recipient identification information for identifying the notification recipient;
the content identification information selection step (bg) (S2307) performs a process of selecting a piece of the content identification information that identifies the retained content;
the viewing-location-limiting remote post information output substep (bl) (S2308) in the post information output step (bh) (S2309) performs a process of outputting the post information associated with, as the geographical information included in the post information, the geographical information for limiting the viewing location which does not necessarily have to be the current location acquired when the input of the content was accepted;
the post information output step (bh) (S2309) performs a process of outputting post information to the post information acquisition step (ab) of the position message server device (A);
the content record notification request acquisition step (bj) (S2310) performs a process of acquiring a content record notification request, which is a request to notify the user identified by the selected piece of the notification recipient user identification information that the selected content is to be recorded or has been recorded; and
the content record notification request output step (bk) (S2311) performs a process of outputting the acquired content record notification request to the content record notification request acquisition step (ad) of the position message server device (A).

The above-mentioned operation method is to have the user terminal device (B) of the computer-based position message system execute such a series of processes.

### <Embodiment 4: Effect>

A user who wishes to make a post, i.e., a poster, can, from a site away from the site where the poster wishes to input the content, associate the geographical information of the site where the poster wishes to input the content with the content and include it in the post information. Therefore, the poster can make a post even if the poster is not in the spot which the post is associated with, and can limit the location where the users who wishes to view the post view the post from a remote location.

### Embodiment 5: Mainly Corresponding to Invention 5

### <Embodiment 5: Overview>

The user terminal device (B) of the position message system according to Embodiment 5 based on Embodiment 3 or 4 acquires a content record notification for notifying the users specified or authorized by the poster that a content has been recorded, and makes the users aware of this.

### <Embodiment 5: Functional Configuration>

FIG. 25 is a block diagram showing a configuration of the position message system according to Embodiment 5 based on Embodiment 3. In addition to the configuration of Embodiment 3, the user terminal device (B) (2540) of the position message system further has a content record notification acquisition unit (BM) (2552).

### <Embodiment 5: Content Record Notification Acquisition Unit (BM) (2552)>

The “content record notification acquisition unit (BM)” (2552) is configured to acquire the content record notification. The content record notification acquisition unit (BM) (2552) acquires the content record notification from the position message server device (A). Then, based on the notification, it is desirable to perform a process for making the users of the user terminal device (B) aware that the notification has been acquired in addition to the display of the notification. The method of making the users aware may be sound, vibration, light emission, etc.

### <Embodiment 5: Content Record Notification Acquisition Unit (BM): Example of Notification>

As a typical examples of notification, there is a push notification as a notification method to the user terminal device (B). A push notification is a mechanism in which, in a client-server system or service, the server side (sender) can actively notify the client (receiver) of information without receiving an inquiry from the client (receiver). In a typical push notification, when an application on the smartphone, which is the user terminal device (B) of the receiver, receives the notification, the notification by text is displayed on the standby screen or home screen of the smartphone, for example. As the methods other than the push notification, communication means such as email, chat, and short message may also be used.

### <Embodiment 5: Flow of Notification to User Terminal Device (B)>

The content record notification request sent to the position message server device (A) is acquired a content record notification request acquisition unit (AD) of the position message server device (A), and the notification processing unit (AE) sends the notification to the users specified by the user identification information included in the content record notification request. When the user terminal device (B) acquires the notification, it makes the user aware of the acquisition of the notification and informs the user that the content has been recorded.

### <Embodiment 5: Present System: Example of Content Record Notification>

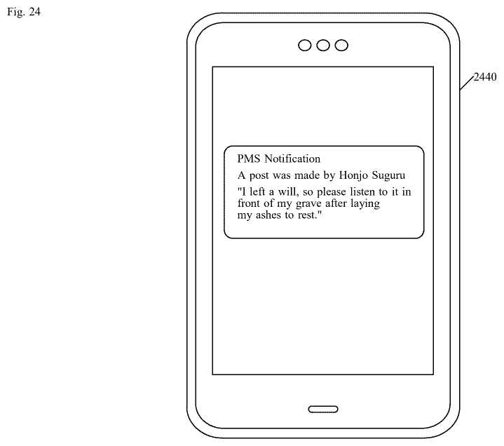

FIG. 24 is an example of the display of the notification in a case where the content record notification which informs the user that the content has been recorded is acquired as a push notification by the smartphone which is the user terminal device (B). On the smartphone screen, which had been the standby screen, a notification is displayed as a push notification from the PMS application informing the user that a post has been made by Honjo Suguru. When receiving the notification, in addition to the display on the screen, standard functions included on typical smartphones are used to make the user of the smartphone aware that the notification was received by sound, vibration, light, etc. As described above, the user can be made aware of the receipt of the notification by using standard functions of the user's communication terminal. It should be configured such that the method of making the user aware can be set by the user. This is because some users prefer only to have the display on the screen, while others prefer to use all of sound, light, vibration, etc. In addition, depending on the relationship between the user and the poster, there may be a relationship in which the user wishes to read the content as soon as the content record notification is received, or a passive relationship in which it is sufficient for the user to read the content during free time such as during the user's break time. Therefore, it may also be configured that the method of making the user aware can be changed depending on the poster's user identification number. Furthermore, in the example of FIG. 24, it is configured such that a comment from the poster is displayed together with the notification for conveying the purpose or the outline of the message included in the post information to the user who received the notification. This function is not essential for the content record notification.

In the example of FIG. 24, it is configured such that by touching the content record notification on the smartphone's standby screen, the PMS application is activated and clarify the details of the post information including the contents which is the subject of the notification. FIG. 26 is an example of the PMS application screen activated by touching the notification. In the example of FIG. 26, the latitude/longitude and the information of the landmarks are displayed on a map displayed on the screen as the location information where the content was recorded. On the map of FIG. 26, the location of the new message is indicated by a solid black icon. Thus, the user can know where the message has been posted. It is configured such that the location of a message which is a content associated with the content record notification that the user of the user terminal device (B) has already received, is also displayed differently by, for example, changing the color or icon shape, and in addition, it can also be configured such that they are displayed simultaneously.

### <Embodiment 5: Hardware Configuration>

The configuration of Embodiment 5 has been described above, but the case where this is realized as a program or an operation method also falls within the scope of the present invention. FIG. 27 is a diagram showing an example of a hardware configuration of the user terminal device (B) of the position message system according to Embodiment 5 based on Embodiment 3. In addition to the configuration of Embodiment 3, the user terminal device (B) according to Embodiment 5 further has a content record notification acquisition program. The content record notification acquisition program is deployed in the main memory when the present system is started up on a computer, and the CPU sequentially performs calculations using these programs and the data by accepting a start-up command.

### <Embodiment 5: Processing Flow>

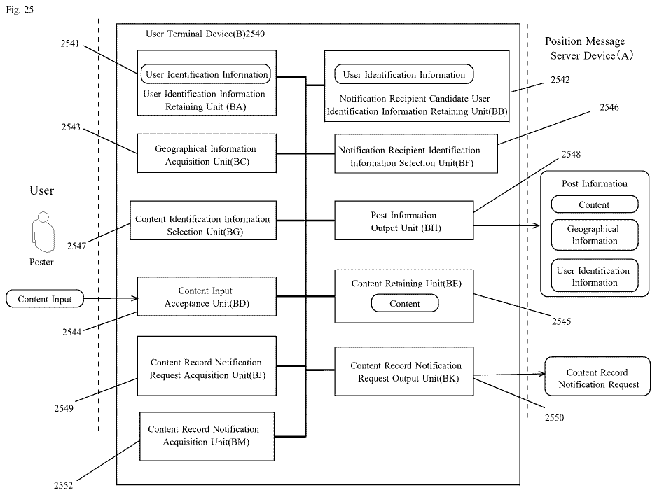

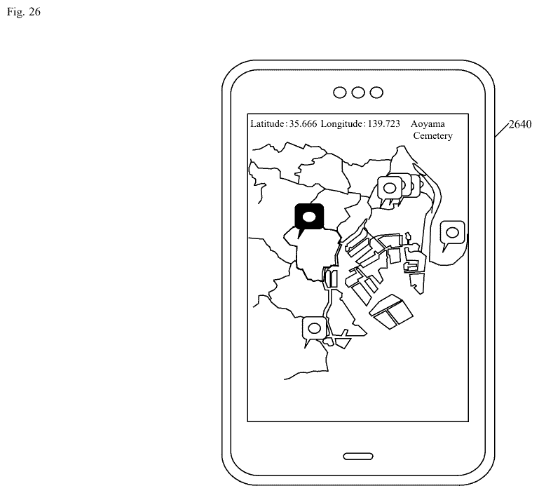

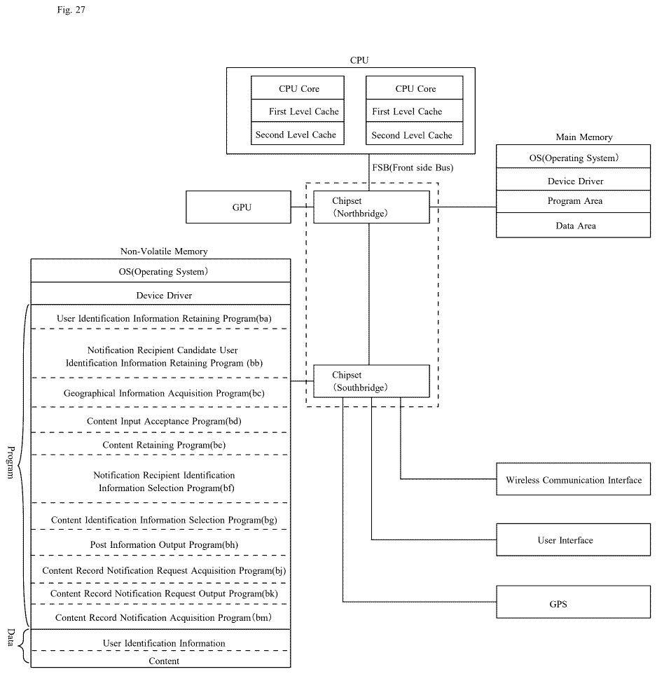

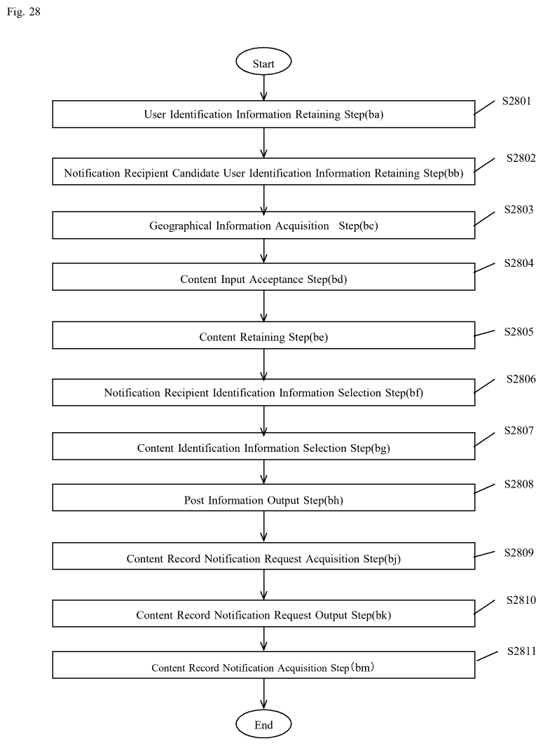

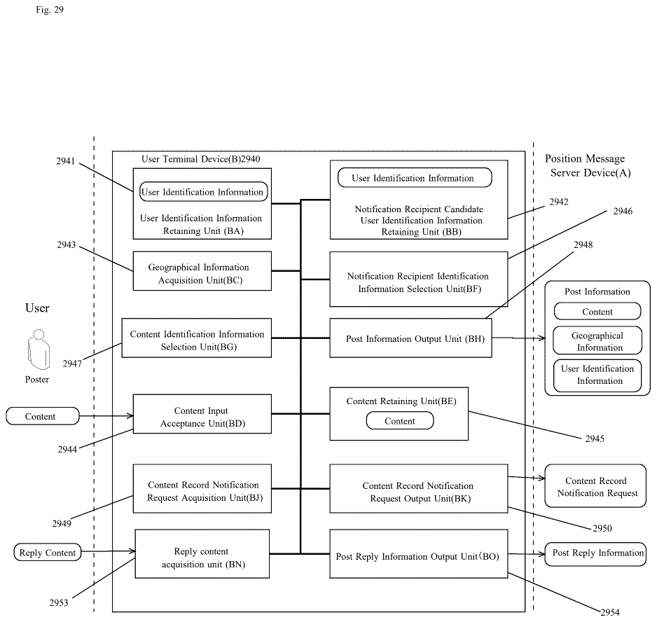

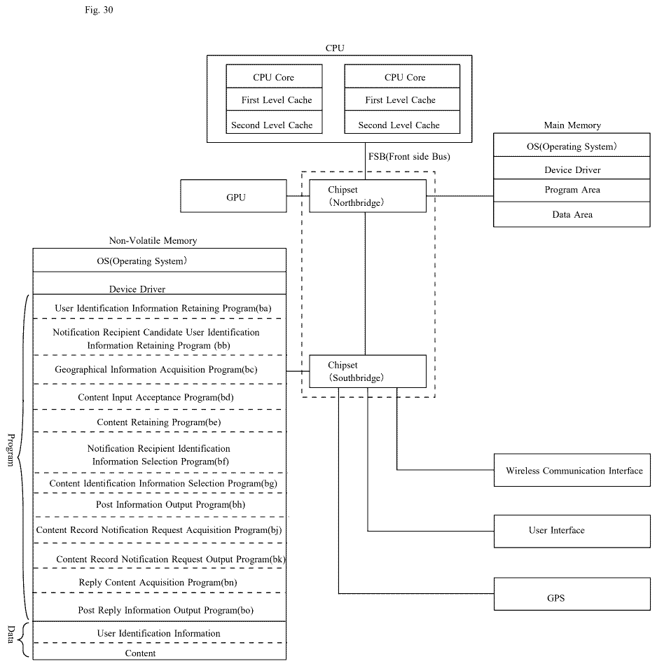

FIG. 28 is a flowchart showing a processing flow of the computer-based user terminal device (B) of the position message system according to Embodiment 5 based on Embodiment 3. The operation method of the user terminal device (B) of the computer-based position message system according to Embodiment 5 further has a user identification information retaining step (ba) (S2801), a notification recipient candidate user identification information retaining step (bb) (S2802), a geographical information acquisition step (bc) (S2803), a content input acceptance step (bd) (S2804), a content retaining step (be) (S2805), a notification recipient identification information selection step (bf) (S2806), a content identification information selection step (bg) (S2807), a post information output step (bh) (S2808), a content record notification request acquisition step (bj) (S2809), a content record notification request output step (bk) (S2810), and furthermore a content record notification acquisition step (bm) (S2811).

The user identification information retaining step (ba) (S2801) performs a process of retaining user identification information for identifying a user who uses the system;
the notification recipient candidate user identification information retaining step (bb) (S2802) performs a process of retaining notification recipient candidate user identification information, which is information of a user other than the user identified by the user identification information and who may be a candidate for the notification recipient described below;
the geographical information acquisition step (bc) (S2803) performs a process of acquiring geographical information including location information of the user terminal device (B);
the content input acceptance step (bd) (S2804) performs a process of accepting input of the content;
the content retaining step (be) (S2805) performs a process of retaining the content of which input has been accepted in association with the content identification information, which is information identifying the content;
the notification recipient identification information selection step (bf) (S2806) performs a process of selecting as notification recipient identification information for identifying the notification recipient from the retained notification recipient candidate user identification information;
the content identification information selection step (bg) (S2807) performs a process of selecting a piece of the content identification information that identifies the retained content;
the post information output step (bh) (S2808) performs a process of outputting post information, which is information that associates the content identified by the selected content identification information, the geographical information acquired when the input of the content was accepted, and the user identification information of the user who uses the system, to the post information acquisition step (ab) of the position message server device (A);
the content record notification request acquisition step (bj) (S2809) performs a process of acquiring a content record notification request, which is a request to notify the user identified by the selected piece of the notification recipient user identification information that the selected content is to be recorded or has been recorded;
the content record notification request output step (bk) (S2810) performs a process of outputting the acquired content record notification request to the content record notification request acquisition step (ad) of the position message server device (A); and
the content record notification acquisition step (bm) (S2811) performs a process of acquiring the content record notification which was processed for output by the notification processing unit (AE) of the position message server device (A).

The above-mentioned operation method is to have the user terminal device (B) of the computer-based position message system execute such a series of processes.

### <Embodiment 5: Effect>

The user terminal device (B) of the position message system according to Embodiment 5 can acquire the content record notification sent based on the content record notification request sent from the poster and notify the user of the content, which triggers the user to know that a message has been posted and to read or reproduce the message.

### Embodiment 6: (Corresponding to Invention 6)

### <Embodiment 6: Overview>

The user terminal device (B) of the position message system according to Embodiment 6 based on any one of Embodiments 3 to 5 can make a reply to the posted post information.

### <Embodiment 6: Functional Configuration>

FIG. 29 is a block diagram showing a configuration of the user terminal device (B) of the position message system according to Embodiment 6 based on Embodiment 3. In addition to the configuration of Embodiment 3, the user terminal device (B) of the position message system (2940) according to Embodiment 6 further has a reply content acquisition unit (BN) (2953) and a post reply information output unit (BO) (2954).

### <Embodiment 6: Reply Content Acquisition Unit (BN) (2953)>

The “reply content acquisition unit (BN)” (2953) is configured to acquire, in accordance with the acquired post information, a reply content for a user identified by user identification information included in the post information. After the posted message is read or reproduced in the position message system, the reply content acquisition unit (BN) (2953) accepts input of a content for replying to the message and acquires it as a reply content. The content for replying includes text, images, videos, voice, etc.

### <Embodiment 6: Present System: Example of Reply Content>

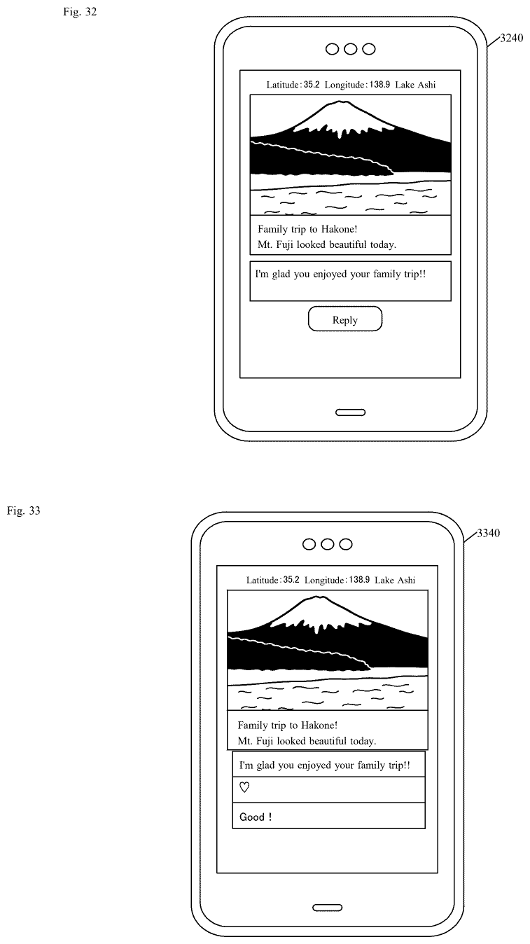

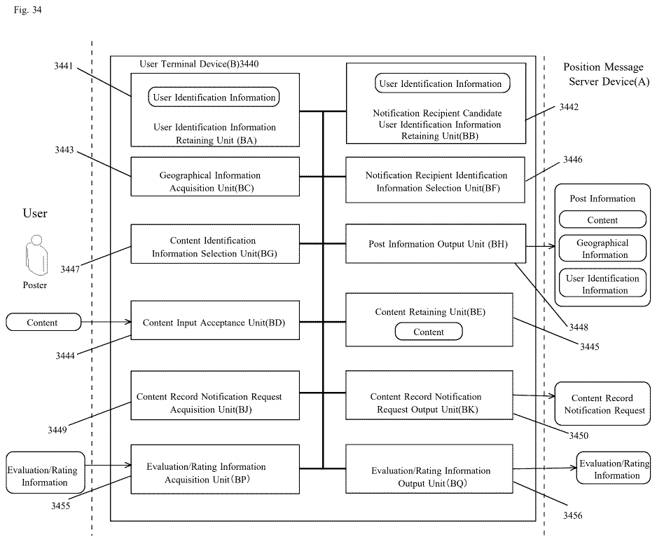

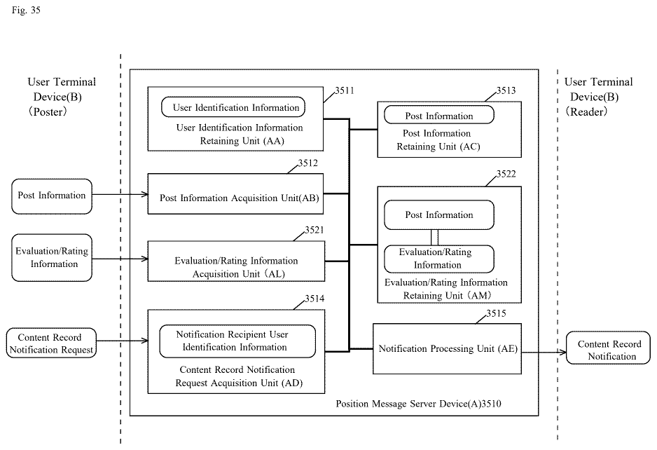

FIG. 32 is a diagram showing an example of a configuration of the reply content acquisition unit (BN) (2953). On the upper half of the screen of the smartphone (3240), which is the user terminal device (B), location information (latitude/longitude, landmark name) as the post information of the position message, a photo as an image, and a text message are displayed. There is a reply content input field to which the reply content is input below the post information. In the example of FIG. 32, the text message is input as the reply. After the input is completed, the input text message is acquired as the reply content by pressing a “reply” button below the reply input field. Since the reply content is not limited to the text message, it may also be configured such that a camera button, video button, or microphone button is configured and pressed to input the relevant content. For example, the post information is read near a point of Lake Ashi shown in FIG. 32, a video is taken with Mt. Fuji and Lake Ashi in the field of view just like in the post, and at the same time, a voice such as “it's beautiful today as well” is recorded using a microphone to obtain a content combining the video and the voice, which is used as the reply content.

### <Embodiment 6: Post Reply Information Output Unit (BO) (2954)>

The “post reply information output unit (BO)” (2954) shown in FIG. 29 is configured to output post reply information, which is information including the acquired reply content.

### <Embodiment 6: Post Reply Information Output Unit (BO): Post Reply Information>

The “post reply information” is information which includes, according to the acquired post information, a reply content to a user who made a post and who is identified by the user identification information included in the post information. For outputting a reply, the post reply information is configured by associating the reply content with the user identification information of the user who made the post and to whom the reply is sent. In this configuration, if the user who has made the post records and posts many contents in different sites, it is difficult determine which post the reply was made to. Therefore, it is preferable to configure the reply such that it is a reply to the post information, includes the reply content, and includes the post information identification information which is information identifying the post information, or/and the user identification information of the reply destination in order to be able to determine which post the reply was made to.

### <Embodiment 6: Post Reply Information Output Unit (BO): Example of Reply Content Prepared in Advance>

The reply content is not limited to the content newly input in a reply content input unit. The acquisition of the reply content includes a case where an icon or the like indicating an emotion prepared in advance in the present system (or it may also be configured to be set as appropriate by the poster) is selected. For example, a case is conceivable where the post information is a quiz, and the post reply information is a selection of the answer to the quiz. In this case, application to a game-like event such as orienteering is conceivable. Replies using standard phrases prepared in advance, icons expressing emotions such as likes and dislikes, the answers to the quiz as described above, choices for questionnaires, etc. may be configured to be displayed simultaneously with the display of the position message, which is the post information, or to be displayed alongside the optional reply content input field. The post reply information output unit (BO) (2954) sends the aforementioned post reply information to the position message server device (A).

### <Embodiment 6: Example of Configuration for Acquiring Post Reply Information: Post Reply Information Acquisition Unit>

To acquire the post reply information as described above, the following configuration is conceivable.

The position message server device (A) is configured to further have a post reply information acquisition unit for acquiring the aforementioned post reply information.

### <Embodiment 6: Present System: Example of Display of Reply Content List>

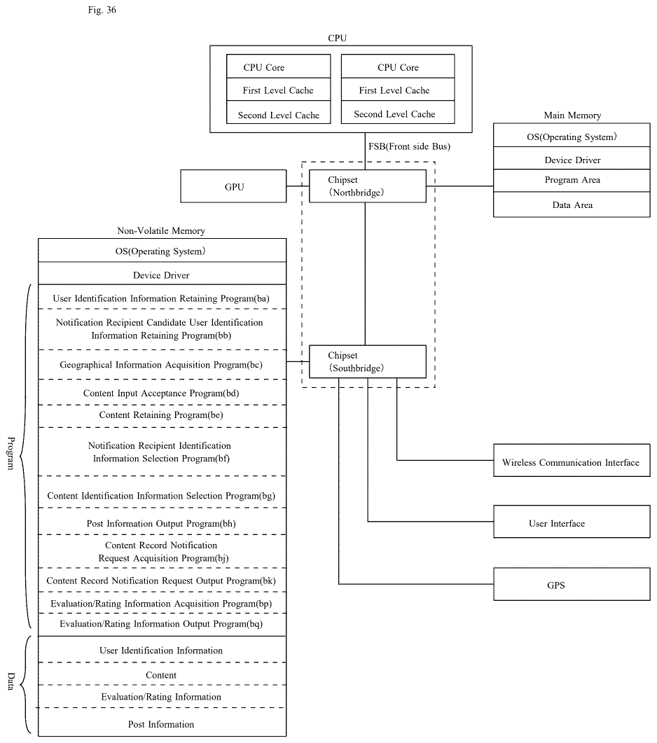

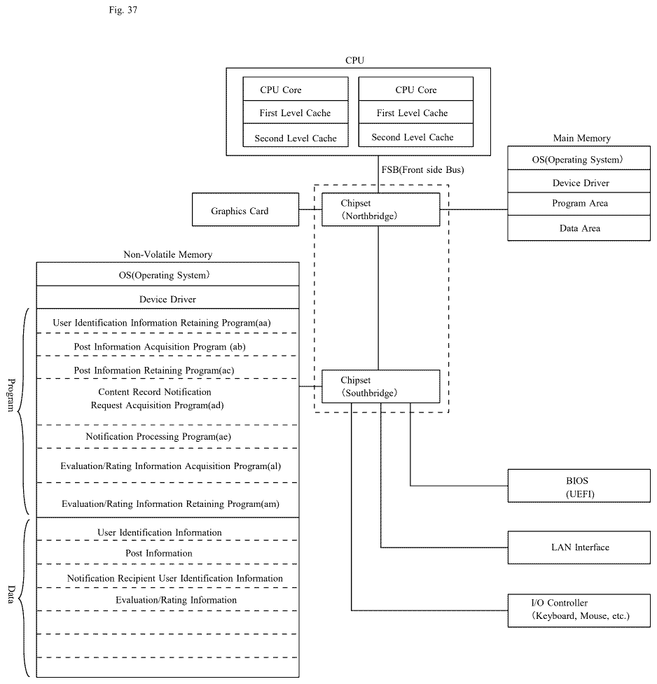

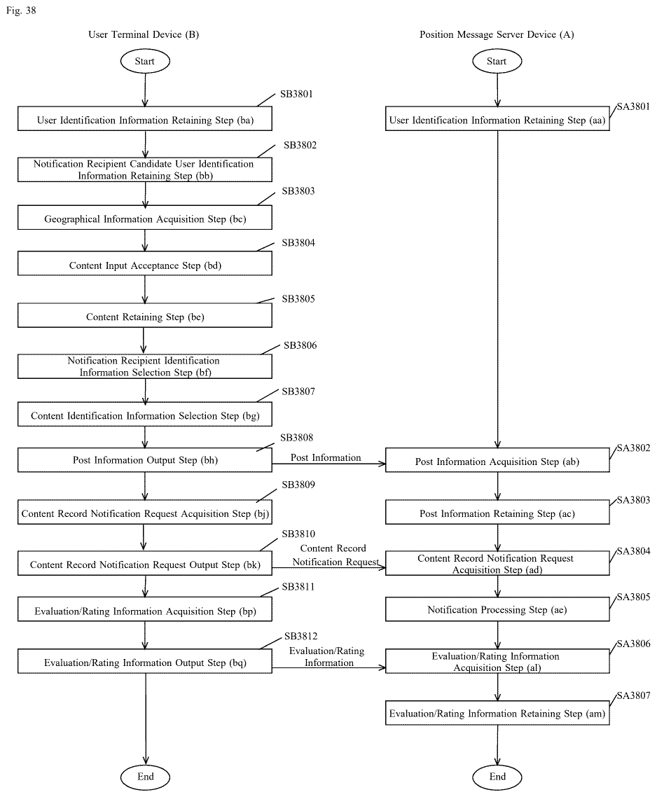

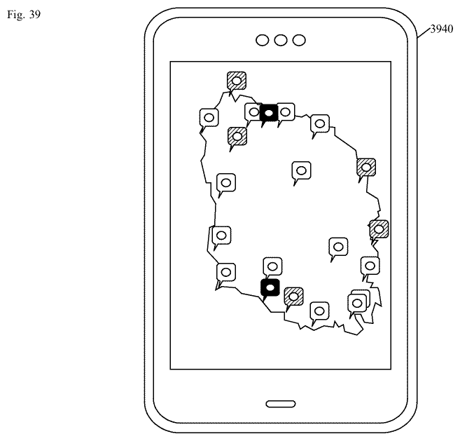

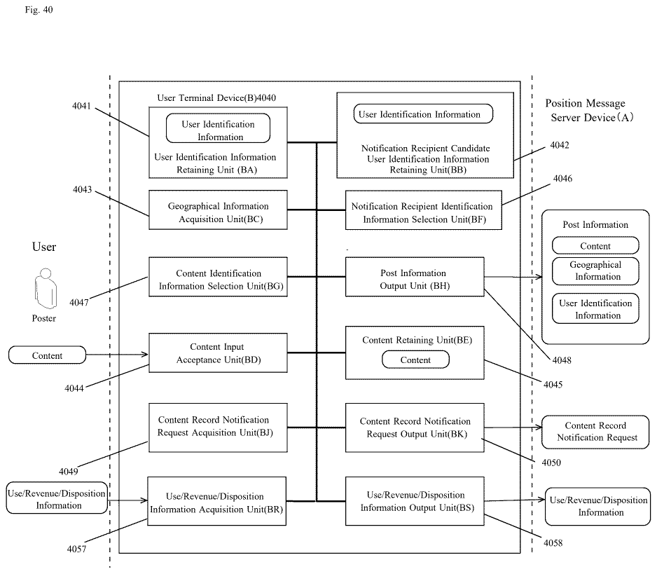

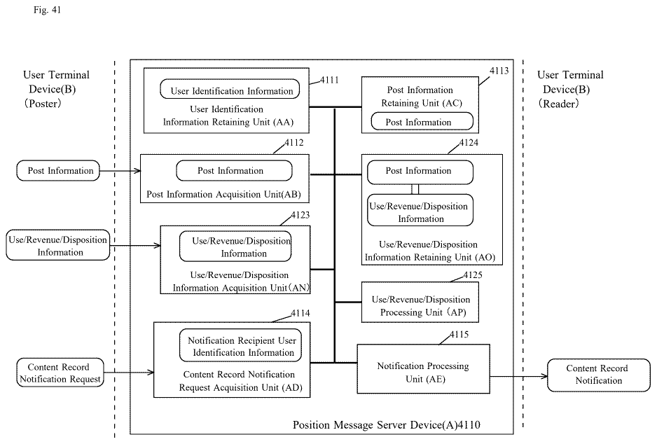

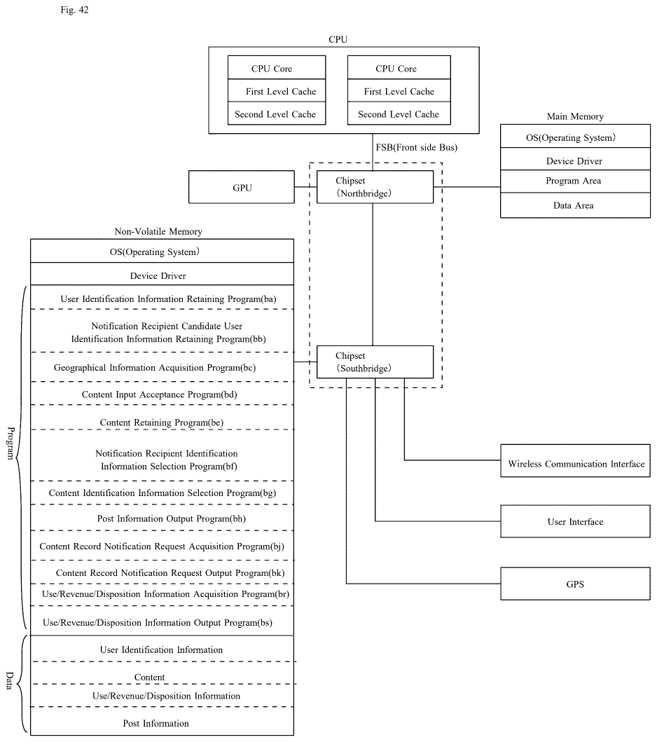

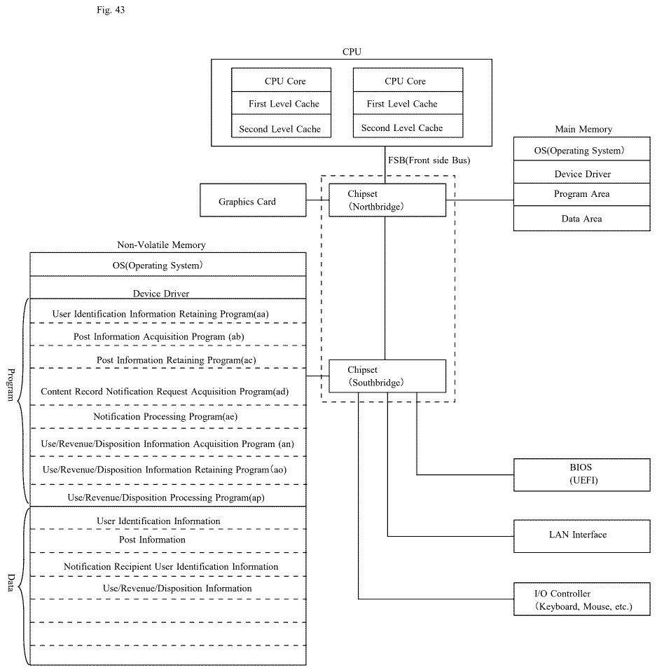

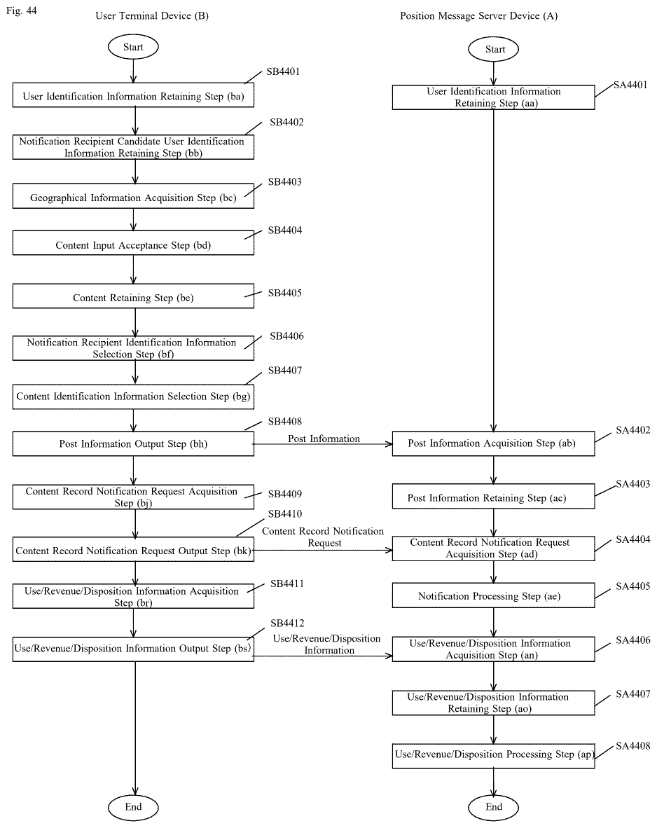

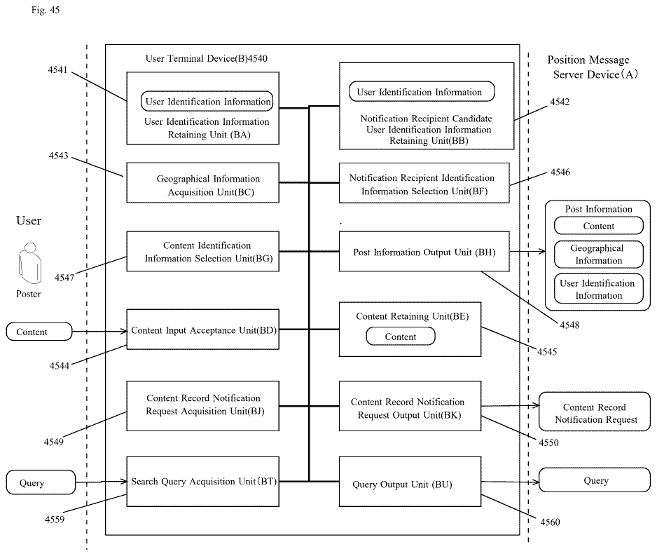

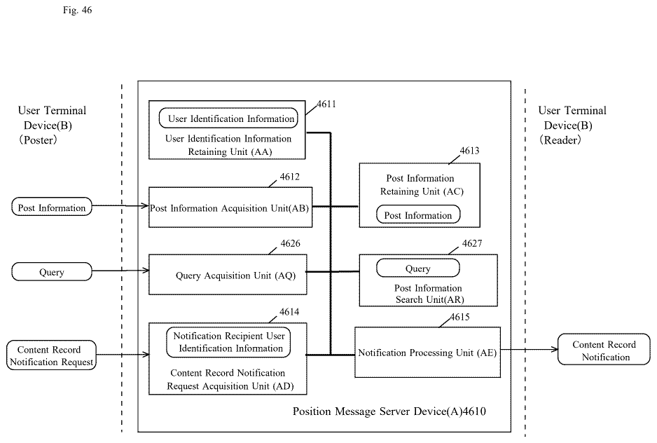

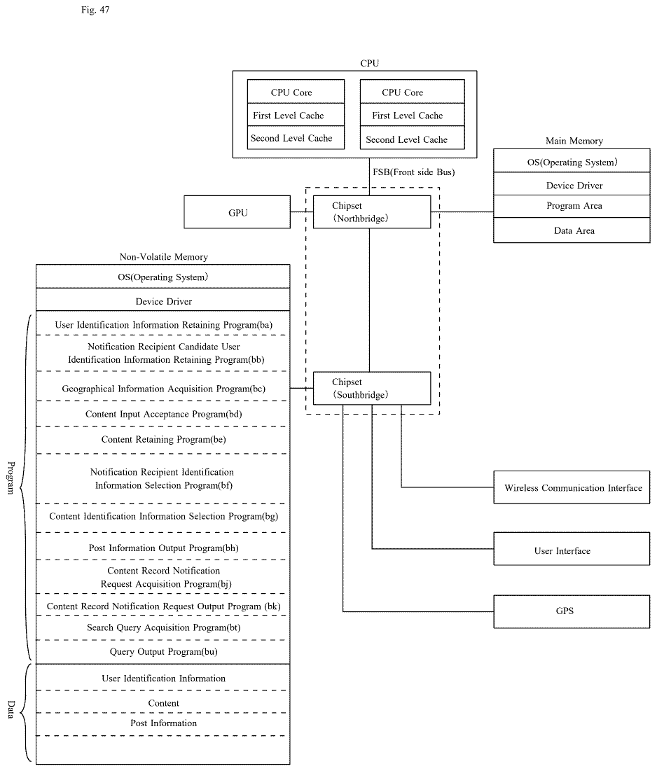

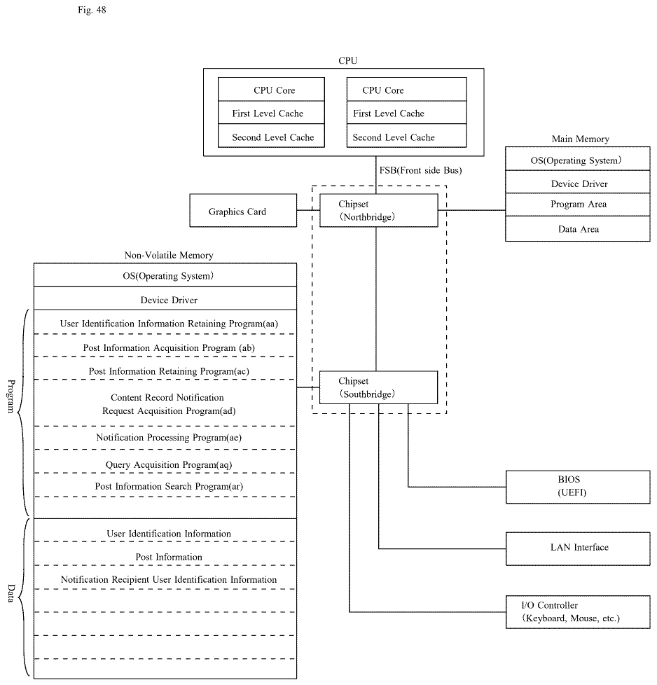

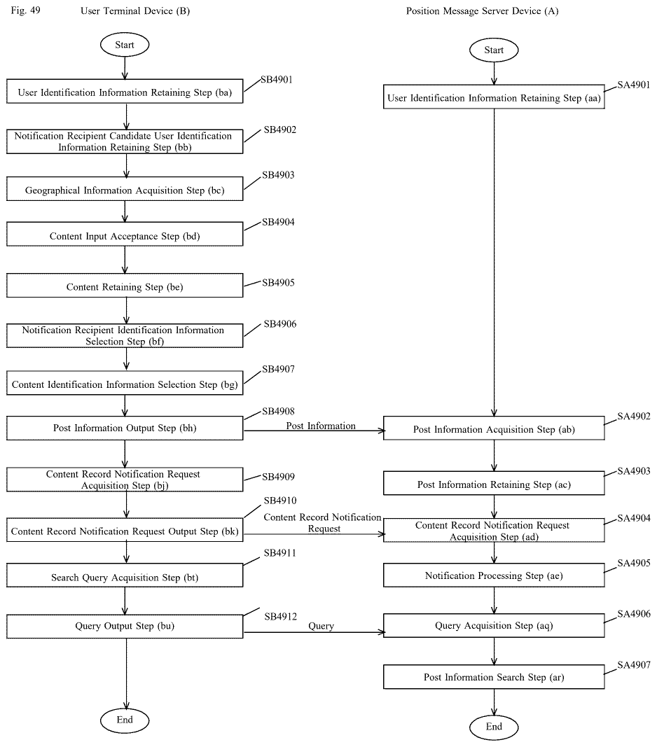

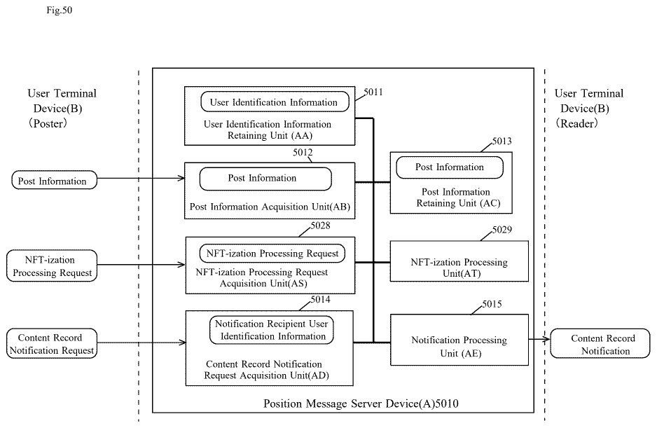

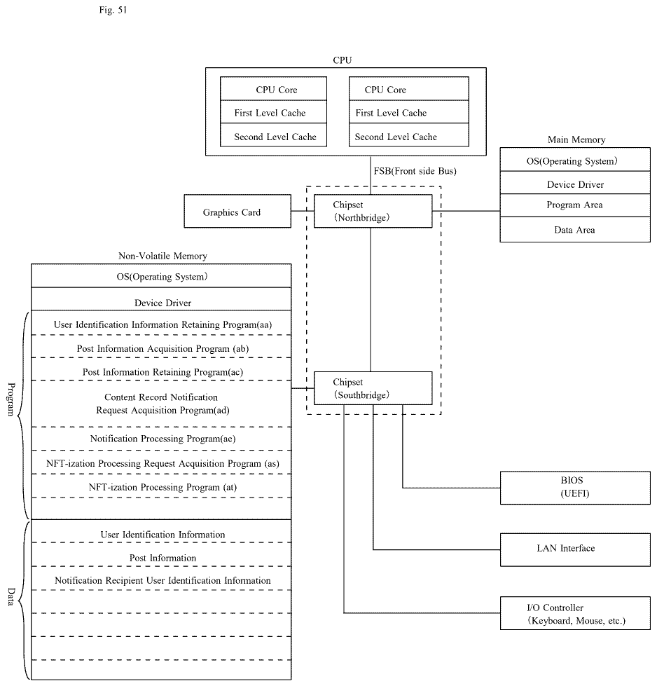

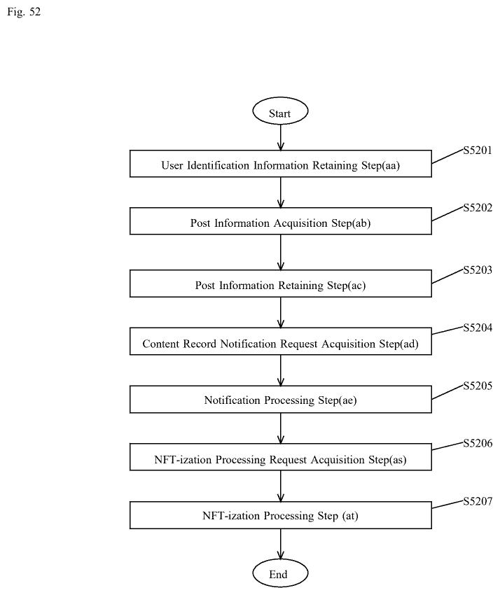

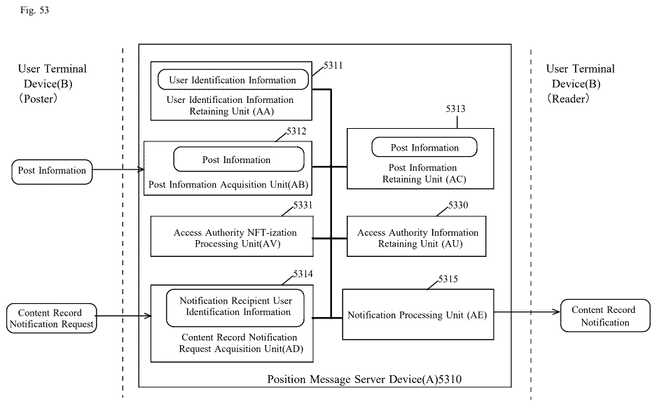

FIG. 33 shows an example of a case where the reply content sent to the position message, which is the post information, is displayed alongside the position message simultaneously. The position message, which is the post information, is displayed on a screen of a smartphone, which is the screen user terminal device (B). The post reply information issued with respect to the post is displayed together in association with the post information In FIG. 33, one each of a text message, an emotion icon, a reply using standard phrases are displayed as the reply contents. This type of display is possible by retaining the post reply information in association with the post information in the post information retaining unit (AC) of the position message server device (A). In this case, it may also be configured such that the post reply information is not displayed in association with the post information by allowing to select whether to make it public or private when replying.

### <Embodiment 6: Post Reply Information Output Unit (BO): Outputting Post Reply Information Directly to Poster>

In addition to the above-described configuration in which the post reply information is displayed in association with the post information, the post reply information may also be sent directly to the poster. In this case, the position message server device (A) has a post reply information output unit (BO) which sends the post reply information to the user who is the poster of the post information. The post reply information output unit (BO) sends the acquired post reply information to a destination specified by the user identification information of the user who posted the post information.

### <Embodiment 6: Post Reply Information Output Unit (BO): Post Reply Information Acquisition Notification>

It can also be configured such that when the post reply information is output, a post reply information acquisition notification, which is a notification that a destination of the post reply information such as the position message server device (A) or the user terminal device (B) of the poster has acquired the post reply information, is output to the poster identified by the user identification information associated with the corresponding post information. The post reply information acquisition notification may be sent as a push notification as the content record notification, or it may be configured such that whether receiving the notification or not is set by the the user who is the poster as appropriate. This is because a plurality of the post reply information acquisition notification will be issued to the poster if a plurality of replies is made with respect to a single post.

### <Embodiment 6: Post Reply Information Output Unit (BO): Example of Configuration for Post Reply Information Acquisition Notification>

In order to output the post reply information acquisition notification to the poster as described above, following example of configuration is conceivable.

The position message server device (A) can further has:
a post reply information acquisition unit which acquires the post reply information, which is information including a reply content which is issued by a user other than the poster to a user identified by the user identification information included in the post information acquired by the user other than the poster, the reply content being in accordance with the post information;
a post reply information retaining unit which retains the acquired post reply information in association with the post information; and
a post reply information acquisition notification output unit which outputs a post reply information acquisition notification for notifying the user identified by the user identification information included in the post information that the post reply information has been acquired.

### <Embodiment 6: Hardware Configuration>

The configuration of Embodiment 6 has been described above, but the case where this is realized as a program or an operation method also falls within the scope of the present invention. FIG. 30 is a block diagram showing a hardware configuration of the user terminal device (B) of the position message system according to Embodiment 6 based on Embodiment 3. In addition to the configuration of Embodiment 3, the user terminal device (B) of the position message system according to Embodiment 6 further has a reply content acquisition program and a post reply information output program. They are deployed in the main memory when the present system is started up on a computer, and the CPU sequentially performs calculations using these programs and the data by accepting a start-up command.

### <Embodiment 6: Processing Flow>

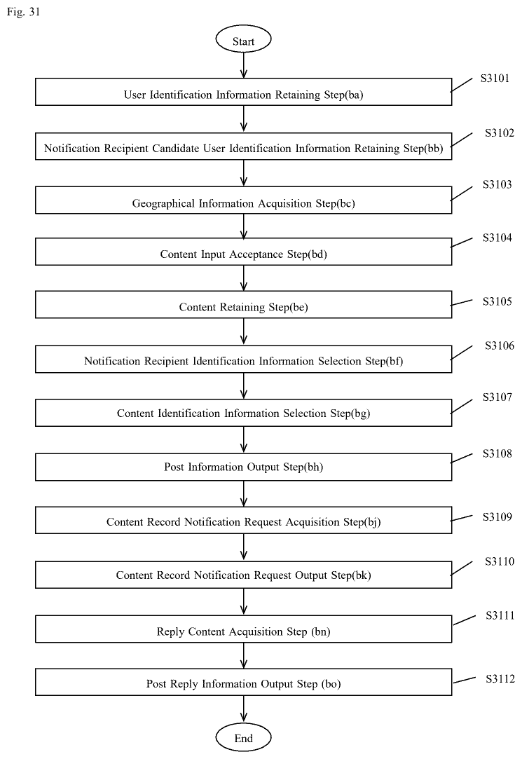

FIG. 31 is a flowchart showing a processing flow of an operation method of the computer-based user terminal device (B) of the position message system according to Embodiment 6 based on Embodiment 3. The operation method of the user terminal device (B) of the computer-based position message system according to Embodiment 6 further has a user identification information retaining step (ba) (S3101), a notification recipient candidate user identification information retaining step (bb) (S3102), a geographical information acquisition step (bc) (S3103), a content input acceptance step (bd) (S3104), a content retaining step (be) (S3105), a notification recipient identification information selection step (bf) (S3106), a content identification information selection step (bg) (S3107), a post information output step (bh) (S3108), a content record notification request acquisition step (bj) (S3109), a content record notification request output step (bk) (S3110), a reply content acquisition step (bn) (S3111), and a post reply information output step (bo) (S3112).

The user identification information retaining step (ba) (S3101) performs a process of retaining user identification information for identifying a user who uses the system;
the notification recipient candidate user identification information retaining step (bb) (S3102) performs a process of retaining notification recipient candidate user identification information, which is information of a user other than the user identified by the user identification information and who may be a candidate for the notification recipient described below;
the geographical information acquisition step (bc) (S3103) performs a process of acquiring geographical information including location information of the user terminal device (B);
the content input acceptance step (bd) (S3104) performs a process of accepting input of the content;
the content retaining step (be) (S3105) performs a process of retaining the content of which input has been accepted in association with the content identification information, which is information identifying the content;
the notification recipient identification information selection step (bf) (S3106) performs a process of selecting from the retained notification recipient candidate user identification information as notification recipient identification information for identifying the notification recipient;
the content identification information selection step (bg) (S3107) performs a process of selecting a piece of the content identification information that identifies the retained content;
the post information output step (bh) (S3108) performs a process of outputting post information, which is information that associates the content identified by the selected content identification information, the geographical information acquired when the input of the content was accepted, and the user identification information of the user who uses the system, to the post information acquisition step (ab) of the position message server device (A);
the content record notification request acquisition step (bj) (S3109) performs a process of acquiring a content record notification request, which is a request to notify the user identified by the selected piece of the notification recipient user identification information that the selected content is to be recorded or has been recorded;
the content record notification request output step (bk) (S3110) performs a process of outputting the acquired content record notification request to the content record notification request acquisition step (ad) of the position message server device (A);
the reply content acquisition step (bn) (S3111) performs a process of acquiring, in accordance with the acquired post information, a reply content for a user identified by user identification information included in the post information; and
the post reply information output step (bo) (S3112) performs a process of outputting post reply information, which is information including the acquired reply content.

The above-mentioned operation method is to have the user terminal device (B) of the computer-based position message system execute such a series of processes.

### <Embodiment 6: Effect>

The position message system according to Embodiment 6 allows for replies to the post information, so that bidirectional communication between the poster and other users is enabled and activation of the position message system is facilitated. Furthermore, it can be applied to events with a game-like nature by using the post reply information as proof of entry to a predetermined point or as a condition for completing a preset task.

### Embodiment 7: (Corresponding to Invention 7)

### <Embodiment 7: Overview>

The position message system according to Embodiment 7 based on any one of Embodiments 3 to 6 can evaluate the post information, and the user can read the evaluation results.

### <Embodiment 7: Functional Configuration>

FIG. 34 is a block diagram showing a configuration of functions of the user terminal device (B) of the position message system according to Embodiment 7 based on Embodiment 3. In addition to the configuration of Embodiment 3, the user terminal device (B) of the position message system according to Embodiment 7 has an evaluation/rating information acquisition unit (BP) (3455) and an evaluation/rating information output unit (BQ) (3456).

FIG. 35 is a block diagram showing a configuration of functions of the position message server device (A) of the position message system according to Embodiment 7 based on Embodiment 3. In addition to the configuration of Embodiment 3, the position message server device (A) of the position message system according to Embodiment 7 further has an evaluation/rating information acquisition unit (AM) (3521) and an evaluation/rating information retaining unit (AM) (3522).

<Embodiment 7: User Terminal Device (B) Evaluation/Rating Information Acquisition Unit (BP) (3455)>

The “evaluation/rating information acquisition unit (BP)” (3455) is configured to acquire evaluation/rating information, which is information of evaluation/rating of the post information output by the post information output unit (BH) (3448).

### <Embodiment 7: User Terminal Device (B) Evaluation/Rating Information Acquisition Unit (BP): Evaluation/Rating Information>

The “evaluation/rating information” is information on evaluation and rating of a posted message. The evaluation may be based on, for example, the evaluation or response given by a user who read the posted message to the user who posted the posted message. Of the five-point scale of “very good,” “good,” “average,” “bad,” and “very bad,” examples of positive evaluations are “very good” and “good,” while examples of negative evaluations are “bad,” and “very bad.” Examples of positive evaluations may also be direct evaluations such as “Good” or “Like”, or emotional expression of users such as “smile” or “laugh.” Examples of negative evaluations are “Bad,” “Not so,” “sulky,” “booing,” etc. It may also be configured such that the evaluation is high or the rating is high depending on the number of positive evaluations. Alternatively, it is conceivable that the evaluation is scored, with “very good”: +2, “good”: +1, “average”: 0, “bad”: −1, and “very bad”: −2, and the average value of the evaluation numbers is used as the evaluation. If there are bad evaluations, the evaluation can be lowered taking that into consideration. The post information (posted message) can be rated according to the evaluation. It is conceivable that the rating is performed according to the number of good evaluations or the percentage of good evaluations, such as A, B, C, and D in descending order, or the rating is performed taking into account the evaluation including negative evaluations (for example, using the total or average value calculated by allocating points for each evaluation level as described above).

### <Embodiment 7: Evaluation/Rating Information Acquisition Unit (BP): Rating of Poster>

The rating may be assigned to the user who made the post rather than the post information. It can be configured such that the user who makes posts is rated based on factors such as the number of highly rated posts, the distribution of the points where the posts are made, the number of followers, the number of replies to the posts, etc. A configuration is conceivable that posts by highly rated users are given a higher rating. Alternatively, it may also be configured such that, when a user who wishes to read a post searches for posts retained in the present system, the posts by highly rated users are displayed at the top of search results, providing convenience to the users.

### <Embodiment 7: Evaluation/Rating Information Acquisition Unit (BP): Example of Configuration for Poster Rating>

For the rating of the poster as described above, the following example of configuration is conceivable.

The evaluation/rating information acquisition unit (BP) of the user terminal (B) is configured to further have a poster evaluation/rating information acquisition means for acquiring evaluations and ratings of users who made posts.

### <Embodiment 7: User Terminal Device (B) Evaluation/Rating Information Output Unit (BQ) (3456)>

The “evaluation/rating information output unit (BQ)” (3456) is configured to output the acquired evaluation/rating information. The evaluation/rating information output unit (BQ) (3456) output the evaluation/rating information acquired by the evaluation/rating information acquisition unit (BP) (3455) to the position message server device (A). In the case of the evaluation/rating information for the post information, the post information identification information identifying the post information may be sent together.

### <Embodiment 7: Evaluation/Rating Information Acquisition Unit (AM) (3521)>

The “evaluation/rating information acquisition unit (AM)” (3521) is configured to acquire the evaluation/rating information. The evaluation/rating information acquisition unit (AM) (3521) acquires the evaluation/rating information sent from the user terminal device (B) via a network such as the Internet.

### <Embodiment 7: Evaluation/Rating Information Retaining Unit (AM) (3522)>

The “evaluation/rating information retaining unit (AM)” (3522) is configured to retain the acquired evaluation/rating information in association with the post information that was the subject of the evaluation. It may also be configured such that, if the evaluation/rating information acquired by the evaluation/rating information acquisition unit (AM) (3521) includes the post information identification information, the evaluation/rating information retaining unit (AM) (3522) retains it in association with post information identification information.

### <Embodiment 7: Evaluation/Rating Information Retaining Unit (AM): Retention of Number of Response>

When the evaluation/rating information is either positive responses or negative responses, the number of each of them may be retained. When retaining the number of positive or negative responses, the current response may be added to the number of responses up to the previous time, and the result may be retained. If there are more positive responses, the rating of the message which is the subject of the evaluation/rating may be increased. In addition, it can also be configured such that the evaluation or rating of the post information can be confirmed by the users.

<Embodiment 7: Present system: Example of Evaluation/Rating Information>

FIG. 39 is an example in which the location of the post information is displayed together with the evaluation/rating information.

A map is displayed on the screen of the smartphone (3940) which is the user terminal device (B), and the location of each piece of the post information is indicated by an icon on the map. As an example, in FIG. 39, the icon colors correspond to three levels of rating of the post information. In the example of FIG. 39, the rating is indicated by a white icon for the post information with 10 or fewer positive evaluations, a diagonal line icon for post information with 11 to 100 positive evaluations, and a black icon for post information with more than 100 positive evaluations.

This easy-to-understand display by changing the color or size of the icons on the map according to the rating of the post information makes it easier for the users who wish to read posts to understand the evaluations or ratings of the posts in their vicinity. This leads to motivation for the users to go to the spot to read a highly rated post if there is such a post near the user.

### <Embodiment 7: Hardware Configuration>

The configuration of Embodiment 7 has been described above, but the case where this is realized as a program or an operation method also falls within the scope of the present invention. FIG. 36 is a block diagram showing a hardware configuration of the user terminal device (B) of the position message system according to Embodiment 7 based on Embodiment 3. In addition to the configuration of Embodiment 3, the user terminal device (B) of the position message system according to Embodiment 7 further has an evaluation/rating information acquisition program (bp) and an evaluation/rating information output program (bq). They are deployed in the main memory when the present system is started up on a computer, and the CPU sequentially performs calculations using these programs and the data by accepting a start-up command.

FIG. 37 is a block diagram showing a hardware configuration of the position message server device (A) of the position message system according to Embodiment 7 based on Embodiment 3. In addition to the configuration of Embodiment 3, the position message server device (A) of the position message system according to Embodiment 7 further has an evaluation/rating information acquisition program (af) and an evaluation/rating information retaining program (am). They are deployed in the main memory when the present system is started up on a computer, and the CPU sequentially performs calculations using these programs and the data by accepting a start-up command. Note that similar effects can be obtained using Embodiment 4 or 5 as a base.

### <Embodiment 7: Processing Flow>

FIG. 38 is a diagram which includes a flowchart showing an operation method of the computer-based user terminal device (B) on the left side, and a flowchart showing an operation method of the computer-based message server device (A) on the right side, of the position message system according to Embodiment 7 based on Embodiment 3.

The operation method of the user terminal device (B) of the position message system according to Embodiment 7 based on Embodiment 3 further has a user identification information retaining step (ba) (SB3801), a notification recipient candidate user identification information retaining step (bb) (SB3802), a geographical information acquisition step (bc) (SB3803), a content input acceptance step (bd) (SB3804), a content retaining step (be) (SB3805), a notification recipient identification information selection step (bf) (SB3806), a content identification information selection step (bg) (SB3807), a post information output step (bh) (SB3808), a content record notification request acquisition step (bj) (SB3809), a content record notification request output step (bk) (SB3810), an evaluation/rating information acquisition step (bp) (SB3811), and an evaluation/rating information output step (bq) (SB3812).

The user identification information retaining step (ba) (SB3801) performs a process of retaining user identification information for identifying a user who uses the system;
the notification recipient candidate user identification information retaining step (bb) (SB3802) performs a process of retaining notification recipient candidate user identification information, which is information of a user other than the user identified by the user identification information and who may be a candidate for the notification recipient described below;
the geographical information acquisition step (bc) (SB3803) performs a process of acquiring geographical information including location information of the user terminal device (B);
the content input acceptance step (bd) (SB3804) performs a process of accepting input of the content;
the content retaining step (be) (SB3805) performs a process of retaining the content of which input has been accepted in association with the content identification information, which is information identifying the content;
the notification recipient identification information selection step (bf) (SB3806) performs a process of selecting as notification recipient identification information for identifying the notification recipient from the retained notification recipient candidate user identification information;
the content identification information selection step (bg) (SB3807) performs a process of selecting a piece of the content identification information that identifies the retained content;
the post information output step (bh) (SB3808) performs a process of outputting post information, which is information that associates the content identified by the selected content identification information, the geographical information acquired when the input of the content was accepted, and the user identification information of the user who uses the system, to the post information acquisition step (ab) (SA3802) of the position message server device (A);
the content record notification request acquisition step (bj) (SB3809) performs a process of acquiring a content record notification request, which is a request to notify the user identified by the selected piece of the notification recipient user identification information that the selected content is to be recorded or has been recorded;
the content record notification request output step (bk) (SB3810) performs a process of outputting the acquired content record notification request to the content record notification request acquisition step (ad) (SA3804) of the position message server device (A);
the evaluation/rating information acquisition step (bp) (SB3811) performs a process of acquiring evaluation/rating information, which is information of evaluation/rating of the post information output in the post information output step (bh) (SB3808); and
the evaluation/rating information output step (bq) (SB3812) performs a process of outputting the acquired evaluation/rating information to the evaluation/rating information acquisition step (af) (SA3806) of the position message server device (A).

The above-mentioned operation method is to have the user terminal device (B) of the computer-based position message system execute such a series of processes.

The operation method of the position message server device (A) of the position message system according to Embodiment 7 based on Embodiment 3 includes a user identification information retaining step (aa) (SA3801), a post information acquisition step (ab) (SA3802), a post information retaining step (ac) (SA3803), a content record notification request acquisition step (SA3804), a notification processing step (ae) (SA3805), an evaluation/rating information acquisition step (af) (SA3806), and an evaluation/rating information retaining step (am) (SA3807).

The user identification information retaining step (aa) (SA3801) performs a process of retaining user identification information for identifying a user;
the post information acquisition step (ab) (SA3802) performs a process of acquiring, from the post information output step (bh) (SB3808) of the user terminal device (B), post information which is information that associates: the user identification information of a user who has recorded a content; geographical information including at least location information, which is information indicating a location; and the content;
the post information retaining step (ac) (SA3803) performs a process of retaining the acquired post information;
the content record notification request acquisition step (ad) (SA3804) performs a process of acquiring, from the content record notification request output step (bk) (SB3810) of the user terminal device (B), a content record notification request, which is a request for outputting a content record notification for notifying a user other than the user who recorded the content that the content included in the post information has been recorded, the request including notification recipient user identification information, which is user identification information of a user who is a notification recipient;
the notification processing step (ae) (SA3805) performs a process of performing a process of outputting the content record notification only to the user identified by the notification recipient user identification information included in the content record notification request among the users;
the evaluation/rating information acquisition step (af) (SA3806) performs a process of acquiring the evaluation/rating information from the evaluation/rating information output step (bq) (SB3811) of the user terminal device (B); and
the evaluation/rating information retaining step (am) (SA3807) performs a process of retaining the acquired evaluation/rating information in association with the post information that was the subject of the evaluation.

The above-mentioned operation method is to have the position message server device (A) of the computer-based position message system execute such a series of processes.

### <Embodiment 7: Effect>

With the configuration that the evaluations or ratings of the post information are retained in association with the post information so as to allow the users to confirm them, it becomes easier to find good post information from a huge amount of post information. This motivates users to go and check out highly rated post information if there is such post information among the pieces of post information posted near the users, and activation of the position message system is facilitated.

### Embodiment 8: Mainly Corresponding to Invention 8

### <Embodiment 8: Overview>

The position message system according to Embodiment 8 based on any one of Embodiments 3 to 7 can add and post information regarding ownership of the content of the posted post information and can perform processing regarding the ownership.

### <Embodiment 8: Functional Configuration>

FIG. 40 is a block diagram showing a configuration of functions of the user terminal device (B) of the position message system according to Embodiment 8 based on Embodiment 3. In addition to the configuration of Embodiment 3, the user terminal device (B) of the position message system according to Embodiment 8 further has a use/revenue/disposition information acquisition unit (BR) (4057) and a use/revenue/disposition information output unit (BS) (4058).

FIG. 41 is a block diagram showing a configuration of functions of the position message server device (A) of the position message system according to Embodiment 8 based on Embodiment 3. In addition to the configuration of Embodiment 3, the position message server device (A) of the position message system according to Embodiment 8 further has a use/revenue/disposition information acquisition unit (AN) (4123), a use/revenue/disposition information retaining unit (AO) (4124), and a use/revenue/disposition processing unit (AP) (4125).

### <Embodiment 8: User Terminal Device (B) Use/Revenue/Disposition Information Acquisition Unit (BR) (4057)>

The “use/revenue/disposition information acquisition unit (BR)” (4057) shown in FIG. 40 is configured to acquire, in association with the acquired content, use/revenue/disposition information, which is information regarding one or more of the use, revenue, and disposition of the content.

### <Embodiment 8: Use/Revenue/Disposition Information Acquisition Unit (BR): Use/Revenue/Disposition Information>

The “use/revenue/disposition information” is information regarding ownership of the post information and includes the scope of rights to read and reproduce the content, the scope of rights to sell and transfer the content, the scope of rights to delete the content, etc. “Use” refers to the scope of rights to use the content, “revenue” refers to the scope of rights to earn revenue using the content, and “disposal” refers to the scope of rights to delete the content.

### <Embodiment 8: Use/Revenue/Disposition Information Acquisition Unit (BR): “Use”>

For example, the scope of rights regarding “use” the content includes the scope of rights to read and reproduce the content and also includes secondary use free of charge to make the content known to those outside the present system via SNS, etc. The poster can set, for example, both unlimited period and number of reproduction for close users, and limit the period and number of reproduction or not allow reproduction for unknown users. Alternatively, the content can be made public (available for reading and viewing) for a limited period, and the content can no longer be read and viewed when the publication period ends. A setting is also be possible in which the content is made available to general users for a limited period and is made available to specific users for a longer period (or even indefinitely). It is configured such that, when publication is terminated, the post information including the content is not deleted from the system and is made unavailable for reading by anyone other than the poster. It may also be configured such that, even if the post information is made private, this does not prevent the administrator of the present system from reading and viewing the content in order to confirm details of the post information for the purpose of maintaining and managing the system or for the public interest. It is also possible for the post information that was once made private to be made public again. For example, a poster who published photos of cherry blossoms in the spring could stop publishing it at the end of April and then publish the post information again around February of the following year before the cherry blossoms bloom for showing the previous year's scenery.

### <Embodiment 8: Use/Revenue/Disposition Information Acquisition Unit (BR): Revenue, Charging>

For example, regarding the scope of rights for selling and transferring the content related to the “revenue” of the content, various settings are possible such as the following: a charge is set for reproduction; a charge is required to view high-resolution versions of images and videos; only the beginning of a text message is available for free, and a charge is required for the remainder; or viewing is free once, but a charge is required from the second time onwards; and a charge is required to download and store the content in the non-volatile memory of the user terminal device (B) so that the content can be viewed even if the user is away from the site where the content was recorded.

### <Embodiment 8: Use/Revenue/Disposition Information Acquisition Unit (BR): Disposition>

For example, regarding the “disposal” of the content, it is conceivable that the right to delete the content could be granted to the poster in addition to the operator of the position message service, or that a time limit could be set for the content posted so that the content is automatically deleted when the time limit arrives. The use/revenue/disposition information acquisition unit (BR) (3757) acquires the scope of rights of the content specified by the user through operation when creating the post information, as the use/revenue/disposition information when posting.

### <Embodiment 8: User Terminal Device (B) Use/Revenue/Disposition Information Output Unit (BS) (4058)>

The “use/revenue/disposition information output unit (BS)” (4057) shown in FIG. 40 is configured to output the acquired use/revenue/disposition information. The user terminal device (B) (4040) associates the use/revenue/disposition information acquired by the use/revenue/disposition information acquisition unit (BR) (4057) with the post information and sends it to the position message server device (A) via a network such as the Internet.

### <Embodiment 8: Position Message Server Device (A) Use/Revenue/Disposition Information Acquisition Unit (AN) (4123)>

The “use/revenue/disposition information acquisition unit (AN)” (4123) shown in FIG. 41 is configured to acquire the use/revenue/disposition information. For example, if there is use/revenue/disposition information associated with the content included in the post information received from the user terminal device (B) via a network such as the Internet, the use/revenue/disposition information acquisition unit (AN) (4123) acquires the use/revenue/disposition information.

### <Embodiment 8: Position Message Server Device (A) Use/Revenue/Disposition Information Retaining Unit (AO) (4124)>

The “use/revenue/disposition information retaining unit (AO)” (4124) shown in FIG. 41 is configured to retain the acquired use/revenue/disposition information in association with the content. The use/revenue/disposition information retaining unit (AO) (4124) may also be configured to retain the use/revenue/disposition information acquired by the use/revenue/disposition information acquisition unit (AN) (4123) in association with the post information.

### <Embodiment 8: Position Message Server Device (A) Use/Revenue/Disposition Processing Unit (AP) (4125)>

The “use/revenue/disposition processing unit (AP)” (4125) shown in FIG. 41 is configured to perform, in accordance with the acquired use/revenue/disposition information, processing related to one or more of the use, revenue, and disposition of the content. The use/revenue/disposition processing unit (AP) (4125) relates to the content of the post information and performs a process of one or more of the use, revenue, and disposition of the content if the conditions stipulated in the use/revenue/disposition information are satisfied.

In this Embodiment, a configuration is conceivable in which, for example, if the content of the post information is stipulated in the use/revenue/disposition information as a post published (readable and viewable) for one month only, the post is made private and deleted after one month has passed since it was posted. However, a configuration is also conceivable in which if the user who wishes to read or has read the content pays the download charge set for the content, the content is downloaded to the user terminal device (B) of the user who made the payment. The payment can be made conveniently by using known mechanisms for making payments over the Internet, such as credit card payments, electronic money, and debit cards.

### <Embodiment 8: Hardware Configuration>

The configuration of Embodiment 8 has been described above, but the case where this is realized as a program or an operation method also falls within the scope of the present invention. FIG. 42 is a block diagram showing a hardware configuration of the user terminal device (B) of the position message system according to Embodiment 8 based on Embodiment 3. In addition to the configuration of Embodiment 3, the user terminal device (B) of the position message system according to Embodiment 8 further has a use/revenue/disposition information acquisition program (br) and a use/revenue/disposition information output program (bs). They are deployed in the main memory when the present system is started up on a computer, and the CPU sequentially performs calculations using these programs and the data by accepting a start-up command.

FIG. 43 is a block diagram showing a hardware configuration of the position message server device (A) of the position message system according to Embodiment 8 based on Embodiment 3. In addition to the configuration of Embodiment 3, the position message server device (A) of the position message system according to Embodiment 8 further has a use/revenue/disposition information information acquisition program (an), a use/revenue/disposition information information retaining program (ao), and a use/revenue/disposition processing program (ap). They are deployed in the main memory when the present system is started up on a computer, and the CPU sequentially performs calculations using these programs and the data by accepting a start-up command.

### <Embodiment 8: Processing Flow>

FIG. 44 is a flowchart which shows a processing flow of an operation method of the user terminal device (B) on the left side, and a processing flow of an operation method of the message server device (A) on the right side, of the position message system according to Embodiment 8 based on Embodiment 3.

### <Embodiment 8: Processing Flow in User Terminal Device (B)>

The operation method of the user terminal device (B) of the computer-based position message system according to Embodiment 8 based on Embodiment 3 further has a user identification information retaining step (ba) (SB4401), a notification recipient candidate user identification information retaining step (bb) (SB4402), a geographical information acquisition step (bc) (SB4403), a content input acceptance step (bd) (SB4404), a content retaining step (be) (SB4405), a notification recipient identification information selection step (bf) (SB4406), a content identification information selection step (bg) (SB4407), a post information output step (bh) (SB4408), a content record notification request acquisition step (bj) (SB4409), a content record notification request output step (bk) (SB4410), a use/revenue/disposition information acquisition step (br) (SB4411), and a use/revenue/disposition information output step (bs) (SB4412).

The user identification information retaining step (ba) (SB4401) performs a process of retaining user identification information for identifying a user who uses the system;
the notification recipient candidate user identification information retaining step (bb) (SB4402) performs a process of retaining notification recipient candidate user identification information, which is information of a user other than the user identified by the user identification information and who may be a candidate for the notification recipient described below;
the geographical information acquisition step (bc) (SB4403) performs a process of acquiring geographical information including location information of the user terminal device (B);
the content input acceptance step (bd) (SB4404) performs a process of accepting input of the content;
the content retaining step (be) (SB4405) performs a process of retaining the content of which input has been accepted in association with the content identification information, which is information identifying the content;
the notification recipient identification information selection step (bf) (SB4406) performs a process of selecting as notification recipient identification information for identifying the notification recipient from the retained notification recipient candidate user identification information;
the content identification information selection step (bg) (SB4407) performs a process of selecting a piece of the content identification information that identifies the retained content;
the post information output step (bh) (SB4408) performs a process of outputting post information, which is information that associates the content identified by the selected content identification information, the geographical information acquired when the input of the content was accepted, and the user identification information of the user who uses the system, to the post information acquisition step (ab) (SA4402) of the position message server device (A);
the content record notification request acquisition step (bj) (SB4409) performs a process of acquiring a content record notification request, which is a request to notify the user identified by the selected piece of the notification recipient user identification information that the selected content is to be recorded or has been recorded;
the content record notification request output step (bk) (SB4410) performs a process of outputting the acquired content record notification request to the content record notification request acquisition step (ad) (SA4404) of the position message server device (A);
the use/revenue/disposition information acquisition step (br) (SB4411) performs a process of acquiring, in association with the acquired content, use/revenue/disposition information which is information on one or more of the use, revenue, and disposition of the content; and
the use/revenue/disposition information output step (bs) (SB4412) performs a process of outputting the acquired use/revenue/disposition information.

The above-mentioned operation method is to have the user terminal device (B) of the computer-based position message system execute such a series of processes.

### <Embodiment 8: Processing Flow in Position Message Server Device (A)>

The operation method of the position message server device (A) of the position message system according to Embodiment 8 includes a user identification information retaining step (aa) (SA4401), a post information acquisition step (ab) (SA4402), a post information retaining step (ac) (SA4403), a content record notification request acquisition step (SA4404), a notification processing step (ae) (SA4405), a use/revenue/disposition information acquisition step (an) (SA4406), a use/revenue/disposition information retaining step (ao) (SA4407), and a use/revenue/disposition processing step (ap) (SA4408).

The user identification information retaining step (aa) (SA4401) performs a process of retaining user identification information for identifying a user;
the post information acquisition step (ab) (SA4402) performs a process of acquiring, from the post information output step (bh) (SB4408) of the user terminal device (B), post information which is information that associates: the user identification information of a user who has recorded a content; geographical information including at least location information, which is information indicating a location; and the content;
the post information retaining step (ac) (SA4403) performs a process of retaining the acquired post information;
the content record notification request acquisition step (ad) (SA4404) performs a process of acquiring, from the content record notification request output step (bk) (SB4410) of the user terminal device (B), a content record notification request, which is a request for outputting a content record notification for notifying a user other than the user who recorded the content that the content included in the post information has been recorded, the request including notification recipient user identification information, which is user identification information of a user who is a notification recipient;
the notification processing step (ae) (SA4405) performs a process of performing a process of outputting the content record notification only to the user identified by the notification recipient user identification information included in the content record notification request among the users;
the use/revenue/disposition information acquisition step (an) (SA4406) performs a process of acquiring use/revenue/disposition information;
the use/revenue/disposition information retaining step (ao) (SA4407) performs a process of retaining the acquired use/revenue/disposition information in association with the content; and
the use/revenue/disposition processing step (ap) (SA4408) performs, in accordance with the acquired use/revenue/disposition information, processing related to one or more of the use, revenue, and disposition of the content.

The above-mentioned operation method is to have the position message server device (A) of the computer-based position message system execute such a series of processes.

### <Embodiment 8: Effect>

With the position message system according to Embodiment 8, processing can be performed based on the ownership conditions specified in the post information so that it is possible to make a post with a time limit or sell the content, thereby enabling various business applications.

### Embodiment 9: Mainly Corresponding to Invention 9

### <Embodiment 9: Overview>

In the position message system according to Embodiment 9 based on any one of Embodiments 3 to 8, the post information retained in the position message server device (A) is made searchable so that the desired post information can be easily found.

### <Embodiment 9: Functional Configuration>

FIG. 45 is a block diagram showing a configuration of functions of the user terminal device (B) of the position message system according to Embodiment 9 based on Embodiment 3. In addition to the configuration of Embodiment 3, the user terminal device (B) of the position message system according to Embodiment 9 further has a search query acquisition unit (BT) (4559) and a query output unit (BU) (4560).

FIG. 46 is a block diagram showing a configuration of functions of the position message server device (A) of the position message system according to Embodiment 9 based on Embodiment 3. In addition to the configuration of Embodiment 3, the position message server device (A) of the position message system according to Embodiment 9 further has a query acquisition unit (AQ) (4626) and a post information search unit (AR) (4627).

### <Embodiment 9: User Terminal Device (B) Search Query Acquisition Unit (BT) (4559)>

The “search query acquisition unit (BT)” (4559) shown in FIG. 45 is configured in the user terminal device (B) to acquire a query for searching the post information retained in the position message server device (A).

### <Embodiment 9: User Terminal Device (b) Search Query Acquisition Unit (BT): Query>

The “query” refers to a request for processing performed to search a database to retrieve information which satisfies specified conditions.

When the user input information related to the search which serves as a query and presses a search button on the user terminal device (B), the search query acquisition unit (BT) acquires the query which serves as the conditions for the search.

The query is specified, for example, by text and may include information related to users, information related to locations, information related to posting time, information related to details of the post information, etc. Specifically, the information related to users may include information related to attributes of the users such as the user's name, nickname, age, sex, occupation, hobbies, and career history (educational background, work history, etc.). The information related to locations may include latitude and longitude, an address including country and prefecture names, a landmark, a distance from the current location, etc. It is conceivable that the information related to posting time is specified by date and time, a period, the number of days from the current day, etc. The information related to details of the post information may include a content category (text, image, video, voice, etc.), evaluation/rating results, the number of replies, etc.

In addition to the specification by text as described above, search may be performed by images or voice. For example, when searching by images, the post information in which similar images are posted, the post information posted at a location estimated from the image, the post information related to a person estimated from the image, etc. may be displayed. Also, when searching by voice, the post information related to a place or a person associated with the voice may be searched for. An example is conceivable in which, if the sound of a crossing gate is input, the post information posted near a crossing gate is searched for.

### <Embodiment 9: Present System: Query>

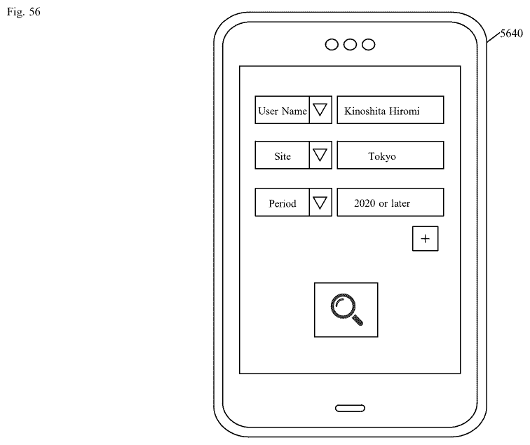

FIG. 56 is a diagram showing an example of a configuration of the search query acquisition unit (BT). In the example of FIG. 56, there are three key input fields as search key input fields on a screen of a smartphone 5340, and “Kinoshita Hiromi” is specified as the “User Name” in the first search key input field in the top row. “Tokyo” is specified as the “site” in the second search key input field in the middle row, and 2020 or later is specified as the “period” in the third search key input field in the bottom row. A “+button” 5504 is pressed when adding a search key input field, and when pressing a “search” button displayed as an icon resembling a magnifying glass below, the query which serves as the conditions for the search is acquired.

Specifically, since each search key is an AND condition, the query in the example shown in FIG. 56 is “the post information posted by a user who is Kinoshita Hiromi, posted in Tokyo, and posted in 2020 or later,” and posts that match all the conditions are subjected to the search. The category of the search key in each search key input field can be configured to be selected using a pull-down menu, etc. In the example of FIG. 56, for example, by pressing the downward triangle to the right of the user name in the top row, the user, location, period, etc. are displayed and can be selected. It is preferable to provide an item “Other” or “Message” in the menu so that the attributes of messages (poster, location, time, publication period, etc.) or the details of messages can be searched for using free keywords. In the case of videos and images, keywords may be extracted from comments added by the posters, or it may also be configured such that the details of the videos or images are analyzed by AI and attached with keywords.

### <Embodiment 9: User Terminal Device (B) Query Output Unit (BU) (4560)>

The “query output unit (BU)” (4560) shown in FIG. 45 is configured to output the acquired search query to the position message server device (A). The query output unit (BU) (4560) sends the query to the position message server device (A) via a network such as the Internet. The user terminal device (B) is assumed to be a mobile device such as a smartphone, and therefore mobile communications connected to a public line or wireless communication such as Wi-Fi (registered trademark) are assumed.

### <Embodiment 9: Position Message Server Device (A) Query Acquisition Unit (AQ) (4626)>

The “query acquisition unit (AQ)” (4626) shown in FIG. 46 is configured such that the position message server device (A) acquires the query. The query acquisition unit (AQ) (4626) acquires, as the query, sent data sent from user terminal device (B) via a network such as the Internet.

### <Embodiment 9: Position Message Server Device (A) Post Information Search Unit (AR) (4627)>

The “post information search unit (AR)” (4627) shown in FIG. 46 searches for the retained post information based on the acquired query. The post information search unit (AR) (4627) searches for the post information which matches the conditions from the post information retained in the post information retaining unit (AC) (4613) based on the query acquired by the query acquisition unit (AQ) (4626).

### <Embodiment 9: Hardware Configuration>

The configuration of Embodiment 9 has been described above, but the case where this is realized as a program or an operation method also falls within the scope of the present invention. FIG. 47 is a block diagram showing a hardware configuration of the user terminal device (B) of the position message system according to Embodiment 9 based on Embodiment 3. In addition to the configuration of Embodiment 3, the user terminal device (B) of the position message system according to Embodiment 9 further has a search query acquisition program (bt) and a query output program (bu). They are deployed in the main memory when the present system is started up on a computer, and the CPU sequentially performs calculations using these programs and the data by accepting a start-up command.

FIG. 48 is a block diagram showing a hardware configuration of the position message server device (A) of the position message system according to Embodiment 9 based on Embodiment 3. In addition to the configuration of Embodiment 3, the position message server device (A) of the position message system according to Embodiment 9 further has a query acquisition program (aq) and a post information search program (ar). They are deployed in the main memory when the present system is started up on a computer, and the CPU sequentially performs calculations using these programs and the data by accepting a start-up command.

### <Embodiment 9: Processing Flow>

FIG. 49 is a flowchart which shows a processing flow of an operation method of the user terminal device (B) on the left side, and a processing flow of an operation method of the message server device (A) on the right side, of the position message system according to Embodiment 9 based on Embodiment 3.

### <Embodiment 9: Processing Flow in User Terminal Device (B)>

The operation method of the user terminal device (B) of the computer-based position message system according to Embodiment 9 based on Embodiment 3 further has a user identification information retaining step (ba) (SB4901), a notification recipient candidate user identification information retaining step (bb) (SB4902), a geographical information acquisition step (bc) (SB4903), a content input acceptance step (bd) (SB4904), a content retaining step (be) (SB4905), a notification recipient identification information selection step (bf) (SB4906), a content identification information selection step (bg) (SB4907), a post information output step (bh) (SB4908), a content record notification request acquisition step (bj) (SB4909), a content record notification request output step (bk) (SB4910), a search query acquisition step (bt) (SB4911), and a query output step (bu) (SB4912).

The user identification information retaining step (ba) (SB4901) performs a process of retaining user identification information for identifying a user who uses the system;
the notification recipient candidate user identification information retaining step (bb) (SB4902) performs a process of retaining notification recipient candidate user identification information, which is information of a user other than the user identified by the user identification information and who may be a candidate for the notification recipient described below;
the geographical information acquisition step (bc) (SB4903) performs a process of acquiring geographical information including location information of the user terminal device (B);
the content input acceptance step (bd) (SB4904) performs a process of accepting input of the content;
the content retaining step (be) (SB4905) performs a process of retaining the content of which input has been accepted in association with the content identification information, which is information identifying the content;
the notification recipient identification information selection step (bf) (SB4906) performs a process of selecting as notification recipient identification information for identifying the notification recipient from the retained notification recipient candidate user identification information;
the content identification information selection step (bg) (SB4907) performs a process of selecting a piece of the content identification information that identifies the retained content;
the post information output step (bh) (SB4908) performs a process of outputting post information, which is information that associates the content identified by the selected content identification information, the geographical information acquired when the input of the content was accepted, and the user identification information of the user who uses the system, to the post information acquisition step (ab) (SA4902) of the position message server device (A);
the content record notification request acquisition step (bj) (SB4909) performs a process of acquiring a content record notification request, which is a request to notify the user identified by the selected piece of the notification recipient user identification information that the selected content is to be recorded or has been recorded;
the content record notification request output step (bk) (SB4910) performs a process of outputting the acquired content record notification request to the content record notification request acquisition step (ad) (SA4904) of the position message server device (A);
the search query acquisition step (bt) (SB4911) performs a process of acquiring a query for searching the post information retained in the position message server device (A); and
the query output step (bu) (SB4912) performs a process of outputting the acquired search query to the query acquisition step (aq) (SA4906) of the position message server device (A).

The above-mentioned operation method is to have the user terminal device (B) of the computer-based position message system execute such a series of processes.

### <Embodiment 9: Processing Flow in Position Message Server Device (A)>

The operation method of the position message server device (A) of the position message system according to Embodiment 9 includes a user identification information retaining step (aa) (SA4901), a post information acquisition step (ab) (SA4902), a post information retaining step (ac) (SA4903), a content record notification request acquisition step (SA4904), a notification processing step (ae) (SA4905), a query acquisition step (aq) (SA4906), and a post information search step (ar) (SA4907).

The user identification information retaining step (aa) (SA4901) performs a process of retaining user identification information for identifying a user;
the post information acquisition step (ab) (SA4902) performs a process of acquiring, from the post information output step (bh) (SB4908) of the user terminal device (B), post information which is information that associates: the user identification information of a user who has recorded a content; geographical information including at least location information, which is information indicating a location; and the content;
the post information retaining step (ac) (SA4903) performs a process of retaining the acquired post information;
the content record notification request acquisition step (ad) (SA4904) performs a process of acquiring, from the content record notification request output step (bk) (SB4910) of the user terminal device (B), a content record notification request, which is a request for outputting a content record notification for notifying a user other than the user who recorded the content that the content included in the post information has been recorded, the request including notification recipient user identification information, which is user identification information of a user who is a notification recipient;
the notification processing step (ae) (SA4905) performs a process of performing a process of outputting the content record notification only to the user identified by the notification recipient user identification information included in the content record notification request among the users;
the query acquisition step (aq) (SA4906) performs a process of acquiring the query from the query output step (bu) (SB4912) of the user terminal device (B); and
the post information search step (ar) (SA4907) performs a process of searching the retained post information based on the acquired query.

The above-mentioned operation method is to have the position message server device (A) of the computer-based position message system execute such a series of processes.

### <Embodiment 9:£ Effect>

The position message system according to Embodiment 9 allows a user to specify a search criteria from the user terminal device (B) and search the post information so that the user can easily find a desired post.

### Embodiment 10: Mainly Corresponding to Invention 10

### <Embodiment 10: Overview>

In the position message system according to Embodiment 10 based on any one of Embodiments 1 to 9, the post information is converted into an NFT (Non Fungible Token) and the users who can read and reproduce it are limited.

### <Embodiment 10: Configuration>

FIG. 50 is a functional block diagram showing a configuration of the position message server device (A) of the position message system according to Embodiment 10 based on Embodiment 1. In addition to the configuration of Embodiment 1, Embodiment 10 further has an NFT-ization processing request acquisition unit (AS) (5028) and an NFT-ization processing unit (AT) (5029). Note that similar effects can be obtained using Embodiment 2 as a base.

### <Embodiment 10: NFT-ization Processing Request Acquisition Unit (AS) (5028)>

The “NFT-ization processing request acquisition unit (AS)” (5028) shown in FIG. 50 is configured to acquire an NFT-ization request, which is a request for NFT-izing the content associated with the post information retained in the post information retaining unit (AC) (5013).

### <Embodiment 10: NFT-ization Processing Request Acquisition Unit (AS): NFT>

An “NFT” uses blockchain technology to add identification information to digital data, thereby indicating the owner of the data and uniqueness of the data.

### <Embodiment 10: NFT-ization Processing Request Acquisition Unit (AS): NFT-ization Request>

For the “NFT-ization request,” the following two cases are conceivable: the user who is the poster of the post information determines whether or not to NFT-ize it and sets the NFT-ization request from the user terminal device (B); or the service provider of the position message system sets the NFT-ization request.

### <Embodiment 10: NFT-ization Processing Unit (AT) (5029)>

The “NFT-ization processing unit (AT)” (5029) shown in FIG. 50 is configured to perform a process of NFT-izing the content based on the acquired NFT-ization request. Various responses become possible by imposing rules when NFT-izing the content of the post information.

For example, it is also possible to provide information limiting users or groups that can access the content of the post information, thereby limiting access to specific users. In addition, it is also possible to charge a fee for reading and reproducing the content. This allows a poster of post information that generates a lot of revenue to sell and transfer the NFT-ized post information to other users. Alternatively, in the case where a will is used as the content as in the example used in the description of the aforementioned embodiments, the will can also be NFT-ized in order to guarantee the authenticity and uniqueness of the will, which must not be altered.

### <Embodiment 10: Hardware Configuration>

The configuration of Embodiment 10 has been described above, but the case where this is realized as a program or an operation method also falls within the scope of the present invention. FIG. 51 is a block diagram showing a hardware configuration of the position message server device (A) of the position message system according to Embodiment 10 based on Embodiment 1. In addition to the configuration of Embodiment 1, the position message server device (A) according to Embodiment 10 further has an NFT-ization processing request acquisition program (as) and an NFT-ization processing program (at). They are deployed in the main memory when the present system is started up on a computer, and the CPU sequentially performs calculations using these programs and the data by accepting a start-up command. Note that similar effects can be obtained using Embodiment 2 as a base.

### <Embodiment 10: Processing Flow>

FIG. 52 is a flowchart showing a processing flow of an operation method of the position message server device (A) of the computer-based position message system according to Embodiment 10 based on Embodiment 1. The operation method of the position message server device (A) according to Embodiment 10 includes a user identification information retaining step (aa) (S5201), a post information acquisition step (ab) (S5202), a post information retaining step (ac) (S5203), a content record notification request acquisition step (S5204), a notification processing step (ae) (S5205), an NFT-ization processing request acquisition step (as) (S5206), and an NFT-ization processing step (at) (S5207). Note that similar effects can be obtained using Embodiment 2 as a base.

The user identification information retaining step (aa) (S5201) performs a process of retaining user identification information for identifying a user;
the post information acquisition step (ab) (S5202) performs a process of acquiring post information which is information that associates: the user identification information of a user who has recorded a content; geographical information including at least location information, which is information indicating a location; and the content;
the post information retaining step (ac) (S5203) performs a process of retaining the acquired post information;
the content record notification request acquisition step (ad) (S5204) performs a process of acquiring a content record notification request, which is a request for outputting a content record notification for notifying a user other than the user who recorded the content that the content included in the post information has been recorded, the request including notification recipient user identification information, which is user identification information of a user who is a notification recipient;
the notification processing step (ae) (S5205) performs a process of performing a process of outputting the content record notification only to the user identified by the notification recipient user identification information included in the content record notification request among the users;
the NFT-ization processing request acquisition step (as) (S5206) performs a process of acquiring an NFT-ization request, which is a request for NFT-izing the content associated with the post information retained in the post information retaining step (ac) (S5203); and
the NFT-ization processing step (at) (S5207) performs a process of NFT-izing the content based on the acquired NFT-ization request.

The above-mentioned operation method is to have the position message server device (A) of the computer-based position message system execute such a series of processes.

### <Embodiment 10: Effect>

The position message system according to Embodiment 10 makes it possible to prevent copyright infringement caused by copying or altering the content and also expands possibilities for various business ventures such as limiting usage and charging fees.

### Embodiment 11: Mainly Corresponding to Invention 11

### <Embodiment 11: Overview>

In the position message system according to Embodiment 11 based on any one of Embodiments 1 to 10, access restrictions are placed on the content of the post information, and an access key, which is the authority to access the content, is NFT-ized.

### <Embodiment 11: Configuration>

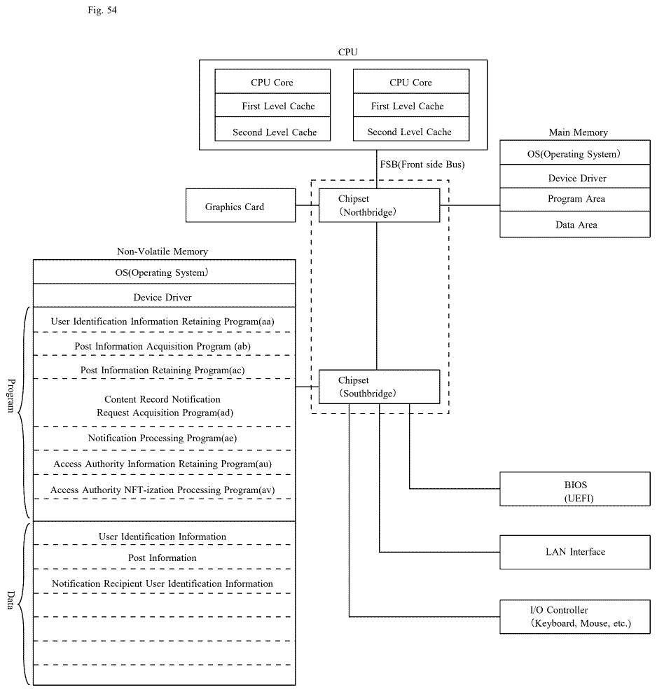

FIG. 53 is a block diagram showing a configuration of functions of the position message server device (A) of the position message system according to Embodiment 11 based on Embodiment 1. In addition to the configuration of Embodiment 1, the position message server device (A) of the position message system according to Embodiment 11 further has an access authority information retaining unit (AU) (5330) and an access authority NFT-ization processing request unit (AV) (5331). Note that similar effects can be obtained using Embodiment 2 as a base.

### <Embodiment 11: Access Authority Information Retaining Unit (AU) (5330)>

The “access authority information retaining unit (AU)” (5330) shown in FIG. 53 is configured in the position message server device (A) to retain access authority information, which is information indicating a right to access the content associated with the post information retained in the post information retaining unit (AC) (5313) from the user terminal device (B).

### <Embodiment 11: Access Authority Information Retaining Unit (AU): Access Authority Information>

The “access authority information” is information such as a secret key composed of digital data that enables access from the user terminal device (B) to the content associated with the post information retained in the post information retaining unit (AC) (5313) of the position message server device (A). The access authority information is retained in a non-volatile memory in association with the post information. A configuration is conceivable in which, if the access authority information added to access from the user terminal device (B) to the content of the post information matches the access authority information retained in the access authority information retaining unit (AU) (5330), access to the content of the post information is permitted.

### <Embodiment 11: Access Authority NFT-ization Processing Request Unit (AV) (5331)>

The “access authority NFT-ization processing request unit (AV)” (5331) shown in FIG. 53 is configured to perform a process of NFT-izing the retained access authority information. The access authority NFT-ization processing request unit (AV) (5331) NFT-izes the access authority information. At this time, it may also be configured to impose various rules such as rules related to transfer and rules related to charging. This makes it possible to prevent unauthorized copying of the access authority information and to enable various transactions such as transfer, sale, and partial sharing.

### <Embodiment 11: Hardware Configuration>

The configuration of Embodiment 11 has been described above, but the case where this is realized as a program or an operation method also falls within the scope of the present invention. FIG. 54 is a block diagram showing a hardware configuration of the position message server device (A) of the position message system according to Embodiment 11 based on Embodiment 1. In addition to the configuration of Embodiment 1, the position message server device (A) according to Embodiment 11 further has an access authority information retaining program (au) and an access authority NFT-ization processing program (av). They are deployed in the main memory when the present system is started up on a computer, and the CPU sequentially performs calculations using these programs and the data by accepting a start-up command. Note that similar effects can be obtained using Embodiment 2 as a base.

### <Embodiment 11: Processing Flow>

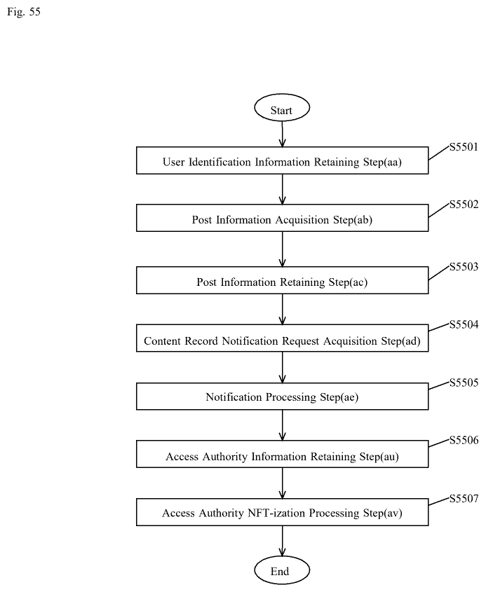

FIG. 55 is a flowchart showing a processing flow of an operation method of the position message server device (A) of the position message system according to Embodiment 11.

The operation method of the position message server device (A) according to Embodiment 11 includes a user identification information retaining step (aa) (S5501), a post information acquisition step (ab) (S5502), a post information retaining step (ac) (S5503), a content record notification request acquisition step (S5504), a notification processing step (ae) (S5505), an access authority information retaining step (au) (S5506), and an access authority NFT-ization processing step (av) (S5507). Note that similar effects can be obtained using Embodiment 2 as a base.

The user identification information retaining step (aa) (S5501) performs a process of retaining user identification information for identifying a user;
the post information acquisition step (ab) (S5502) performs a process of acquiring post information, which is information that associates: the user identification information of a user who has recorded a content included in the post information; geographical information including location information, which is information indicating a location used as a requirement for allowing a user other than the user identified by the user identification information to view this content; and the content;
the post information retaining step (ac) (S5503) performs a process of retaining the acquired post information;
the content record notification request acquisition step (ad) (S5504) performs a process of acquiring a content record notification request, which is a request for outputting a content record notification for notifying a user other than the user who recorded the content that the content included in the post information has been recorded, the request including notification recipient user identification information, which is user identification information of a user who is a notification recipient;
the notification processing step (ae) (S5505) performs a process of performing a process of outputting the content record notification only to the user identified by the notification recipient user identification information included in the content record notification request among the users;
the access authority information retaining step (au) (S5506) performs a process of retaining access authority information, which is information indicating a right to access the content associated with the post information retained in the post information retaining step (ac) (S5503) from the user terminal device (B); and
the access authority NFT-ization processing step (av) (S5507) perform a process of NFT-izing the retained access authority information.

The above-mentioned operation method is to have the position message server device (A) of the computer-based position message system execute such a series of processes.

### <Embodiment 11: Effect>

The position message system of Embodiment 11 sets access restrictions on the content of the post information, which not only prevents unauthorized copying of the authority to access the content but also enables transfer, sale, sharing, etc., thereby expanding the possibilities for development into various businesses.

1. A position message system having a position message server device (A), the position message server device (A) having:
a user identification information retaining unit (AA) for retaining user identification information for identifying a user;
a post information acquisition unit (AB) for acquiring post information, which is information that associates:
the user identification information of a user who has recorded a content included in the post information,
geographical information including location information, which is information indicating a location used as a requirement for allowing a user other than the user identified by the user identification information to view this content, and
the content;
a post information retaining unit (AC) for retaining the acquired post information;
a content record notification request acquisition unit (AD) for acquiring a content record notification request, which is a request for outputting a content record notification for notifying a user other than the user who recorded the content that the content included in the post information has been recorded, the request including notification recipient user identification information, which is user identification information of a user who is a notification recipient; and
a notification processing unit (AE) for performing processing for outputting the content record notification only to the user identified by the notification recipient user identification information included in the content record notification request among the users.

2. The position message system having the position message server device (A) according to claim 1, the position message server device (A) further having:
a viewing request information acquisition unit (AF) for acquiring viewing request information, which is information associating a request for viewing the retained post information and the geographical information including a location information which is information indicating at least a site of a user terminal device (B) being about to issue the request;
a geographical relationship determination rule retaining unit (AG) for retaining a geographical relationship determination rule, which is a rule for determining whether the geographical information included in the viewing request information and the geographical information associated with the retained content have a predetermined relationship;
a geographical relationship determination unit (AH) for determining, based on the geographical information included in the viewing request information, the geographical information associated with the retained content, and the retained geographical relationship determination rule, whether the two pieces of geographical information have the predetermined relationship;
a permission enabling information output unit (AJ) for outputting permission enabling information, which is information enabling permission to view the content which is requested to be viewed in the viewing request information, when the geographical relationship determination unit (AH) determines that they have the predetermined relationship; and
a content output unit (AK) for outputting the requested content to the user terminal device (B) that has output the viewing request information when predetermined processing is completed based on the output permission enabling information.

3. The position message system further having the user terminal device (B) according to claim 1, the user terminal device (B) having:
a user identification information retaining unit (BA) for retaining user identification information for identifying a user who uses the system;
a notification recipient candidate user identification information retaining unit (BB) for retaining notification recipient candidate user identification information, which is information of a user other than the user identified by the user identification information and who may be a candidate for the notification recipient described below;
a geographical information acquisition unit (BC) for acquiring geographical information including location information of the user terminal device (B);
a content input acceptance unit (BD) for accepting input of the content;
a content retaining unit (BE) for retaining the content of which input has been accepted in association with content identification information, which is information that identifies the content;
a notification recipient identification information selection unit (BF) for selecting as notification recipient identification information for identifying the notification recipient from the notification recipient candidate user identification information retained;
a content identification information selection unit (BG) for selecting a piece of the content identification information that identifies the retained content;
a post information output unit (BH) for outputting post information, which is information that associates:
the content identified by the selected piece of the content identification information,
geographical information acquired when the input of the content was accepted, and
the user identification information of the user who uses the system;
a content record notification request acquisition unit (BJ) for acquiring a content record notification request, which is a request to notify the user identified by the selected piece of the notification recipient user identification information that the selected content is to be recorded or has been recorded; and
a content record notification request output unit (BK) for outputting the acquired content record notification request.

4. The position message system according to claim 3, wherein the post information output unit (BH) of the user terminal device (B) has a viewing-location-limiting remote post information output means (BL) for outputting the post information associated with the geographical information for limiting a viewing location which is not necessarily a current location, the geographical information being acquired when the input of the content was accepted as the geographical information included in the post information.

5. The position message system according to claim 3, wherein the user terminal device (B) further has a content record notification acquisition unit (BM) for acquiring the content record notification.

6. The position message system according to claim 3, wherein the user terminal device (B) further has:
a reply content acquisition unit (BN) for acquiring, in accordance with the acquired post information, a reply content for a user identified by user identification information included in the post information; and
a post reply information output unit (BO) for outputting post reply information, which is information including the acquired reply content.

7. The position message system according to claim 3, wherein
the user terminal device (B) has:
an evaluation/rating information acquisition unit (BP) for acquiring evaluation/rating information, which is information of evaluation/rating of the post information output by the post information output unit (BH); and
an evaluation/rating information output unit (BQ) for outputting the acquired evaluation/rating information, and
the position message server device (A) further has:
an evaluation/rating information acquisition unit (AM) for acquiring the evaluation/rating information; and
an evaluation/rating information retaining unit (AM) for retaining the acquired evaluation/rating information in association with the post information that was the subject of the evaluation.

8. The position message system according to claim 3, wherein
the user terminal device (B) has:
a use/revenue/disposition information acquisition unit (BR) for acquiring, in association with the acquired content, use/revenue/disposition information, which is information regarding one or more of use, revenue, and disposition of the content; and
a use/revenue/disposition information output unit (BS) for outputting the acquired use/revenue/disposition information, and
the position message server device (A) further has:
a use/revenue/disposition information acquisition unit (AN) for acquiring the use/revenue/disposition information;
a use/revenue/disposition information retaining unit (AO) for retaining the acquired use/revenue/disposition information in association with the content; and
a use/revenue/disposition processing unit (AP) for performing, in accordance with the acquired use/revenue/disposition information, processing related to one or more of the use, revenue, and disposition of the content.

9. The position message system according to claim 3, wherein
the user terminal device (B) has:
a search query acquisition unit (BT) for acquiring a query for searching the post information retained in the position message server device (A); and
a query output unit (BU) for outputting the acquired search query to the position message server device (A), and
the position message server device (A) has:
a query acquisition unit (AQ) for acquiring the query; and
a post information search unit (AR) for searching the retained post information based on the acquired query.

10. The position message system according to claim 1, wherein the position message server device (A) further has:
an NFT-ization processing request acquisition unit (AS) for acquiring an NFT-ization request, which is a request for NFT-izing the content associated with the post information retained in the post information retaining unit (AC); and
an NFT-ization processing unit (AT) for performing processing for NFT-izing the content based on the acquired NFT-ization request.

11. The position message system according to claim 1, wherein the position message server device (A) further has:
an access authority information retaining unit (AU) for retaining access authority information, which is information indicating a right to access the content associated with the post information retained in the post information retaining unit (AC) from the user terminal device (B); and
an access authority NFT-ization processing unit (AV) for performing processing for NFT-izing the retained access authority information.

12. A method of operation of a computer-based position message system, which includes a method of operation of a computer-based position message server device (A) including:
a user identification information retaining step (aa) for retaining user identification information for identifying a user;
a post information acquisition step (ab) for acquiring post information that associates:
the user identification information of a user who has recorded a content included in the post information,
geographical information including location information, which is information indicating a location used as a requirement for allowing a user other than the user identified by the user identification information to view this content, and
the content;
a post information retaining step (ac) for retaining the acquired post information;
a content record notification request acquisition step (ad) for acquiring a content record notification request which is a request for outputting a content record notification for notifying a user other than the user who recorded the content that the content included in the post information has been recorded, the request including notification recipient user identification information, which is user identification information of a user who is a notification recipient; and
a notification processing step (ae) for performing processing for outputting the content record notification only to the user identified by the notification recipient user identification information included in the content record notification request among the users.

13. The method of operation of the computer-based position message system according to claim 12, which includes the method of operation of the computer-based position message server device (A) further including:
a viewing request information acquisition step (af) for acquiring viewing request information, which is information associating a request for viewing the retained post information and the geographical information including the location information, which is information at least indicating a location where a user terminal device (B) being about to issue the request is;
a geographical relationship determination rule retaining step (ag) for retaining a geographical relationship determination rule, which is a rule for determining whether the geographical information included in the viewing request information and the geographical information associated with the retained content have a predetermined relationship;
a geographical relationship determination step (ah) for determining, based on the geographical information included in the viewing request information, the geographical information associated with the retained content, and the retained geographical relationship determination rule, whether the two pieces of geographical information have the predetermined relationship;
a permission enabling information output step (aj) for outputting permission enabling information, which is information enabling permission to view the content which is requested to be viewed in the viewing request information, when the geographical relationship determination step (ah) determines that they have the predetermined relationship; and
a content output step (ak) for outputting the requested content to the user terminal device (B) that has output the viewing request information when predetermined processing is completed based on the output permission enabling information.

14. The method of operation of the computer-based position message system according to claim 12, which further includes the method of operation of the computer-based user terminal device (B) including:
a user identification information retaining step (ba) for retaining user identification information for identifying a user who uses the system;
a notification recipient candidate user identification information retaining step (bb) for retaining notification recipient candidate user identification information, which is information of a user other than the user identified by the user identification information and who may be a candidate for the notification recipient described below;
a geographical information acquisition step (bc) for acquiring geographical information including location information of the user terminal device (B);
a content input acceptance step (bd) for accepting input of the content;
a content retaining step (be) for retaining the content of which input has been accepted in association with the content identification information which is information identifying the content;
a notification recipient identification information selection step (bf) for selecting the retained notification recipient candidate user identification information as notification recipient identification information for identifying the notification recipient described below;
a content identification information selection step (bg) for selecting a piece of the content identification information that identifies the retained content;
a post information output step (bh) for outputting as post information, which is information that associates:
the content identified by the selected content identification information,
geographical information acquired when the input of the content was accepted, and
the user identification information of the user who uses the system;
a content record notification request acquisition step (bj) for acquiring a content record notification request, which is a request to notify the user identified by the selected piece of the notification recipient user identification information that the selected content is to be recorded or has been recorded; and
a content record notification request output step (bk) for outputting the acquired content record notification request.

15. A program readable and executable by a computer-based position message system, which includes programs readable and executable by a computer-based position message server device (A) including:
a user identification information retaining program (aa) for retaining user identification information for identifying a user;
a post information acquisition program (ab) for acquiring post information that associates:
the user identification information of a user who has recorded a content included in the post information,
geographical information including location information, which is information indicating a location used as a requirement for allowing a user other than the user identified by the user identification information to view this content, and
the content;
a post information retaining program (ac) for retaining the acquired post information;
a content record notification request acquisition program (ad) for acquiring a content record notification request which is a request for outputting a content record notification for notifying a user other than the user who recorded the content that the content included in the post information has been recorded, the request including notification recipient user identification information, which is user identification information of a user who is a notification recipient; and
a notification processing program (ae) for performing processing for outputting the content record notification only to the user identified by the notification recipient user identification information included in the content record notification request among the users.

16. The program readable and executable by the computer-based position message system according to claim 15, which includes the programs readable and executable by the computer-based position message server device (A) further including:
a viewing request information acquisition step (af) for acquiring viewing request information, which is information associating a request for viewing the retained post information and the geographical information including the location information, which is information at least indicating a location where the user terminal device (B) being about to issue the request is;
a geographical relationship determination rule retaining step (ag) for retaining a geographical relationship determination rule, which is a rule for determining whether the geographical information included in the viewing request information and the geographical information associated with the retained content have a predetermined relationship;
a geographical relationship determination step (ah) for determining, based on the geographical information included in the viewing request information, the geographical information associated with the retained content, and the retained geographical relationship determination rule, whether the two pieces of geographical information have the predetermined relationship;
a permission enabling information output step (aj) for outputting permission enabling information, which is information enabling permission to view the content which is requested to be viewed in the viewing request information, when the geographical relationship determination step (ah) determines that they have the predetermined relationship; and
a content output step (ak) for outputting the requested content to the user terminal device (B) that has output the viewing request information when predetermined processing is completed based on the output permission enabling information.

17. The program readable and executable by the computer-based position message system according to claim 15, which further includes the programs readable and executable by the computer-based user terminal device (B) including:
a user identification information retaining program (ba) for retaining user identification information for identifying a user who uses the system;
a notification recipient candidate user identification information retaining program (bb) for retaining notification recipient candidate user identification information, which is information of a user other than the user identified by the user identification information and who may be a candidate for the notification recipient described below;
a geographical information acquisition program (bc) for acquiring geographical information including location information of the user terminal device (B);
a content input acceptance program (bd) for accepting input of the content;
a content retaining program (be) for retaining the content of which input has been accepted in association with the content identification information which is information identifying the content;
a notification recipient identification information selection program (bf) for selecting the retained notification recipient candidate user identification information as notification recipient identification information for identifying the notification recipient described below;
a content identification information selection program (bg) for selecting a piece of the content identification information that identifies the retained content;
a post information output program (bh) for outputting as post information, which is information that associates:
the content identified by the selected content identification information,
geographical information acquired when the input of the content was accepted, and
the user identification information of the user who uses the system;
a content record notification request acquisition program (bj) for acquiring a content record notification request, which is a request to notify the user identified by the selected piece of the notification recipient user identification information that the selected content is to be recorded or has been recorded; and
a content record notification request output program (bk) for outputting the acquired content record notification request.
